(19) United States
(12) Patent Application Publication
(10) Pub. No.: US 2024/0071246 A1
(43) Pub. Date: Feb. 29, 2024

(54) Distributed Architecture for Structured Data Exchange and User Interface Transformation

(71) Applicant: Startup Studio LLC, Windermere, FL (US)

(72) Inventors: Gary Conroy, Windermere, FL (US); Anastasia Hall, Deerfield Beach, FL (US)

(21) Appl. No.: 18/458,797

(22) Filed: Aug. 30, 2023

Related U.S. Application Data
(60) Provisional application No. 63/402,458, filed on Aug. 30, 2022.

(51) Int. Cl. G09B 5/12; G06Q 50/20

(52) U.S. Cl. CPC G09B 5/12; G06Q 50/20

(57) ABSTRACT

A system for orchestrating structured data exchange between computer devices and generating dynamic user interfaces includes an interconnect platform including a data store, platform generation and service modules, a programming interface, and a first communications interface. The platform generation and service modules are configured to access a plurality of formatted data objects stored in the user profile, save the formatted data objects to the submissions database, determine whether each of the formatted data objects complies with standards stored in a certification standards database, transform a user interface element at a user interface to provide a positive indication in response to determining that each of the formatted data objects complies with the standards, and transform the user interface element to provide a negative indication in response to determining that at least one of the formatted data objects does not comply with the standards.

### CROSS-REFERENCE TO RELATED APPLICATIONS

This application claims the benefit of U.S. Provisional Application No. 63/402,458 filed 30 Aug. 2022, the entire disclosure of which is incorporated by reference.

### FIELD

The present disclosure relates to improved user interfaces for distributed computing platforms and, more particularly, to adaptive graphical user interfaces for distributed computer platforms in data procession, fusion, and synthesis applications.

### BACKGROUND

With the emergence of remote and/or hybrid learning environments, there is an increasing demand for distributed computer systems that collect data submissions from user devices, analyze the data submissions, and generate feedback. However, any large-scale remote and/or hybrid learning environment would include correspondingly large number of users, and each user would in turn generate a large number of data objects as the user progresses through a curriculum. In a learning environment, human interaction with these data objects is essential. For example, learners need to interact with data objects generated by themselves and others in order to realize benefits and synergies generated by collaboration. Similarly, instructors need to interact with these data objects in order to evaluate the learners, particularly if the data objects relate to portions of the curriculum that require human judgment during the evaluation process. Given the quantity of data involved, there exists a need for systems capable of automatically generating user interfaces that improves the accuracy of users accessing and evaluating large quantities of data objects of varying file formats.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system for orchestrating structured data exchange between computer devices and generating dynamic user interfaces includes an interconnect platform including a data store including a user profile, a submissions database, and a certification database, platform generation and service modules, a programming interface configured to provide access to the platform generation and service modules, and a first communications interface configured to provide access to the programming interface. The system includes a user device including a display, a second communications interface configured to be operatively coupled to the first communications interface via a network, and platform access modules configured to access the programming interface via the second communications interface, the network, and the first communications interface.

The platform generation and service modules are configured to access a plurality of formatted data objects stored in the user profile, save the formatted data objects to the submissions database, determine whether each of the formatted data objects comply with standards stored in a certification standards database, transform a user interface element at a user interface to provide a positive indication in response to determining that each of the formatted data objects complies with the standards, and transform the user interface element to provide a negative indication in response to determining that at least one of the formatted data objects does not comply with the standards.

In other features, the platform generation and service modules are configured to generate a second user interface element selectable by a first user, receive a raw data object uploaded by the first user in response to the first user selecting the second user interface element, and save the raw data object to the user profile. In other features, the user platform generation and service modules are configured to determine whether the raw data object is in a file format compatible with the platform generation and service modules and reformat the raw data object and adding the reformatted raw data object to the formatted data objects in response to determining that the file format is not compatible with the platform generation and service modules.

In other features, the user platform generation and service modules are configured to add the raw data object to the formatted data objects in response to determining that the file format is compatible with the platform generation and service modules. In other features, the platform generation and service modules are configured to transform the second user interface element to display a preview of one of the formatted data objects. In other features, the platform generation and service modules are configured to transform the user interface to display a third user interface element selectable by the first user and save the formatted data objects as submitted data objects in the submissions database in response to the first user selecting third user interface element.

In other features, the platform generation and service modules are configured to transform the user interface to display a fourth user interface element selectable by a second user. In response to the second user selecting the fourth user interface element, the platform generation and service modules are configured to transform the user interface to display one of the submitted data objects, transform the user interface to display a fifth user interface element and a sixth user interface element, the fifth user interface element and the sixth user interface element each selectable by the second user, associate a first data marker with the submitted data object in response to the second user selecting the fifth user interface element, and associate a second data marker with the submitted data object in response to the second user selecting the sixth user interface element.

In other features, the platform generation and service modules are configured to transform the user interface to display a seventh user interface element selectable by the second user. In response to the second user selecting the seventh user interface element, the platform generation and service modules are configured to determine whether each of the submitted data objects has an associated data marker, save the submitted data objects and the associated data markers as submitted grades in the submissions database in response to determining that each of the submitted data objects has the associated data marker, and generate an error message and outputting the error message to the user interface in response to determining that at least one of the submitted data objects does not have the associated data marker.

In other features, the platform generation and service modules are configured to load the submitted grades from the submissions database, determine whether each of the submitted grades is associated with the first data marker or the second data marker, generate a second error message and outputting the second error message to the user interface in response to determining that one of the submitted grades is associated with the second data marker, and add an entry to the certifications database in response to determining that each of the submitted grades is associated with the first data marker.

In other features, the platform generation and service modules are configured to generate an eighth user interface element, determine whether the entry is present in the certifications database, and transform the eighth user interface element to display a negative indication in response to determining that the entry is not present in the certifications database. In response to determining that the entry is present in the certifications database, the platform generation and service modules are configured to transform the eighth user interface element to display a positive indication, generate a ninth user interface element selectable by the first user, and generate a certificate corresponding to the entry and outputting the certificate to the user interface in response to the first user selecting the eighth user interface element.

A computer-implemented method of orchestrating structured data exchange between computer devices and generating dynamic user interfaces includes accessing, at platform generation and service modules, a plurality of formatted data objects stored in a user profile, the user profile stored in a data store, the data store forming a part of an interconnect platform including the data store, the platform generation and service modules, a programming interface configured to provide access to the platform generation and service modules, and a first communications interface configured to provide access to the programming interface. The method includes saving the formatted data objects to a submissions database, the submission database stored in the data store, determining whether each of the formatted data objects comply with standards stored in a certification standards database, the certification standards database stored in the data store, transforming a user interface element at a user interface to provide a positive indication in response to determining that each of the formatted data objects complies with the standards, and transforming the user interface element to provide a negative indication in response to determining that at least one of the formatted data objects does not comply with the standards.

In other features, the method includes generating a second user interface element selectable by a first user, receiving a raw data object uploaded by the first user in response to the first user selecting the second user interface element, and saving the raw data object to the user profile. In other features, the method includes determining whether the raw data object is in a file format compatible with the platform generation and service modules, reformatting the raw data object in response to determining that the file format is not compatible with the platform generation and service modules, and adding the reformatted raw data object to the formatted data objects.

In other features, the method includes adding the raw data object to the formatted data objects in response to determining that the file format is compatible with the platform generation and service modules. In other features, the method includes transforming the second user interface element to display a preview of one of the formatted data objects. In other features, the method includes transforming the user interface to display a third user interface element selectable by the first user and saving the formatted data objects as submitted data objects in the submissions database in response to the first user selecting the third user interface element.

In other features, the method includes transforming the user interface to display a fourth user interface element selectable by a second user. In response to the second user selecting the fourth user interface element, the method includes transforming the user interface to display one of the submitted data objects, transforming the user interface to display a fifth user interface element and a sixth user interface element, the fifth user interface element and the sixth user interface element selectable by the second user, associating a first data marker with the submitted data object in response to the second user selecting the fifth user interface element, and associating a second data marker with the submitted data object in response to the second user selecting the sixth user interface element.

In other features, the method includes transforming the user interface to display a seventh user interface element selectable by the second user. In response to the second user selecting the seventh user interface element, the method includes determining whether each of the submitted data objects has an associated data marker, saving the submitted data objects and the associated data markers as submitted grades in the submissions database in response to determining that each of the submitted data objects has the associated data marker, and generating an error message and outputting the error message to the user interface in response to determining that at least one of the submitted data objects does not have the associated data marker.

In other features, the method includes loading the submitted grades from the submissions database, determining whether each of the submitted grades is associated with the first data marker or the second data marker, generating a second error message and outputting the second error message to the user interface in response to determining that one of the submitted grades is associated with the second data marker, and adding an entry to a certification database, the certification database stored in the data store in response to determining that each of the submitted grades is associated with the first data marker.

In other features, the method includes generating an eighth user interface element, determining whether the entry is present in the certifications database, and transforming the eighth user interface element to display a negative indication in response to determining that the entry is not present in the certifications database. In response to determining that the entry is present in the certifications database, the method includes transforming the eighth user interface element to display a positive indication, generating a ninth user interface element selectable by the first user, and generating a certificate corresponding to the entry and outputting the certificate to the user interface in response to the first user selecting the eighth user interface element.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a block diagram of an example implementation of a system for providing a remote and/or hybrid learning environment;

FIG. 2 is a block diagram of a system with some examples of a distributed client integration and interconnect platform shown in detail;

FIG. 3 is a block diagram showing example databases that may be stored in data store(s);

FIG. 4 is a block diagram of the system with some examples of a user device shown in detail;

FIG. 5 is a flowchart of an example process for automatically orchestrating data transfer between components of a system and automatically transforming user interface elements;

FIG. 6 is an example user interface associated with some embodiments of the process of FIG. 5;

FIG. 7 is a flowchart of an example process for automatically initializing a user platform generation module according to characteristics of a user profile;

FIG. 8 illustrates example user interface elements that may be automatically generated when a user platform generation module is initialized;

FIG. 9 illustrates example user interface elements that may be automatically generated when a user platform generation module is initialized;

FIG. 10 illustrates example user interface elements that may be automatically generated when a user platform generation module is initialized;

FIG. 11 illustrates example user interface elements that may be automatically generated when a user platform generation module is initialized;

FIG. 12 illustrates example user interface elements that may be automatically generated when a user platform generation module is initialized;

FIG. 13 illustrates example user interface elements that may be automatically generated when a user platform generation module is initialized;

FIG. 14 illustrates example user interface elements that may be automatically generated when a user platform generation module is initialized;

FIG. 15 illustrates example user interface elements that may be automatically generated when a user platform generation module is initialized;

FIG. 16 illustrates example user interface elements that may be automatically generated when a user platform generation module is initialized;

FIG. 17 is a flowchart of an example process for automatically generating and transforming a user interface for defining certification standards data objects and creating generated data tags after an administrator platform generation module is initialized;

FIG. 18 is a flowchart of an example process for automatically initializing a user platform generation module by generating selectable user interface elements;

FIG. 19 is a flowchart of an example process for generating user interfaces and adding data objects to a user profile databases after a first mutable data objects editing and display module is initialized;

FIG. 20 illustrates example user interface elements that may be generated when a first mutable data objects editing and display module is initialized;

FIG. 21 illustrates example user interface elements that may be generated when a first mutable data objects editing and display module is initialized;

FIG. 22 illustrates example user interface elements that may be generated when a first mutable data objects editing and display module is initialized;

FIG. 23 is a flowchart of an example process for generating user interfaces and adding data objects to a user profile databases after a second mutable data objects editing and display module is initialized;

FIG. 24 illustrates example user interface elements that may be generated when a second mutable data objects editing and display module is initialized;

FIG. 25 illustrates example user interface elements that may be generated when a second mutable data objects editing and display module is initialized;

FIG. 26 illustrates example user interface elements that may be generated when a second mutable data objects editing and display module is initialized;

FIG. 27 is a flowchart of an example process for generating user interfaces and adding data objects to user profile databases after a third mutable data objects editing and display module is initialized;

FIG. 28 illustrates example user interface elements that may be generated when a third mutable data objects editing and display module is initialized;

FIG. 29 illustrates example user interface elements that may be generated when a third mutable data objects editing and display module is initialized;

FIG. 30 illustrates example user interface elements that may be generated when a third mutable data objects editing and display module is initialized;

FIG. 31 is a flowchart of an example process for generating user interfaces and adding data objects to user profile databases after a first mutable data objects editing and display module is initialized;

FIG. 32 illustrates example user interface elements that may be generated when a first mutable data objects editing and display module is initialized;

FIG. 33 illustrates example user interface elements that may be generated when a first mutable data objects editing and display module is initialized;

FIG. 34 illustrates example user interface elements that may be generated when a first mutable data objects editing and display module is initialized;

FIG. 35 is a flowchart of an example process for automatically generating user interfaces and processing data objects after a data object synthesis module is initialized;

FIG. 36 illustrates example user interface elements that may be generated when a data object synthesis module is initialized;

FIG. 37 illustrates example user interface elements that may be generated when a data object synthesis module is initialized;

FIG. 38 is a flowchart of an example process for automatically generating user interfaces and processing data objects after a review platform generation module is initialized;

FIG. 39 illustrates example user interface elements that may be generated when a review platform generation module is initialized;

FIG. 40 illustrates example user interface elements that may be generated when a review platform generation module is initialized;

FIG. 41 illustrates example user interface elements that may be generated when a review platform generation module is initialized;

FIG. 42 illustrates example user interface elements that may be generated when a review platform generation module is initialized;

FIG. 43 illustrates example user interface elements that may be generated when a review platform generation module is initialized;

FIG. 44 is a flowchart of an example process for automatically generating user interfaces and processing data objects after an administrator platform generation module is initialized;

FIG. 45 is a flowchart of an example process for automatically generating user interfaces after a user platform generation module is initialized;

FIG. 46 illustrates user interface elements that may be automatically generated after a user platform generation module is initialized;

FIG. 47 illustrates an example certificate that may be generated by a user platform generation module;

FIG. 48 shows example user interface elements that may be generated by the a platform generation module;

FIG. 49 shows example user interface elements that may be generated by the a platform generation module;

FIG. 50 shows example user interface elements that may be generated by the a platform generation module;

FIG. 51 shows example user interface elements that may be generated by the a platform generation module;

FIG. 52 shows example user interface elements that may be generated by the a platform generation module;

FIG. 53 shows example user interface elements that may be generated by the a platform generation module;

FIG. 54 shows example user interface elements that may be generated by the a platform generation module;

FIG. 55 shows example user interface elements that may be generated by the a platform generation module;

FIG. 56 shows example user interface elements that may be generated by the a platform generation module;

FIG. 57 shows example user interface elements that may be generated by the a platform generation module;

FIG. 58 shows example user interface elements that may be generated by the a platform generation module;

FIG. 59 shows example user interface elements that may be generated by the a platform generation module;

FIG. 60 shows example user interface elements that may be generated by the a platform generation module;

FIG. 61 shows example user interface elements that may be generated by the a platform generation module;

FIG. 62 shows example user interface elements that may be generated by the a platform generation module;

FIG. 63 shows example user interface elements that may be generated by the a platform generation module;

FIG. 64 shows example user interface elements that may be generated by the a platform generation module;

FIG. 65 shows example user interface elements that may be generated by the a platform generation module; and

FIG. 66 shows example user interface elements that may be generated by the a platform generation module.

In the drawings, reference numbers may be reused to identify similar and/or identical elements.

### DETAILED DESCRIPTION

### System Overview

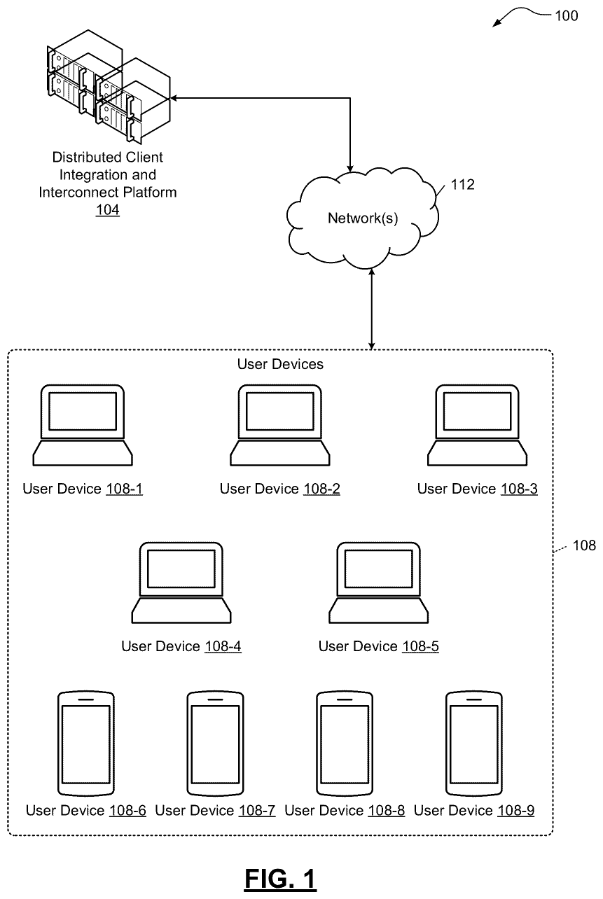

FIG. 1 is a block diagram of an example implementation of a system 100 for providing a remote and/or hybrid learning environment. As shown in FIG. 1, some examples of the system 100 may include a hosting platform, such as a distributed client integration and interconnect platform 104, one or more user device(s) 108, and one or more network(s) 112. In various implementations, the one or more user device(s) 108 may communicate with the distributed client integration and interconnect platform 104 and/or each other via the network(s) 112. Examples of the network(s) 112 may include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network(s) 112 may include an optical network. The network(s) 112 may be a local area network or a global communication network, such as the Internet. Moreover, although the system shows a single network 112, multiple networks can be used. The multiple networks may communicate in series and/or parallel with each other to link the devices 104-108.

In various implementations, the one or more user devices(s) 108 may include any combination of a user device 108-1 for an instructor associated with an educational institution, a user device 108-2 for an administrator associated with the educational institution, a user device 108-3 for an manager associated with a corporate entity, a user device 108-4 for an administrator associated with the corporate entity, a user device 108-5 for an administrator associated with the distributed client integration and interconnect platform 104, a user device 108-6 associated with a Level 1 user, a user device 108-7 associated with a Level 2 user, a user device 108-8 associated with a Level 3 user, and a user device 108-9 associated with a Level 4 user. In various implementations, the system 100 may include additional user devices 108 associated with any number of users.

Various implementations of the system 100 provide technological solutions that address deficiencies in existing computer-implemented educational platforms. Because current education systems only work with “quantitative” or “summative” assessments, training systems or technology tools that are capable of teaching or grading “formative” skills (such as skills that the market refers to as “soft skills”) do not exist. The system 100 addresses these long-felt but unmet needs by collecting “qualitative data sets” that may serve as proof of these “formative” skills and parsing the collected data using built-in assessment mechanisms tied to exact standards.

### Distributed Client Integration and Interconnect Platform

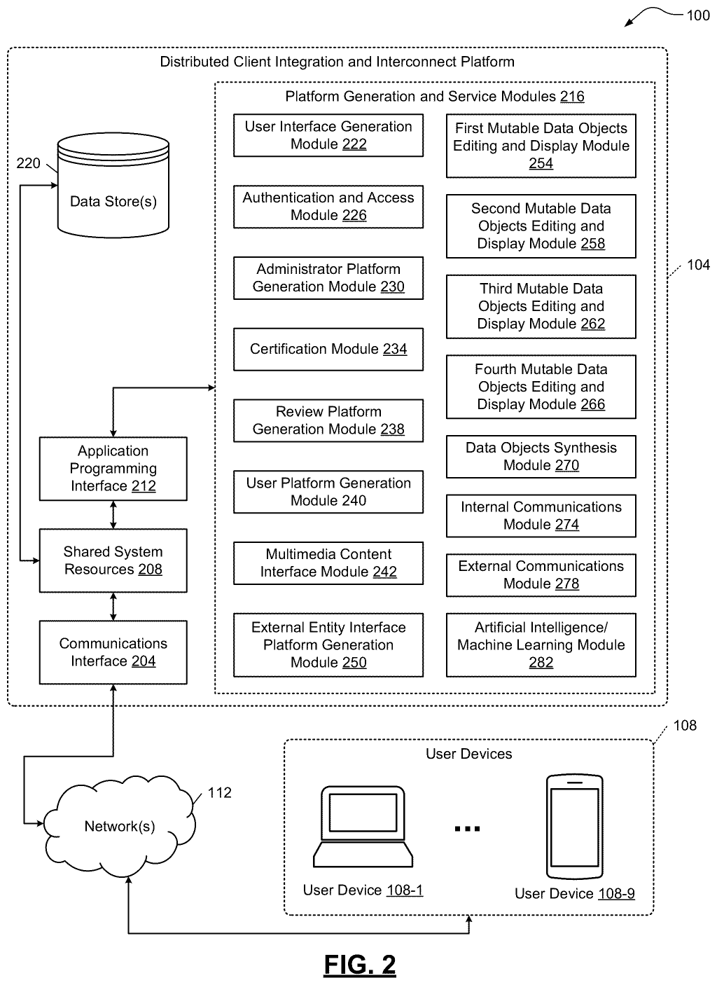

FIG. 2 is a block diagram of the system 100 with some examples of the distributed client integration and interconnect platform 104 shown in detail. As shown in FIG. 2, the distributed client integration and interconnect platform 104 may include a communications interface 204, shared system resources 208, an application programming interface 212, platform generation and service modules 216, and one or more data stores 220. In various implementations, the communications interface 204 may be suitable for communicating with other communications interfaces via the network(s) 112. In various implementations, the communications interface 204 may include a transceiver suitable for sending and/or receiving data to and from other communications interfaces via the network(s) 112. In various implementations, the shared system resources 208 may include one or more processors, volatile or non-volatile computer memory (such as random access memory), system storage, system storage (such as non-transitory computer-readable storage media), and one or more system busses connecting the components.

In various implementations, the application programming interface 212 and the platform generation and service modules 216 may be software modules stored on non-transitory computer-readable storage media. In various implementations, the communications interface 204, the application programming interface 212, the platform generation and service module 216, and/or the data store(s) 220 may be operatively coupled to the shared system resources 208, and/or operatively coupled to each other via the shared system resources 208. In various implementations, the platform generation and service modules 216 may access the user device(s) 108 via the application programming interface 212, the shared system resources 208, the communications interface 204, and the network(s) 112. In various implementations, the user device(s) 108 may access the platform generation and service module(s) 216 via the network(s) 112, the communications interface 204, the shared system resources 208, and the application programming interface 212.

In various implementations, the application programming interface 212 may be a software module that provides an interface for software external to the platform generation and service modules 216 to communicate with the platform generation and service modules 216. For example, the application programming interface 212 may allow software modules at a user device 108 to communicate with the platform generation and service modules 216. In various implementations, the platform generation and service modules 216 may include a user interface generation module 222, an authentication and access module 226, an administrator platform generation module 230, a certification module 234, a review platform generation module 238, a user platform generation module 240, a multimedia content interface module 242, an external entity interface platform generation module 250, a first mutable data objects editing and display module 254, a second mutable data objects editing and display module 258, a third mutable data objects editing and display module 262, a fourth mutable data objects editing and display module 266, a data object synthesis module 270, an internal communications module 274, an external communications module 278, and an artificial intelligence/machine learning module 282. As will be described in detail, the platform generation and service modules 216 work in concert to automatically generate generating user interfaces that improves the accuracy of users accessing and evaluating large quantities of data objects of varying file formats.

In various implementations, the artificial intelligence/machine learning module 282 may automate any of the processes described in this specification. In various implementations, the artificial intelligence/machine learning module 282 may access and parse data in the data store(s) 220 to automatically identify strengths and weaknesses associated with each user/user profile. In various implementations, the artificial intelligence/machine learning module 282 may train reviewers and/or connect reviewers directly into external markets to improve the reviewers' ability to assess user skill levels and advise users. In various implementations, the artificial intelligence/machine learning modules 282 may include fuzzy logic systems, artificial intelligence systems, and/or expert systems.

In various implementations, the artificial intelligence/machine learning modules 282 may identify skill levels of the users of the system 100. In various implementations, the artificial intelligence/machine learning modules 282 may evaluate the sustainability, profitability, and/or efficiency of the curricula, and/or the believability, credibility, and/or charisma of the users. In various implementations, the artificial intelligence/machine learning modules 282 may identify opportunities by matching users and actors on external marketplaces. In various implementations, the artificial intelligence/machine learning modules 282 may use blockchain technologies.

In various implementations, components of the system 100 may be deployed under a software as a service (SaaS) model. In various implementations, components of the system 100 may be deployed under a platform as a service (PaaS) model. In various implementations, components of the system 100 may be deployed under an infrastructure as a service (IaaS) model.

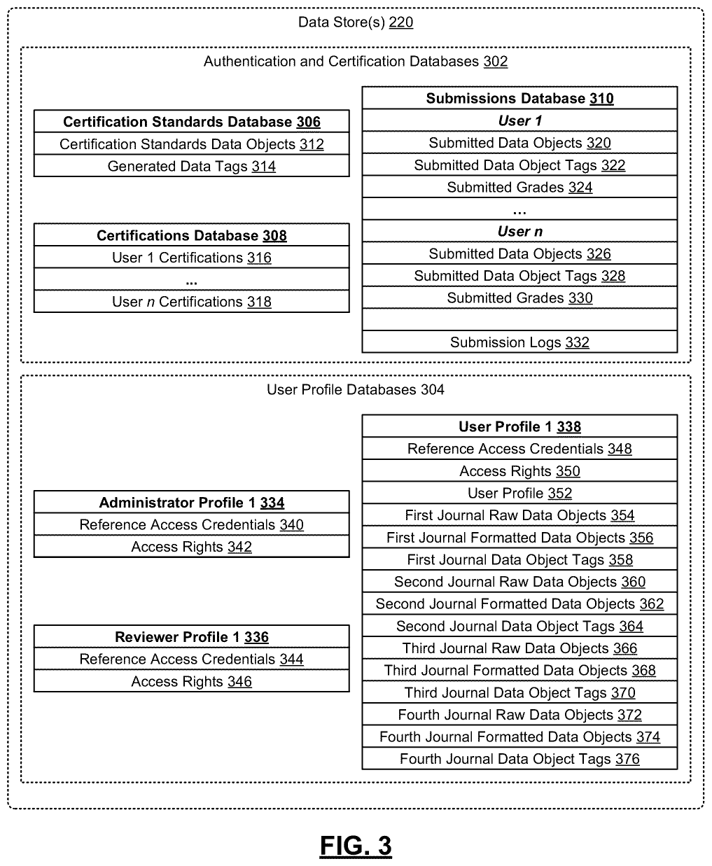

FIG. 3 is a block diagram showing example databases that may be stored in the data store(s) 220. For example, in various implementations, the data store(s) 220 includes authentication and certification databases 302 and user profile databases 304. In various implementations, the authentication and certification databases 302 includes a certification standards database 306, a certifications database 308, and a submissions database 310. In various implementations, the certification standards database 306 includes certification standards data objects 312 and generated data tags 314. The certification standards data objects 312 may be the standards set by an administrator associated with the distributed client integration and interconnect platform 104 and/or an administrator associated with the educational institution. These standards may be the standards used to certify users to meeting the standards required by a curriculum. In various implementations, the generated data tags 314 may be data tag that correspond to the standards used to certify the users.

In various implementations, the certifications database 308 includes certifications for one or more users. For example, the certifications database 308 may include user 1 certifications 316 corresponding to a first user and user n certifications 318 corresponding to an n-th user. In various implementations, the certifications may include data objects indicating that the user has been certified according to one or more curricula. In various implementations, the certifications database 308 may include certifications for any number of users.

In various implementations, the submissions database 310 may include submitted data objects, submitted data object tags, and submitted grades for one or more users. The submitted data objects may include data objects submitted for grading as the user progresses through a curriculum, and the submitted data object tags may be data tags used to indicate which of the certification standards the submitted data object relates to. The submitted grades may indicate whether or not each submitted data objects meets the relevant certification standards. In various implementations, the submissions database 310 may include submitted data objects 320, submitted data object tags 322, and submitted grades 324 corresponding to a first user. In various implementations, the submissions database 310 may include submitted data objects 326, submitted data object tags 328, and submitted grades 330 corresponding to an n-th user. In various implementations, the submissions database 310 may include submitted data objects, submitted data object tags, and submitted grades for any number of users. In various implementations, the submissions database 310 includes submission logs 332 that track how many times has attempted to submit data objects over a period of time.

In various implementations, the user profile databases 304 may include information related to one or more user profiles associated with users that have access to the distributed client integration and interconnect platform 104. For example, the user profile databases 304 may include user profiles associated with administrators, reviewers, and users. As illustrated in FIG. 3, in some examples, the user profile databases 304 may include an administrator profile 334 associated with a first administrator, a reviewer profile 336 associated with a first reviewer, and a user profile 338 associated with a first user. In various implementations, the user profile databases 304 may include user profiles associated with any number of administrators, reviewers, and/or users.

In various implementations, the administrator profile 334 may include reference access credentials 340 and access rights 342. The reference access credentials 340 may include the correct login credentials that the administrator must provide in order to access the distributed client integration and interconnect platform 104. For example, the reference access credentials 340 may include a username and password, two- or multi-factor authentication, biometrics, single sign-on, identification number, license, security token, or other suitable technology. The access rights 342 may include roles, privileges, and/or access credentials or tokens that define the scope of the administrator's access to the distributed client integration and interconnect platform 104. For example, the access rights 342 may deny or grant the administrator access to one or more modules of the platform generation and service modules 216, and/or deny or grant the administration access to one or more parts and/or functions of the individual modules of the platform generation and service modules 216.

In various implementations, the reviewer profile 336 may include reference access credentials 344 and access rights 346. The reference access credentials 344 may include the correct login credentials that the reviewer must provide in order to access the distributed client integration and interconnect platform 104. For example, the reference access credentials 344 may include a username and password, two- or multi-factor authentication, biometrics, single sign-on, identification number, license, security token, or other suitable technology. The access rights 346 may include roles, privileges, and/or access credentials or tokens that define the scope of the reviewer access to the distributed client integration and interconnect platform 104. For example, the access rights 346 may deny or grant the reviewer access to one or more modules of the platform generation and service modules 216, and/or deny or grant the reviewer access to one or more parts and/or functions of the individual modules of the platform generation and service modules 216.

In various implementations, the user profile 338 may include reference access credentials 348, access rights 350, a user profile 352, first journal raw data objects 354, first journal formatted data objects 356, first journal data object tags 358, second journal raw data objects 360, second journal formatted data objects 362, second journal data object tags 364, third journal raw data objects 366, third journal formatted data objects 368, third journal data object tags 370, fourth journal raw data objects 372, fourth journal formatted data objects 374, and/or fourth journal data object tags 376.

In various implementations, the reference access credentials 348 may include the correct login credentials that the user must provide in order to access the distributed client integration and interconnect platform 104. For example, the reference access credentials 348 may include a username and password, two- or multi-factor authentication, biometrics, single sign-on, identification number, license, security token, or other suitable technology. The access rights 350 may include roles, privileges, and/or access credentials or tokens that define the scope of the user access to the distributed client integration and interconnect platform 104. For example, the access rights 350 may deny or grant the user access to one or more modules of the platform generation and service modules 216, and/or deny or grant the user access to one or more parts and/or functions of the individual modules of the platform generation and service modules 216.

In various implementations, the user profile 352 may include a variety of data objects related to the user. For example, the user profile 352 may include any combination of text files, image files, audio files, video files, and/or other data objects. In various implementations, the first journal raw data objects 354, second journal raw data objects 360, third journal raw data objects 366, and/or fourth journal raw data objects 372 may include any combination of text files, image files, audio files, video files, and/or other data objects related to the user. In various implementations, the first journal raw data objects 354, second journal raw data objects 360, third journal raw data objects 366, and/or fourth journal raw data objects 372 may include files in formats that the platform generation and service modules 216 may user direct as well as files in formats not directly compatible with the platform generation and service modules 216.

In various implementations, the first journal formatted data objects 356, second journal formatted data objects 362, third journal formatted data objects 368, and/or fourth journal formatted data objects 374 may include any combination of text files, image files, audio files, video files, and/or other data objects related to the user. In various implementations, the first journal formatted data objects 356, second journal formatted data objects 362, third journal formatted data objects 368, and/or fourth journal formatted data objects 374 may include versions of the first journal raw data objects 354, second journal raw data objects 360, third journal raw data objects 366, and/or fourth journal raw data objects 372 formatted to be compatible with the platform generation and service modules 216.

In various implementations, the first journal data object tags 358, second journal data object tags 364, third journal data object tags 370, and/or fourth journal data object tags 376 may be data tags associated with the first journal formatted data objects 356, second journal formatted data objects 362, third journal formatted data objects 368, fourth journal formatted data objects 374, first journal raw data objects 354, second journal raw data objects 360, third journal raw data objects 366, and/or fourth journal raw data objects 372. In various implementations, the first journal data object tags 358, second journal data object tags 364, third journal data object tags 370, and/or fourth journal data object tags 376 may indicate whether each of the respective associated data objects is relevant to one or more of the certification standards data objects 312 and/or generated data tags 314.

In various implementations, the first journal data object tags 358, second journal data object tags 364, third journal data object tags 370, and/or fourth journal data object tags 376 may be appended to one or more of the first journal formatted data objects 356, second journal formatted data objects 362, third journal formatted data objects 368, fourth journal formatted data objects 374, first journal raw data objects 354, second journal raw data objects 360, third journal raw data objects 366, and/or fourth journal raw data objects 372—for example, as metadata. In various implementations, the first journal data object tags 358, second journal data object tags 364, third journal data object tags 370, and/or fourth journal data object tags 376 may be entries in a database indicating which of the certification standards data objects 312 and/or the generated data tags 314 the first journal formatted data objects 356, second journal formatted data objects 362, third journal formatted data objects 368, fourth journal formatted data objects 374, first journal raw data objects 354, second journal raw data objects 360, third journal raw data objects 366, and/or fourth journal raw data objects 372 are associated with.

### User Device

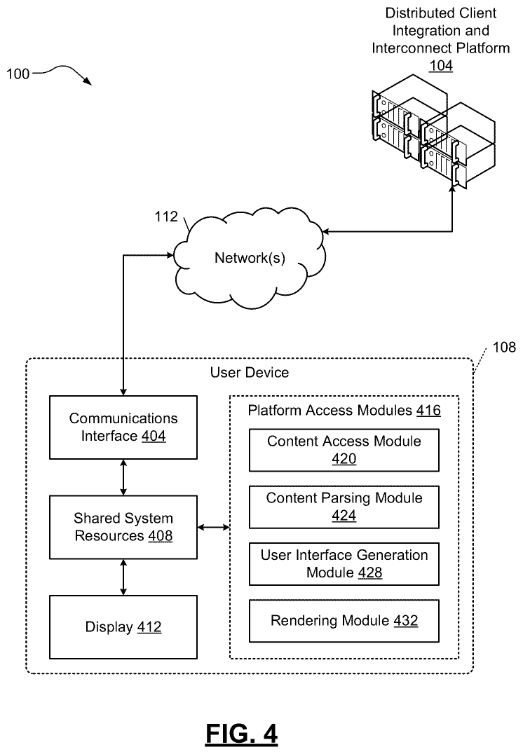

FIG. 4 is a block diagram of the system 100 with some examples of the user device 108 shown in detail. In various implementations, the user device 108 may include a communications interface 404, shared system resources 408, a display 412, and platform access modules 416. In various implementations, the communications interface 404 may be suitable for communicating with other communications interfaces via the network(s) 112. In various implementations, the communications interface 404 may include a transceiver suitable for sending and/or receiving data to and from other communications interfaces via the network(s) 112. In various implementations, the shared system resources 408 may include one or more processors, volatile or non-volatile computer memory (such as random access memory), system storage, system storage (such as non-transitory computer-readable storage media), and one or more system busses connecting the components. In various implementations, the display 412 may include a user input device in addition to an output device. For example, the display 412 may include a touchscreen.

In various implementations, the platform access modules 416 may be software modules stored on non-transitory computer-readable storage media. In various implementations, the communications interface 404, the display 412, and/or the platform access modules 416 may be operatively coupled to the shared system resources 408 and/or operatively coupled to each other via the shared system resources 408. In various implementations, the platform access modules 416 may access the platform generation and service modules 216 via the shared system resources 408, the communications interface 404, the network 112, the shared system resources 208, and/or the application programming interface 212.

In various implementations, the platform access modules 416 include a content access module 420, a content parsing module 424, a user interface generation module 428, and/or a rendering module 432. The content access module 420 may retrieve URLs using Internet protocols such as the Hypertext Transport Protocol (HTTP), the Hypertext Transport Protocol Secure (HTTPS), and/or the File Transport Protocol (FTP). The content parsing module 424 may receive content from the content access module 420 and render a web page based on the content. The user interface generation module 428 may generate a user interface to be output to the display 412, and the rendering module 432 may output the rendered web page to the user interface. In various implementations, the platform access modules 416 may access the content generated by the platform generation and service modules 216 and render the content as one or more web pages on the display 412.

### Flowcharts and User Interfaces

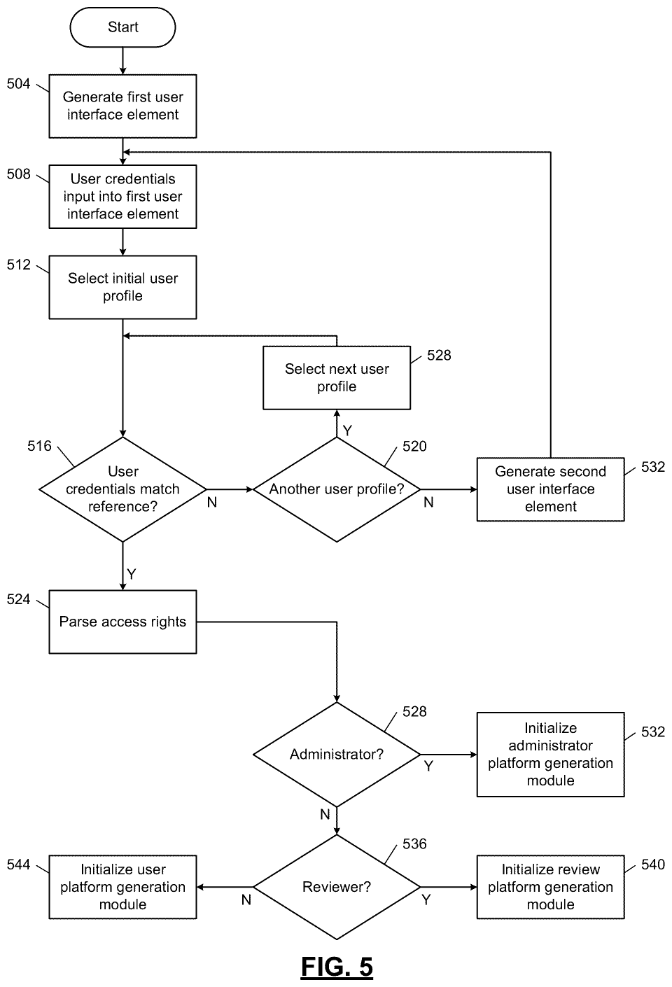

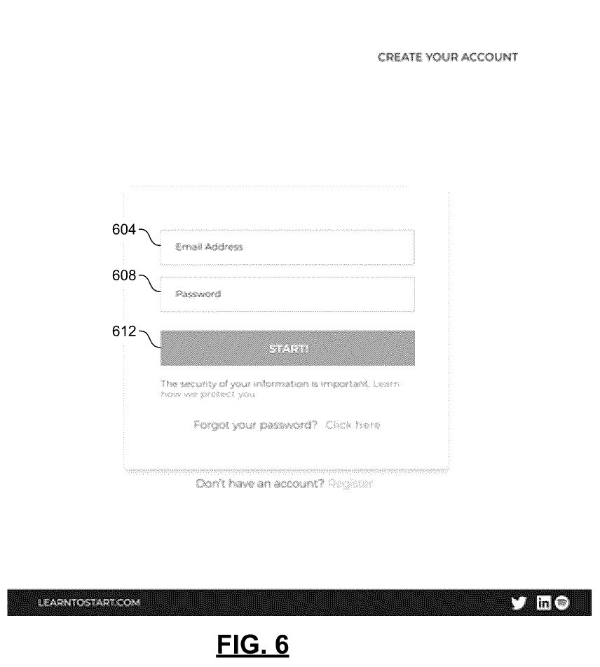

FIG. 5 is a flowchart of an example process for automatically orchestrating the data transfer between components of the system 100 and automatically transforming user interface elements. FIG. 6 is an example user interface associated with some embodiments of the process of FIG. 5. In various implementations, the user interface shown in FIG. 6 may be collectively referred to as a “Welcome Page.” At 504, the user interface generation module 222 generates a first user interface element. In various implementations, the first user interface element may include user editable input fields—such as the username/email input field 604 and the password input field 608—that allow the user to input credentials. In various implementations, the first user interface element may further include a user selectable element, such as a login button 612. Control proceeds to 508. At 508, the user inputs credentials into the first user interface element. For example, the user may input a username/email address into the username/email input field 604, a password into the password input field 608, and select the login button 612. In response to the user selecting the login button 612, the user's credentials are passed to the authentication and access module 226, and control proceeds to 512.

At 512, the authentication and access module 226 selects an initial user profile from the user profile databases 304. Control proceeds to 516. At 516, the authentication and access module 226 determines whether the user credentials input at 508 matches the reference user credentials of the selected user profile. For example, if at 512 the authentication and access module 226 selects the first administrator profile 334, the authentication and access module 226 determines whether the user credentials input at 508 matches reference access credentials 340. Similarly, if the first reviewer profile 336 is selected, the authentication and access module 226 determines whether the user credentials input at 508 matches reference access credentials 344. If the first user profile 338 is selected, the authentication and access module 226 determines whether the user credentials input at 508 matches reference access credentials 348. If at 516 the user credentials input at 508 do not match the reference user credentials of the selected profile, control proceeds to 520. Otherwise, if at 512 the user credentials input at 508 matches the reference user credentials of the selected profile, control proceeds to 524.

At 520, the authentication and access module 226 determines whether another user profile is present in the user profile databases 304. If at 520 the authentication and access module 226 determines that another user profile is present in the user profile databases 304, control proceeds to 528, where the authentication and access module 226 selects the next user profile and proceeds back to 516. If at 520 the authentication and access module 226 determines that another user profile is not present in the user profile databases 304, control proceeds to 532, where the user interface generation module 222 generates a second user interface element. In various implementations, the second user interface element may include an error message, such as a message displayed to the user indicating that the user credentials input at 508 are not valid. Control may proceed back to 508.

At 524, the authentication and access module 226 retrieves and parses access rights from the user profile parsed at 516. For example, if at 516 the authentication and access module 226 parses the first administrator profile 334, the authentication and access module 226 retrieves corresponding access rights 342. If at 516 the authentication and access module 226 parses the first reviewer profile 336, the authentication and access module 226 retrieves corresponding access rights 346. If at 516 the authentication and access module 226 parses the first user profile 338, the authentication and access module 226 retrieves corresponding access rights 350. Control proceeds to 528. At 528, the authentication and access module 226 determines whether the access rights retrieved and parsed at 524 indicate that the user is an administrator. If at 528 the authentication and access module 226 determines that the user is an administrator, control proceeds to 532. Otherwise, control proceeds to 536.

At 532, the authentication and access module 226 initializes the administrator platform generation module 230. At 536, the authentication and access module 226 determines whether the access rights retrieved and parsed at 524 indicate that the user is a reviewer. If at 532 the authentication and access module 226 determines that the user is a reviewer, control proceeds to 540. otherwise, control proceeds to 544. At 540, the authentication and access module 226 initializes the review platform generation module 238. At 544, the authentication and access module 226 initializes the user platform generation module 240.

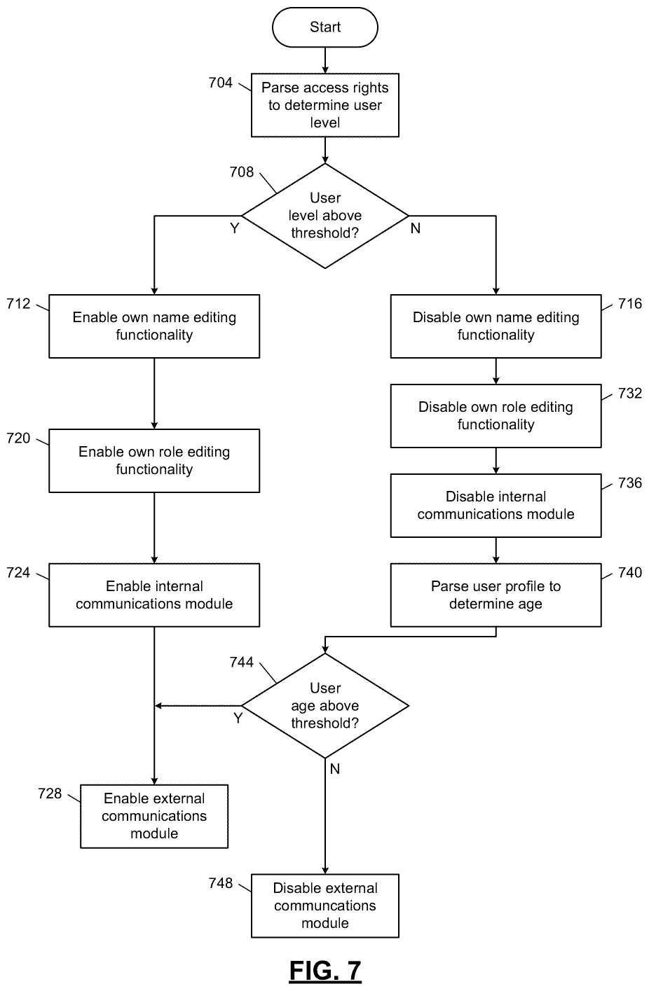

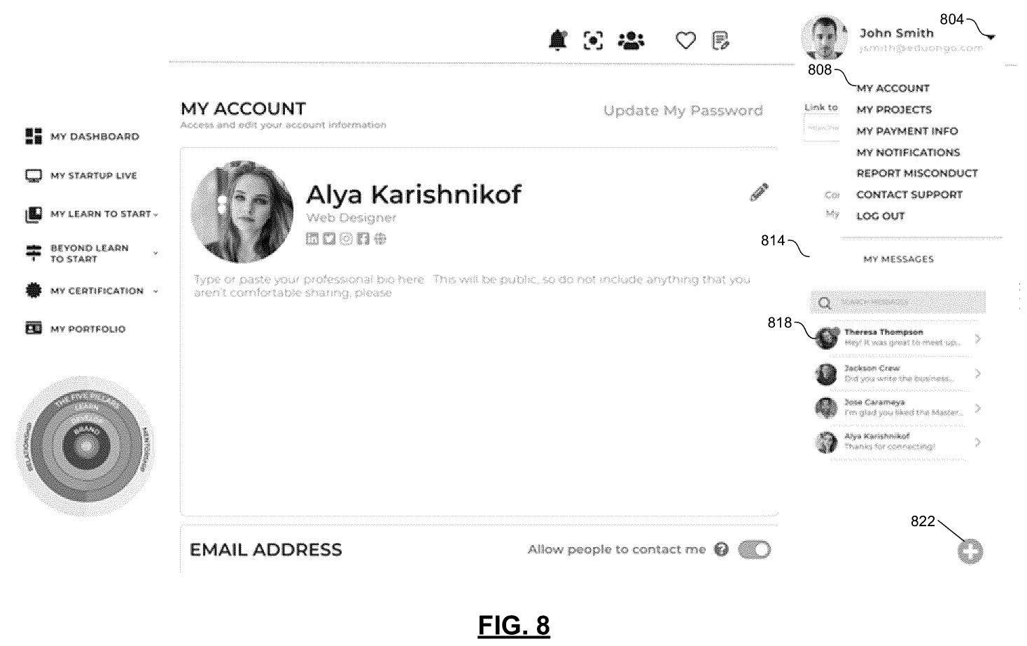

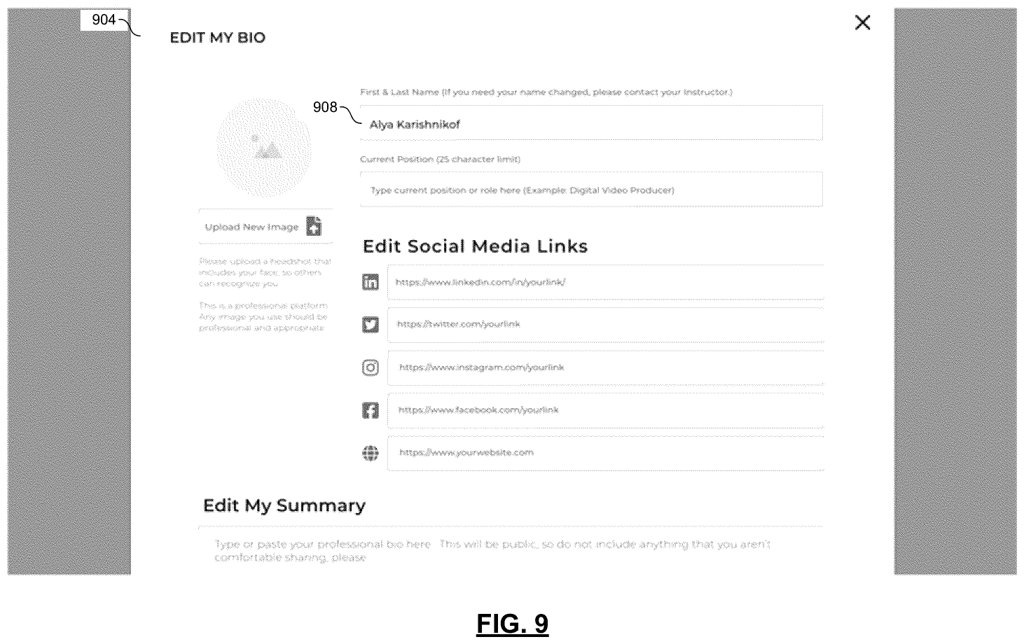

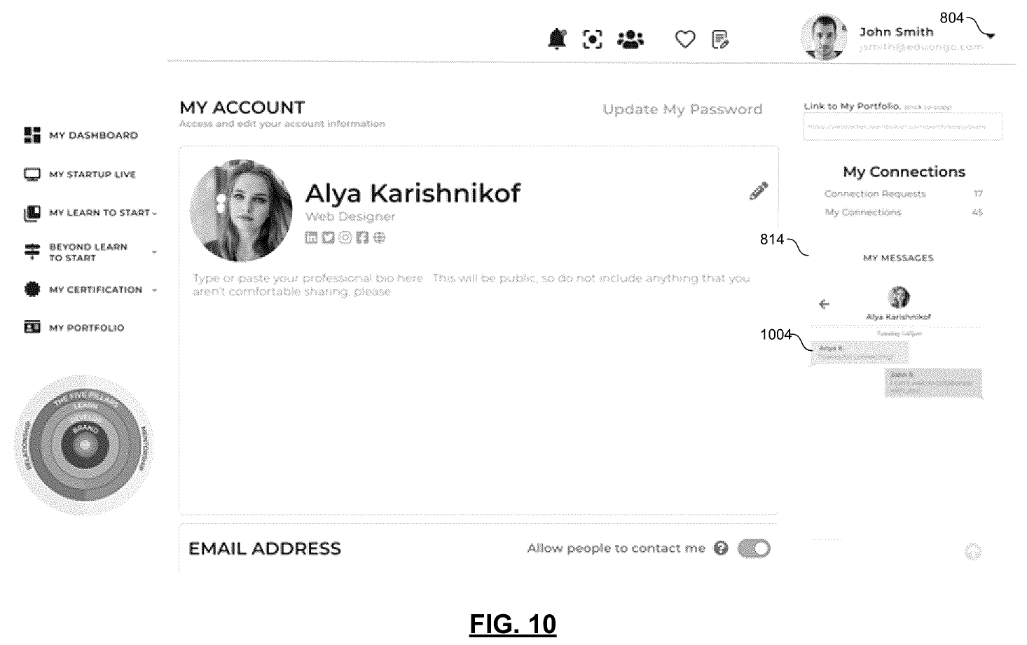

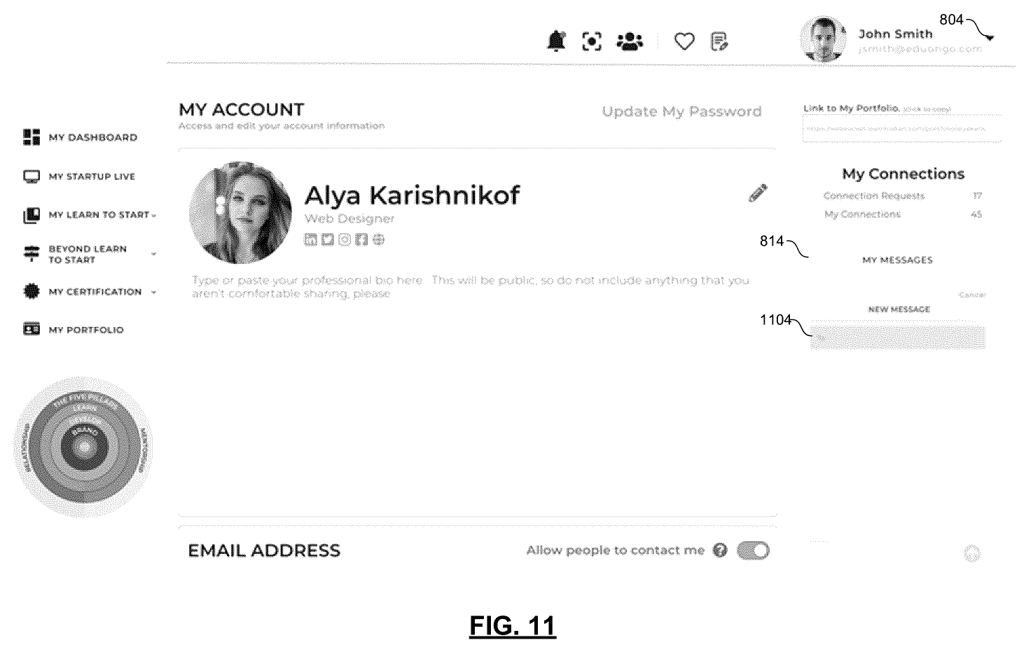

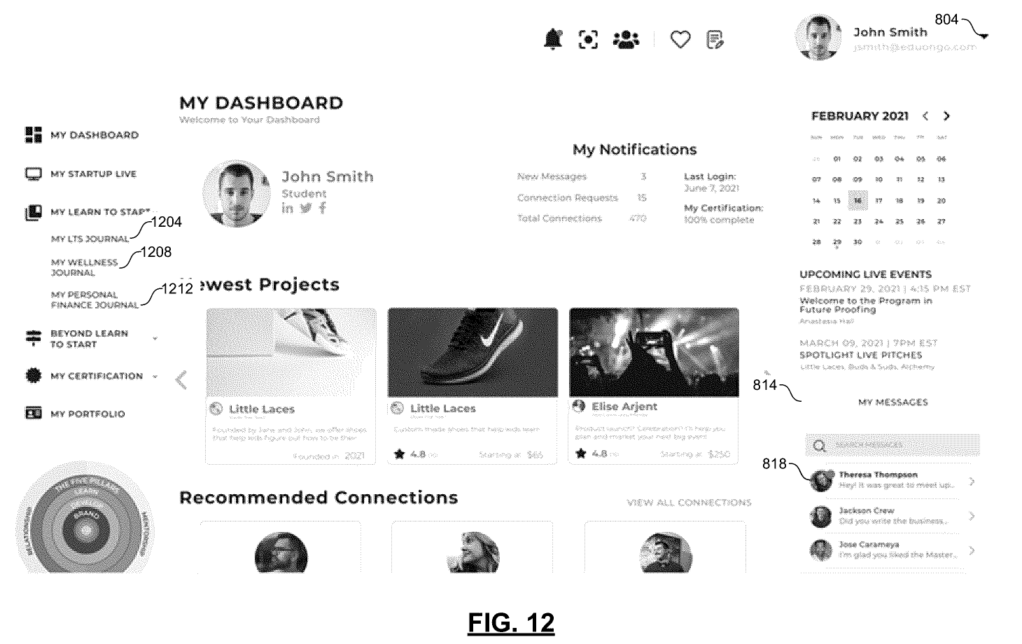

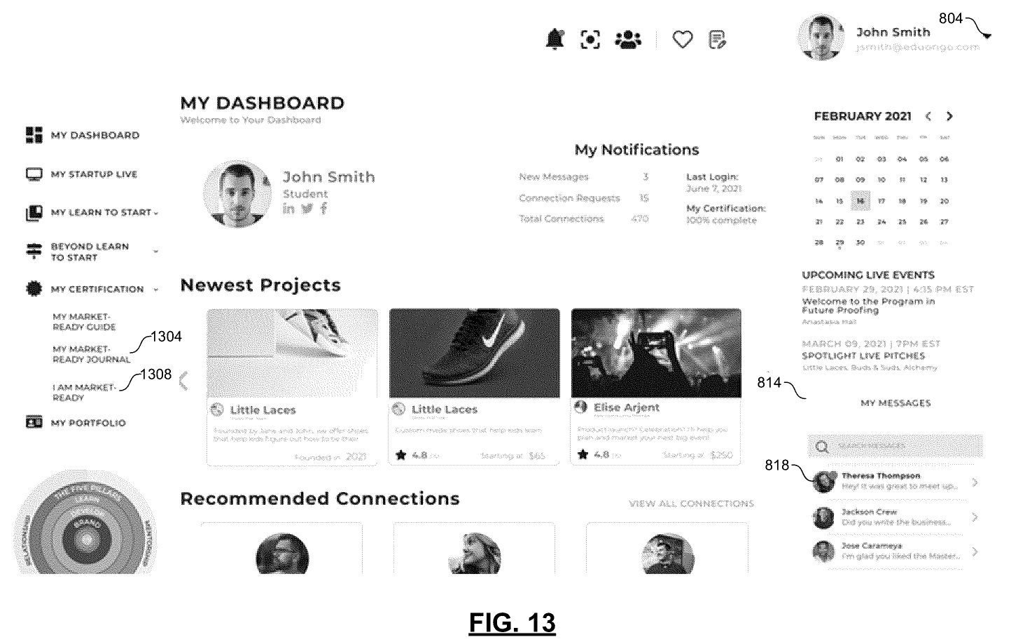

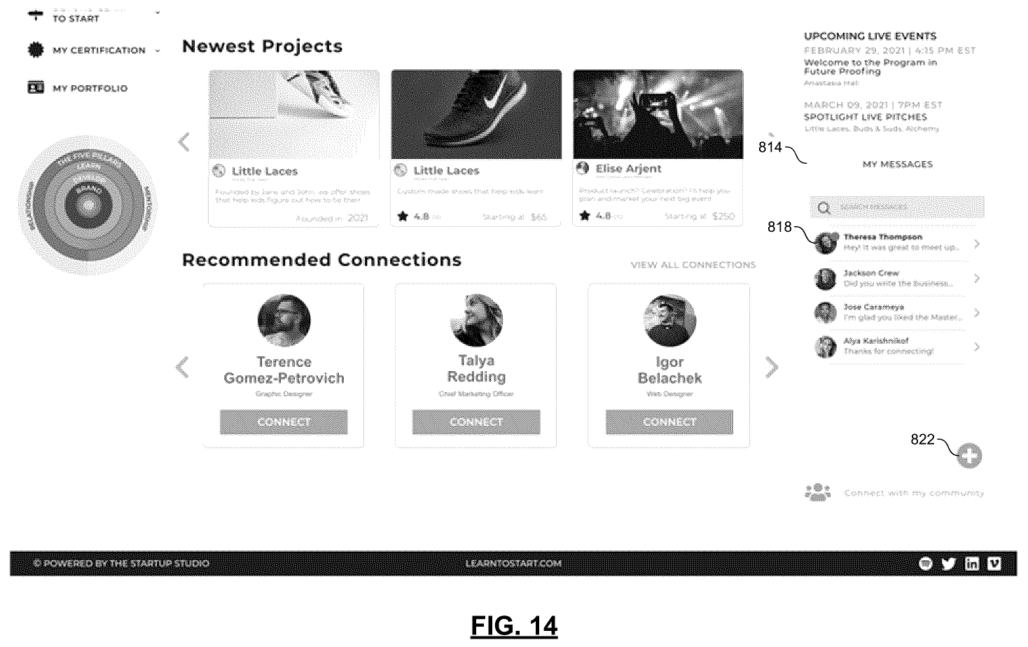

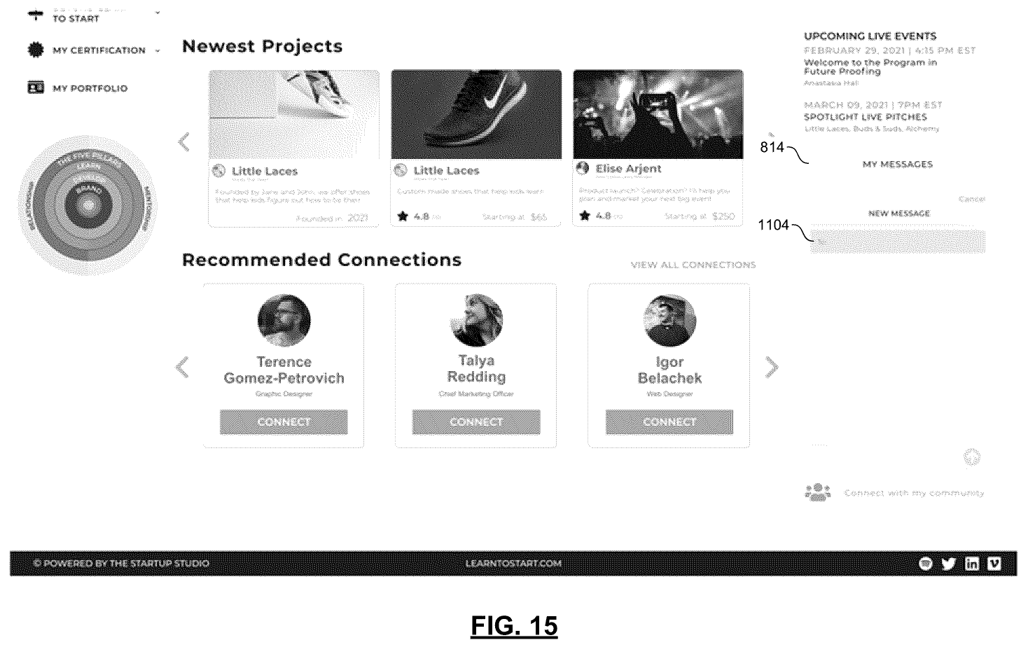

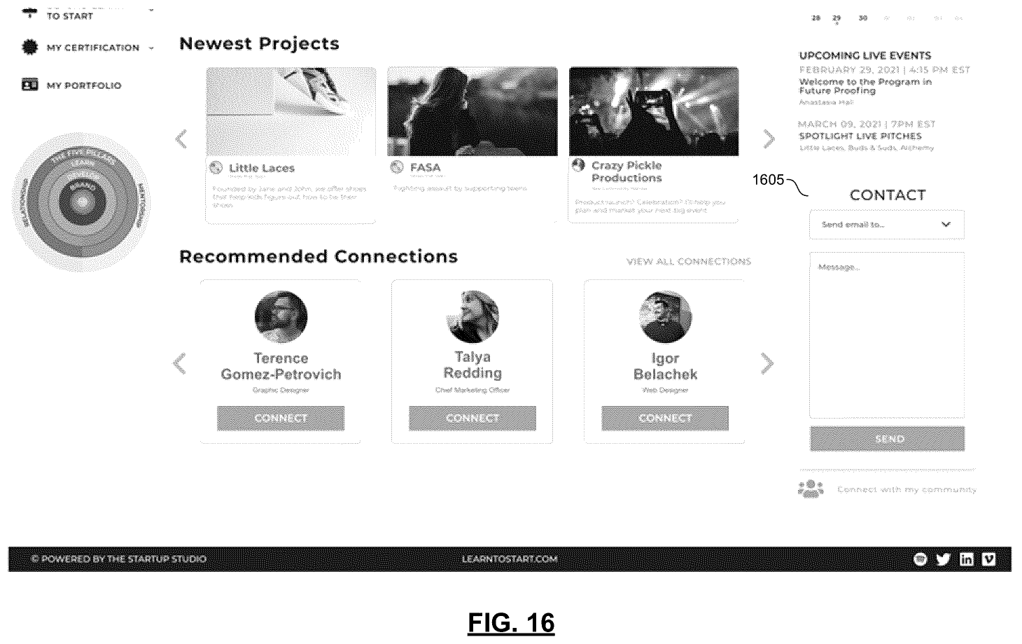

FIG. 7 is a flowchart of an example process for automatically initializing the user platform generation module 240 according to characteristics of a user profile. FIGS. 8-16 illustrate example user interface elements that may be automatically generated when the user platform generation module 240 is initialized. In various implementations, FIGS. 8-11 may be referred to as an account or “My Accounts” page. In various implementations, FIGS. 12-16 may be referred to as a dashboard or “My Dashboard” page. At 704, the user platform generation module 240 parses the access rights retrieved at 524 to determine the user's level. In various implementations, there may be four levels. For example, the user's level may be one of Levels 1-4. Control proceeds to 708. At 708, the user platform generation module 240 determines whether the user level is above a threshold. In various implementations, the threshold may be Level 3. If at 708 the user platform generation module 240 determines that the user level is above the threshold, control proceeds to 712. Otherwise, control proceeds to 716.

At 712, the user platform generation module 240 enables functionality allowing the user to edit their name. For example, if the user is the first user corresponding to the first user profile 338, then the enabled functionality may enable the user to edit a data object corresponding to their name. In various implementations, the data object may be stored in the user profile 352. In various implementations, to access the name editing functionality, the user may select the user profile drop-down menu 804 and select the “My Account” element 808 from the drop-down menu 804. After the “My Account” element 808 is selected, the user platform generation module 240 generates a pop-up page 904 with a field 908 allowing the user to edit their own name. Control proceeds to 720.

At 720, the user platform generation module 240 enables functionality allowing the user to edit their own role. In various implementations, the user's role may be stored in the user profile database 304. For example, if the user is the first user corresponding to the first user profile 338, the user's role may be stored in the access rights 350 and/or the user profile 352. Control proceeds to 724. At 724, the user platform generation module 240 may enable the internal communications module 274. The internal communications module 274 may enable the user to communicate with other users for whom the internal communications module 274 is enabled. In various implementations, if the internal communications module 274 is enabled, the user platform generation module 240 may generate a “My Messages” element 814 on the user interface. In various implementations, the “My Messages” element 814 may allow the user to communicate with other users. For example, if the user selects an existing messaging thread 818, the user platform generation module 240 generates and displays a messaging dialog 1004 that shows a chat history between the user and another user as well as allowing the user to send new messages to the another user.

In various implementations, if the internal communications module 274 is enabled, the user platform generation module 240 may generate a new messages element 822 on the user interface. If the user selects the new messages element 822, the user platform generation module may generate a new message dialog 1104 that allows the user to send messages to another user with whom there is not an existing chat history. Control proceeds to 728. At 728, the user platform generation module 240 enables the external communications module 278. In various implementations, the external communications module 278 may allow the user to communicate with other users outside of the distributed client integration and interconnect platform 104. For example, in various implementations, the external communications module 278 may be an email module.

If the external communications module 278 is enabled, the user platform generation module 240 may generate and output an external messaging dialog 1605 to the user interface. In various implementations, the external messaging dialog 1605 may allow the user to send emails to users of the distributed client integration and interconnect platform 104 as well as users external to the distributed client integration and interconnect platform 104.

At 716, the user platform generation module 240 disables the own name editing functionality for the user. Control proceeds to 732. At 732, the user platform generation module 240 disables the own role editing functionality. Control proceeds to 736. At 736, the user platform generation module 240 does not initialize and/or disables the internal communications module 274 for the user. Control proceeds to 740. At 740, the user platform generation module 240 parses data from the user profile databases 304 to determine the user's age. For example, if the user is associated with the first user profile 338, the user platform generation module 240 parses the user profile 352. Control proceeds to 744. If at 744 the user platform generation module 240 determines that the user's age is above a threshold, control proceeds to 728. Otherwise, control proceeds to 748. At 748, the user platform generation module 240 does not initialize and/or disables the external communications module 748.

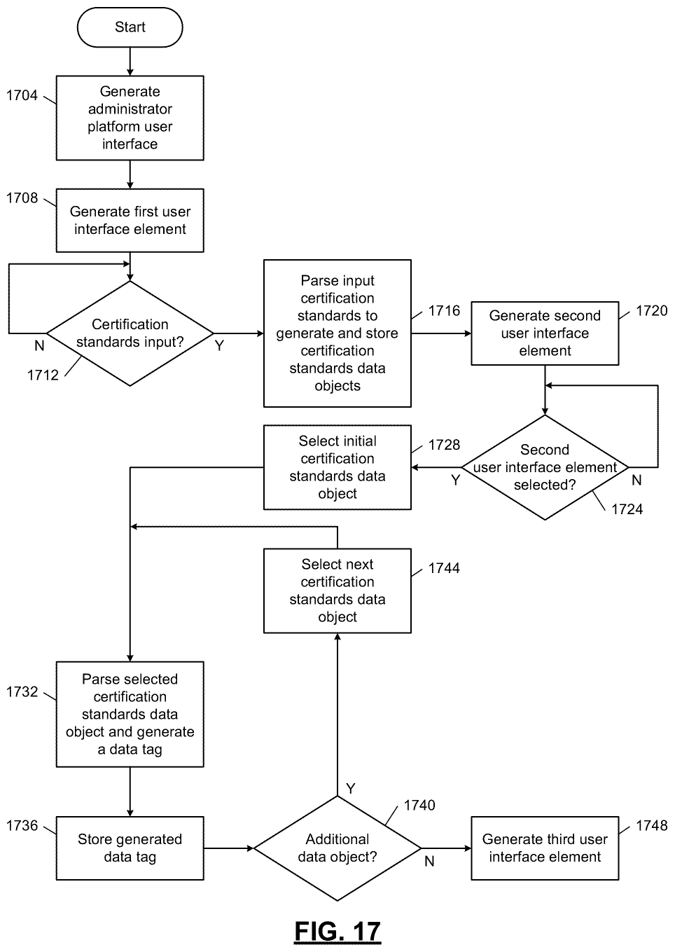

FIG. 17 is a flowchart of an example process for automatically generating and transforming a user interface for defining certification standards data objects 312 and creating generated data tags 314 after the administrator platform generation module 230 is initialized. At 1704, the administrator platform generation module 230 generates an administrator platform user interface. Control proceeds to 1708. At 1708, the administrator platform generation module generates a first user interface element. In various implementations, the first user interface element allows the administrator to input certification standards. Control proceeds to 1712. At 1712, the administrator platform generation module 230 determines whether certification standards are input. If at 1712, the administrator platform generation module 230 determines that certification standards have not been input, control proceeds back to 1712. Otherwise, if at 1712 the administrator platform generation module 230 determines that certification standards have been input, control proceeds to 1716.

At 1716, the administrator platform generation module 230 parses the certification standards input by the user to generate certification standards data objects 312. The administrator platform generation module 230 then stores the generated certification standards data objects 312 in the certification standards database 306. Control proceeds to 1720. At 1720, the administrator platform generation module 230 generates a second user interface element. In various implementations, the second user interface element may allow the administrator to initiate a process for automatically generating data tags based on the certification standards data objects 312. Control proceeds to 1724. At 1724, the administrator platform generation module 230 determines whether the second user interface element is selected. If at 1724 the administrator platform generation module 230 determines that the second user interface element was not selected, control proceeds back to 1724. If at 1724 the administrator platform generation module 230 determines that the second user interface element was selected, control proceeds to 1728.

At 1728, the administrator platform generation module 230 selects the initial certification standards data object from the certification standards data objects 312. Control proceeds to 1732. At 1732, the administrator platform generation module 230 parses the selected certification standards data object and generates a data tag based on the certification standards data object. Control proceeds to 1736. At 1736, the administrator platform generation module 230 stores the generated data tag in the certification standards database 306. For example, the administrator platform generation module 230 adds the generated data tag to the generated data tags 314. Control proceeds to 1740. At 1740, the administrator platform generation module 230 determines whether there is an additional certification standards data object present in the certification standards data objects 312. If yes, control proceeds to 1744. Otherwise, control proceeds to 1748.

At 1744, the administrator platform generation module 230 selects the next certification standards data object from the certification standards data objects 312 and proceeds back to 1732. At 1748, the administrator platform generation module 230 generates a third user interface element. In various implementations, the third user interface element alerts the administrator that the automatic certification standards data tag generation process is complete.

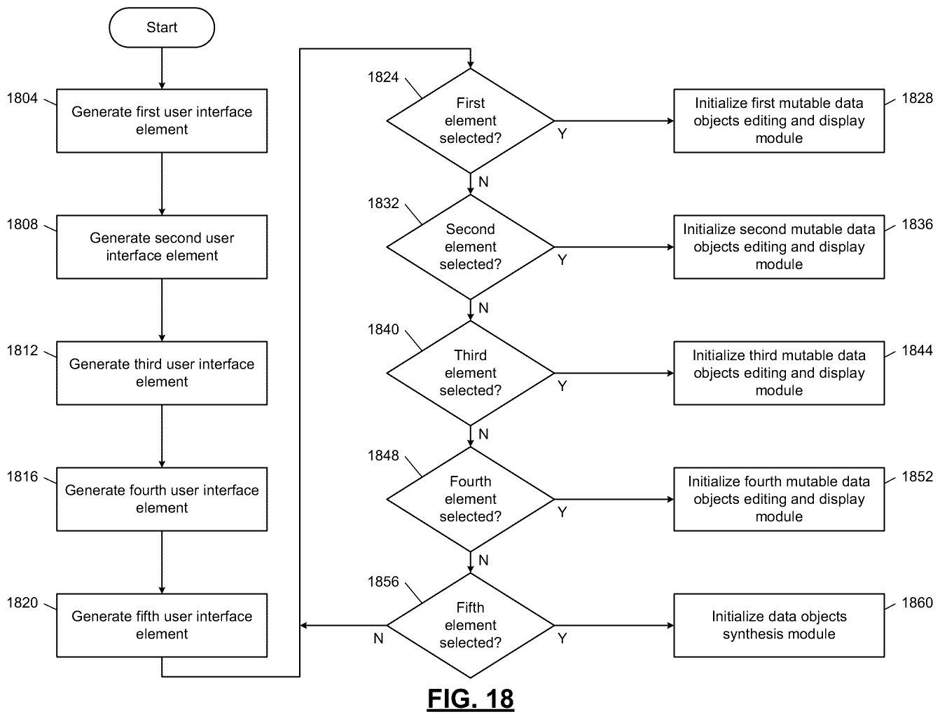

FIG. 18 is a flowchart of an example process for automatically initializing the user platform generation module 240 by generating selectable user interface elements. At 1804, the user platform generation module 240 generates a first user interface element. In various implementations, the first user interface element may be a selectable element, such as a “My LTS Journal” element 1204. Control proceeds to 1808. At 1808, the user platform generation module 240 generates a second user interface element. In various implementations, the second user interface element may be a selectable element, such as a “My Wellness Journal” element 1208. Control proceeds to 1812. At 1812, the user platform generation module 240 generates a third user interface element. In various implementations, the third user interface element may be a selectable element, such as a “My Personal Finance Journal” element 1212. Control proceeds to 1816.

At 1816, the user platform generation module 240 generates a fourth user interface element. In various implementations, the fourth user interface element may be a selectable element, such as a “My Market-Ready Journal” element 1304. Control proceeds to 1820. At 1820, the user platform generation module 240 generates a fifth user interface element. In various implementations, the fifth user interface element may be a selectable element, such as an “I Am Market-Ready” element 1308 (also referred to as an “IAMR” element). Control proceeds to 1824. At 1824, the user platform generation module 240 determines whether the first element was selected by the user. If the first element was selected, control proceeds to 1828, where the user platform generation module 240 initializes the first mutable data objects editing and display module 254. Otherwise, control proceeds to 1832.

At 1832, the user platform generation module 240 determines whether the second element was selected by the user. If the second element was selected, control proceeds to 1836, where the user platform generation module 240 initializes the second mutable data objects editing and display module 258. Otherwise, control proceeds to 1840. At 1840, the user platform generation module 240 determines whether the third element was selected by the user. If the third element was selected, control proceeds to 1844, where the user platform generation module 240 initializes the third mutable data objects editing and display module 262. Otherwise, control proceeds to 1848. At 1848, the user platform generation module 240 determines whether the fourth element was selected by the user. If the fourth element was selected, control proceeds to 1852, where the user platform generation module 240 initializes the fourth mutable data objects editing and display module 266. Otherwise, control proceeds to 1856. At 1856, the user platform generation module 240 determines whether the fifth element was selected by the user. If the fifth element was selected, control proceeds to 1860 where the user platform generation module 240 initializes the data object synthesis module 270. Otherwise, control proceeds back to 1824.

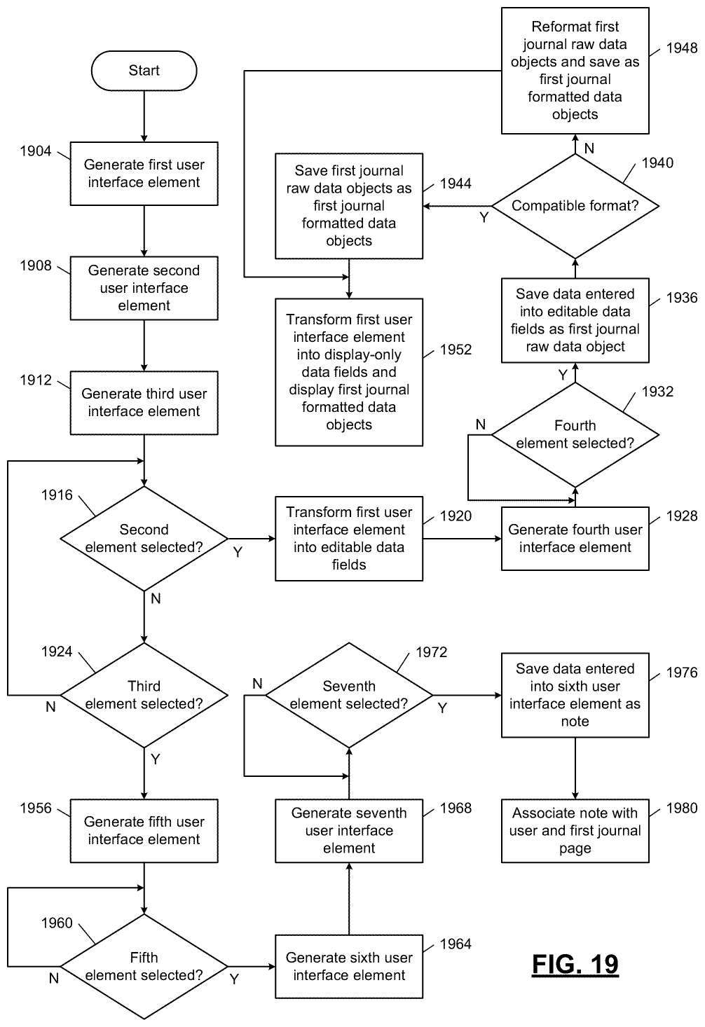

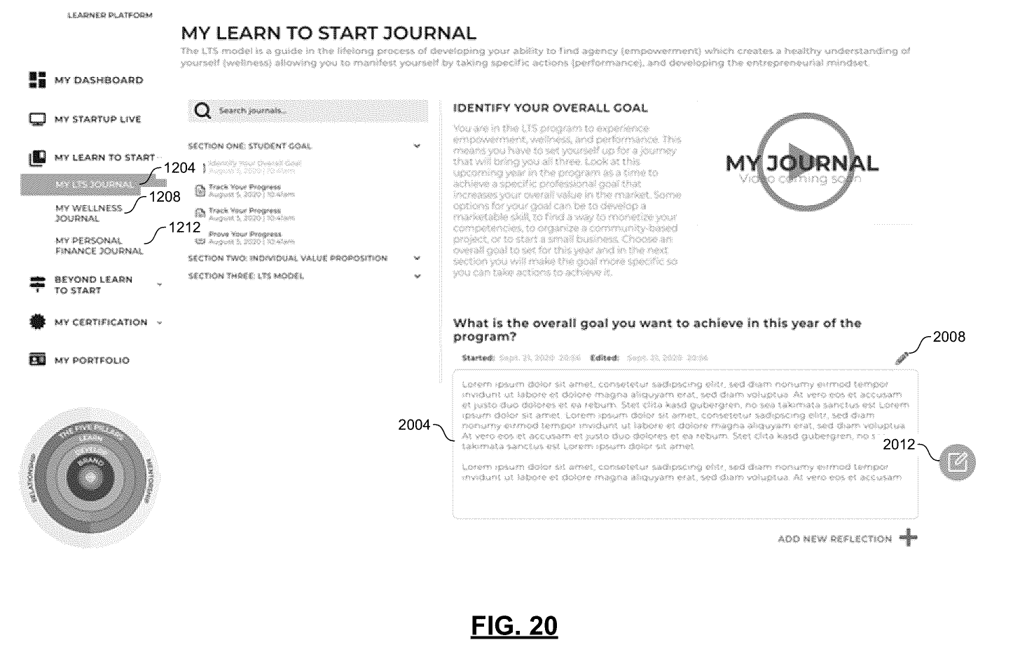

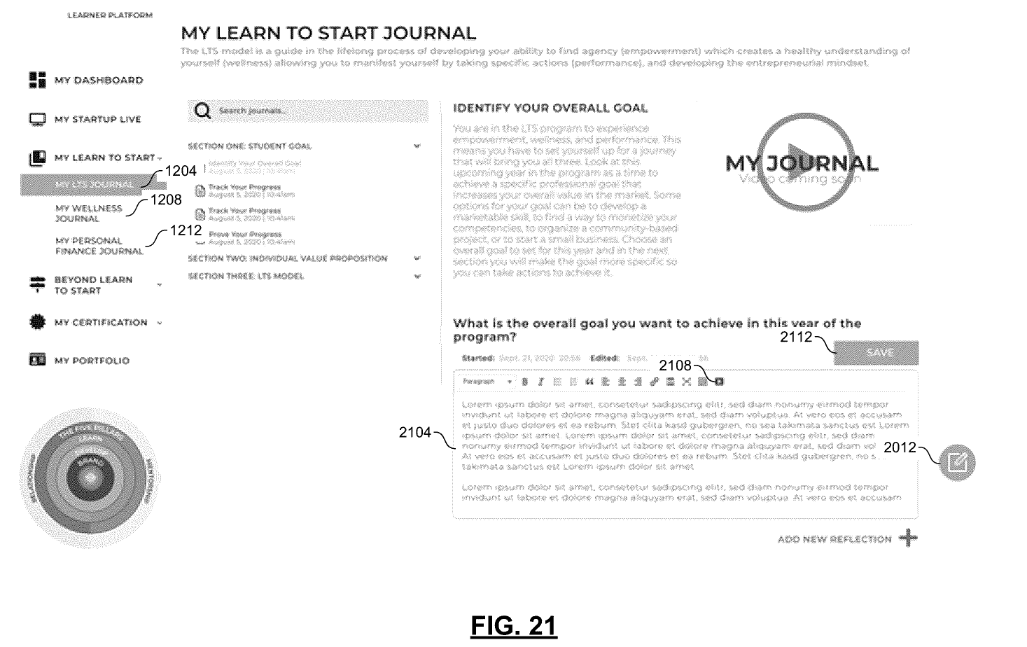

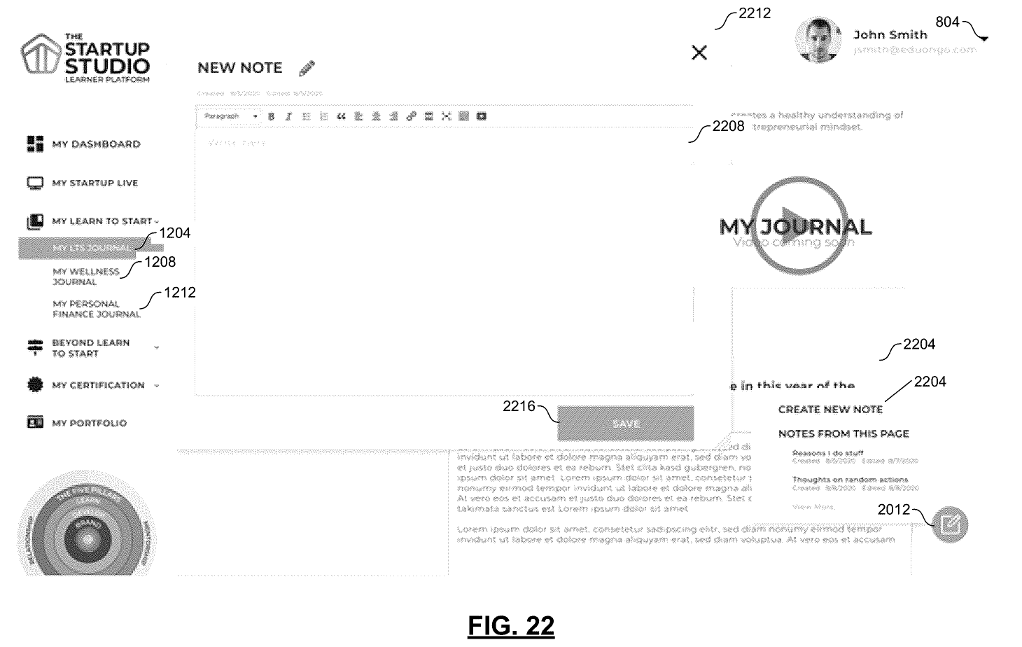

FIG. 19 is a flowchart of an example process for generating user interfaces and adding data objects to the user profile databases 304 after the first mutable data objects editing and display module 254 is initialized. FIGS. 20-22 illustrate example user interface elements that may be generated when the first mutable data objects editing and display module 254 is initialized. In various implementations, FIGS. 20-22 may be referred to as a first journal or “My LTS Journal” page. At 1904, the first mutable data objects editing and display module 254 generates a first user interface element. In various implementations, the first user interface element may be a display-only text box 2004. Control proceeds to 1908. At 1908, the first mutable data objects editing and display module 254 generates a second user interface element. In various implementations, the second user interface element may be a selectable button 2008. Control proceeds to 1912. At 1912, the first mutable data objects editing and display module 254 generates a third user interface element. In various implementations, the third user interface element may be a selectable button 2012. Control proceeds to 1916.

At 1916, the first mutable data objects editing and display module 254 determines whether the second user interface element was selected. If the second user interface element was selected, control proceeds to 1920. Otherwise, control proceeds to 1924. At 1920, the first mutable data objects editing and display module 254 transforms the first user interface element into editable data fields. In various implementations, the editable data fields may be an editable text box 2104. In various implementations, the editable text box 2104 may include selectable buttons 2108 that allow the user to attach files (such as audio, image, and/or video files). Control proceeds to 1928. At 1928, the first mutable data objects editing and display module 254 generates a fourth user interface element. In various implementations, the fourth user interface element may be a selectable button 2112. Control proceeds to 1932. At 1932, the first mutable data objects editing and display module 254 determines whether the fourth user interface element was selected. If the fourth user interface element was selected, control proceeds to 1936. Otherwise, control proceeds back to 1932.

At 1936, the first mutable data objects editing and display module 254 saves the data entered into the editable data fields as first journal raw data objects 354. In various implementations, the first journal raw data objects 354 may include the attached files. Control proceeds to 1940. At 1940, the first mutable data objects editing and display module 254 determines whether the data entered into the editable data fields and/or the attached files are in a compatible format. For example, a compatible format may be a format usable by the first mutable data objects editing and display module 254 and/or the data object synthesis module 270. If the entered data and/or the attached files are in a compatible format, control proceeds to 1944. Otherwise, control proceeds to 1948.

At 1944, the first mutable data objects editing and display module 254 saves the first journal raw data objects 354 as the first journal formatted data objects 356 and proceeds to 1952. At 1948, the first mutable data objects editing and display module 254 saves reformats the first journal raw data objects 354 into formats usable by the first mutable data objects editing and display module 254 and/or the data object synthesis module 270 and saves the reformatted data objects as the first journal formatted data objects 356. Control proceed to 1952. At 1952, the first mutable data objects editing and display module 254 transforms the first user interface element back into display-only data fields and displays at least a portion of the first journal formatted data objects 356.

At 1924, the first mutable data objects editing and display module 254 determines whether the third user interface element was selected. If the third user interface element was selected, control proceeds to 1956. Otherwise, control proceeds back to 1916. At 1956, the first mutable data objects editing and display module 254 generates a fifth user interface element. In various implementations, the fifth user interface element may be a “Create New Note” selectable element 2204. Control proceeds to 1960. At 1960, the first mutable data objects editing and display module 254 determines whether the fifth user interface element was selected. If the fifth user interface element was selected, control proceeds to 1964. Otherwise, control proceeds back to 1960. At 1964, the first mutable data objects editing and display module 254 generates a sixth user interface element. In various implementations, the sixth user interface element may include an editable text field 2208 within a pop-up field 2212. Control proceeds to 1968.

At 1968, the first mutable data objects editing and display module 254 may generate a seventh user interface element. In various implementations, the seventh user interface element may be a selectable button 2216. Control proceeds to 1972. At 1972, the first mutable data objects editing and display module 254 may determine whether the seventh user interface element was selected. If the seventh user interface element was selected, control proceeds to 1976. Otherwise, control proceeds back to 1972. At 1976, the first mutable data objects editing and display module 254 saves the data entered into the sixth user interface element as a note. Control proceeds to 1980. At 1980, the first mutable data objects editing and display module 254 associates the note with the user and the first journal page.

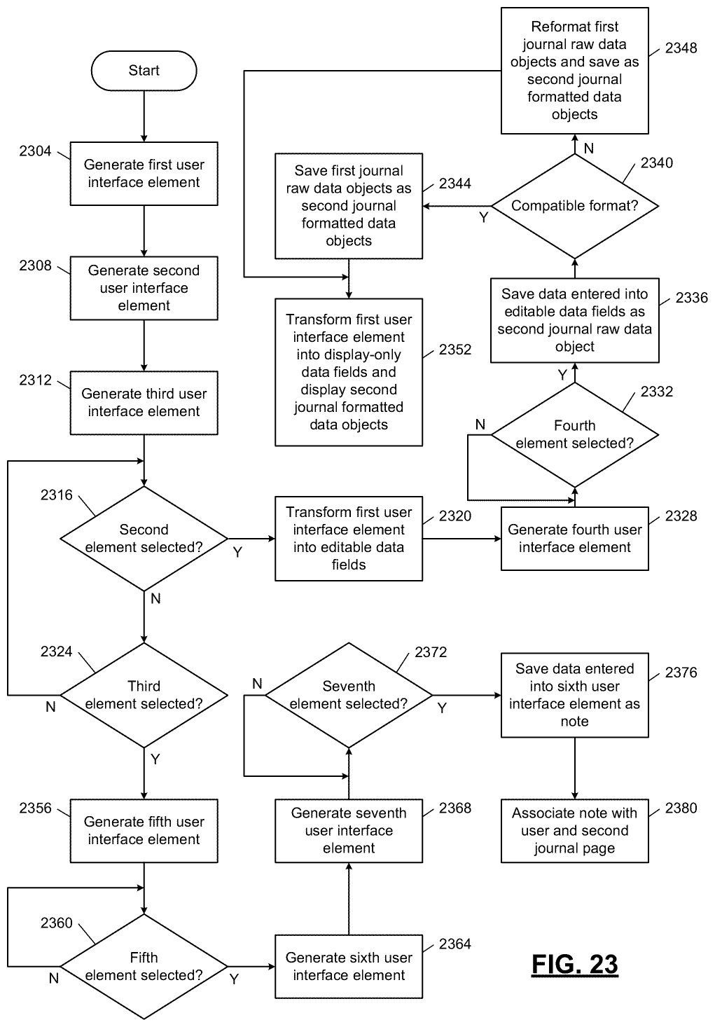

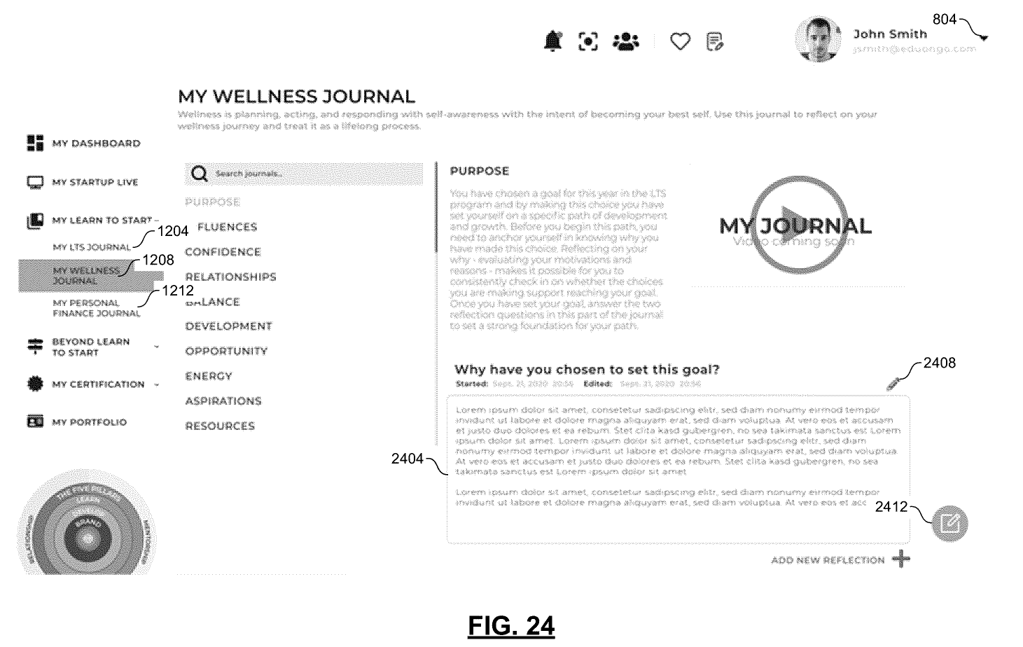

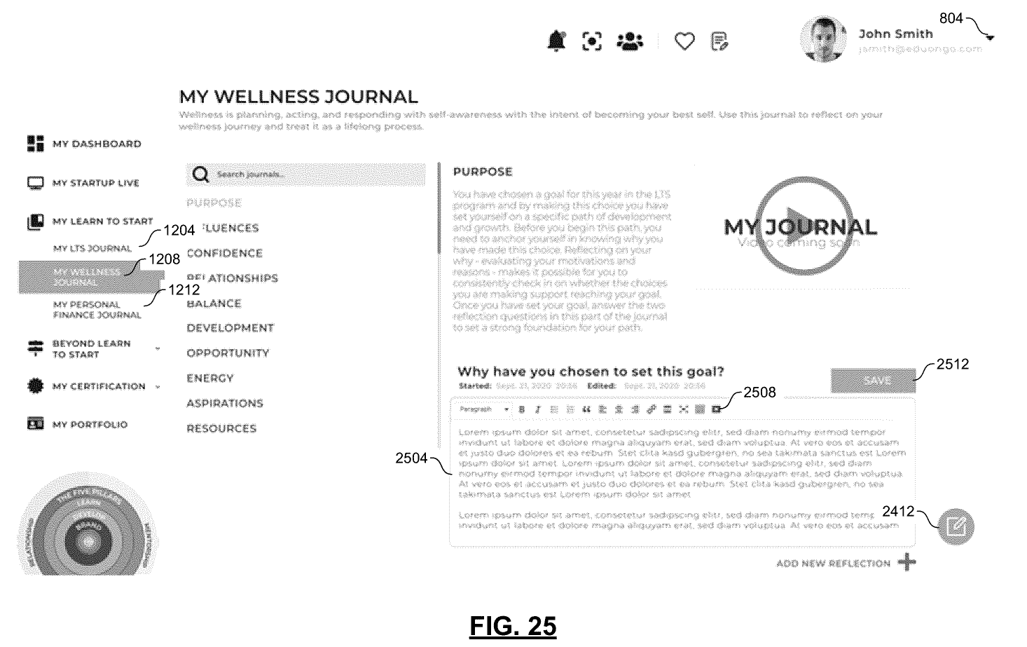

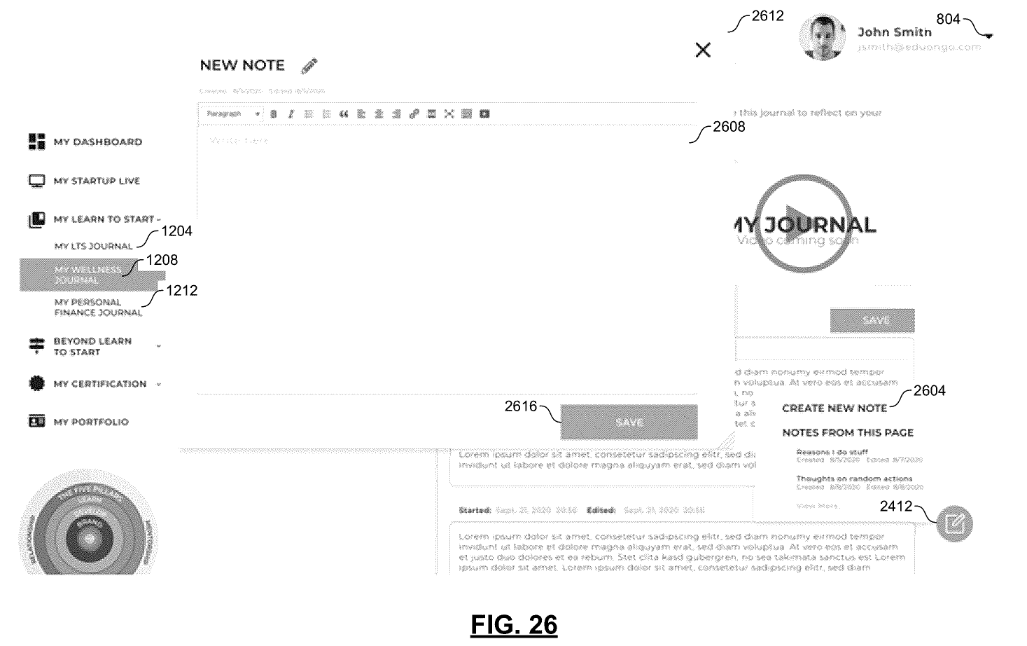

FIG. 23 is a flowchart of an example process for generating user interfaces and adding data objects to the user profile databases 304 after the second mutable data objects editing and display module 258 is initialized. FIGS. 24-26 illustrate example user interface elements that may be generated when the second mutable data objects editing and display module 258 is initialized. In various implementations, FIGS. 24-26 may be referred to as a second journal or “My Wellness Journal” page. At 2304, the second mutable data objects editing and display module 258 generates a first user interface element. In various implementations, the first user interface element may be a display-only text box 2404. Control proceeds to 2308. At 2308, the second mutable data objects editing and display module 258 generates a second user interface element. In various implementations, the second user interface element may be a selectable button 2408. Control proceeds to 2312. At 2312, the second mutable data objects editing and display module 258 generates a third user interface element. In various implementations, the third user interface element may be a selectable button 2412. Control proceeds to 2316.

At 2316, the second mutable data objects editing and display module 258 determines whether the second user interface element was selected. If the second user interface element was selected, control proceeds to 2320. Otherwise, control proceeds to 2324. At 2320, the second mutable data objects editing and display module 258 transforms the first user interface element into editable data fields. In various implementations, the editable data fields may be an editable text box 2504. In various implementations, the editable text box 2504 may include selectable buttons 2508 that allow the user to attach files (such as audio, image, and/or video files). Control proceeds to 2328. At 2328, the first mutable data objects editing and display module 254 generates a fourth user interface element. In various implementations, the fourth user interface element may be a selectable button 2512. Control proceeds to 2332. At 2332, the second mutable data objects editing and display module 258 determines whether the fourth user interface element was selected. If the fourth user interface element was selected, control proceeds to 2336. Otherwise, control proceeds back to 2332.

At 2336, the second mutable data objects editing and display module 258 saves the data entered into the editable data fields as second journal raw data objects 360. In various implementations, the second journal raw data objects 360 may include the attached files. Control proceeds to 2340. At 2340, the second mutable data objects editing and display module 258 determines whether the data entered into the editable data fields and/or the attached files are in a compatible format. For example, a compatible format may be a format usable by the second mutable data objects editing and display module 258 and/or the data object synthesis module 270. If the entered data and/or the attached files are in a compatible format, control proceeds to 2344. Otherwise, control proceeds to 2348.

At 2344, the second mutable data objects editing and display module 258 saves the second journal raw data objects 360 as the second journal formatted data objects 362 and proceeds to 2352. At 2348, the second mutable data objects editing and display module 258 saves reformats the second journal raw data objects 360 into formats usable by the second mutable data objects editing and display module 258 and/or the data object synthesis module 270 and saves the reformatted data objects as the second journal formatted data objects 362. Control proceed to 2352. At 2352, the second mutable data objects editing and display module 258 transforms the first user interface element back into display-only data fields and displays at least a portion of the second journal formatted data objects 362.

At 2324, the second mutable data objects editing and display module 258 determines whether the third user interface element was selected. If the third user interface element was selected, control proceeds to 2356. Otherwise, control proceeds back to 2316. At 2356, the second mutable data objects editing and display module 258 generates a fifth user interface element. In various implementations, the fifth user interface element may be a “Create New Note” selectable element 2604. Control proceeds to 2360. At 2360, the second mutable data objects editing and display module 258 determines whether the fifth user interface element was selected. If the fifth user interface element was selected, control proceeds to 2364. Otherwise, control proceeds back to 2360. At 2364, the second mutable data objects editing and display module 258 generates a sixth user interface element. In various implementations, the sixth user interface element may include an editable text field 2608 within a pop-up field 2612. Control proceeds to 2368.

At 2368, the second mutable data objects editing and display module 258 may generate a seventh user interface element. In various implementations, the seventh user interface element may be a selectable button 2616. Control proceeds to 2372. At 2372, the second mutable data objects editing and display module 258 may determine whether the seventh user interface element was selected. If the seventh user interface element was selected, control proceeds to 2376. Otherwise, control proceeds back to 2372. At 2376, the second mutable data objects editing and display module 258 saves the data entered into the sixth user interface element as a note. Control proceeds to 2380. At 2380, the second mutable data objects editing and display module 258 associates the note with the user and the second journal page.

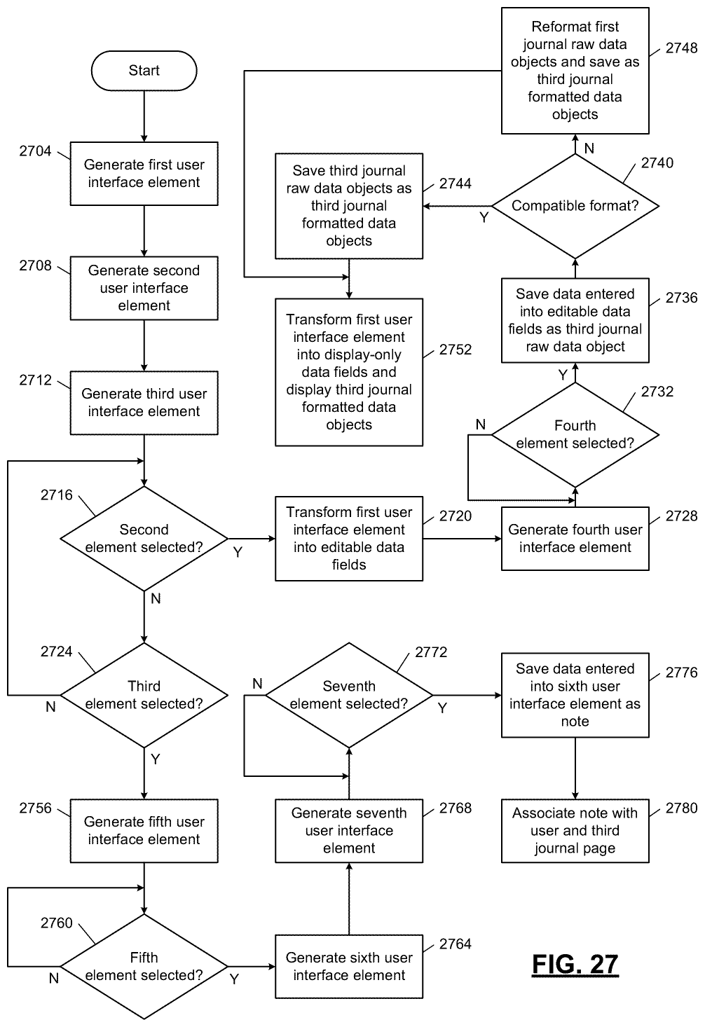

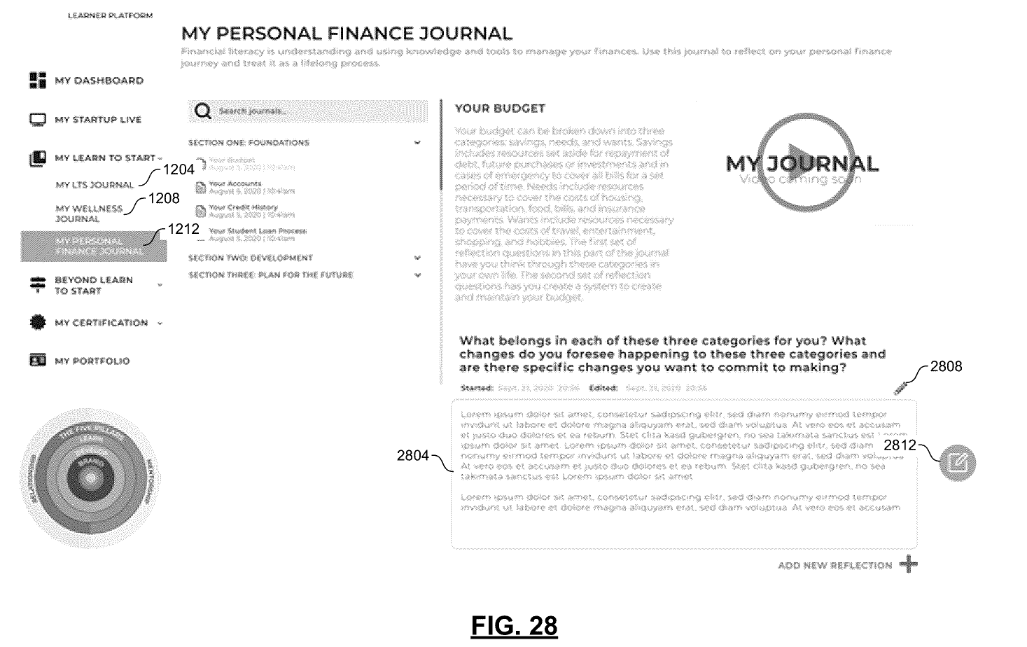

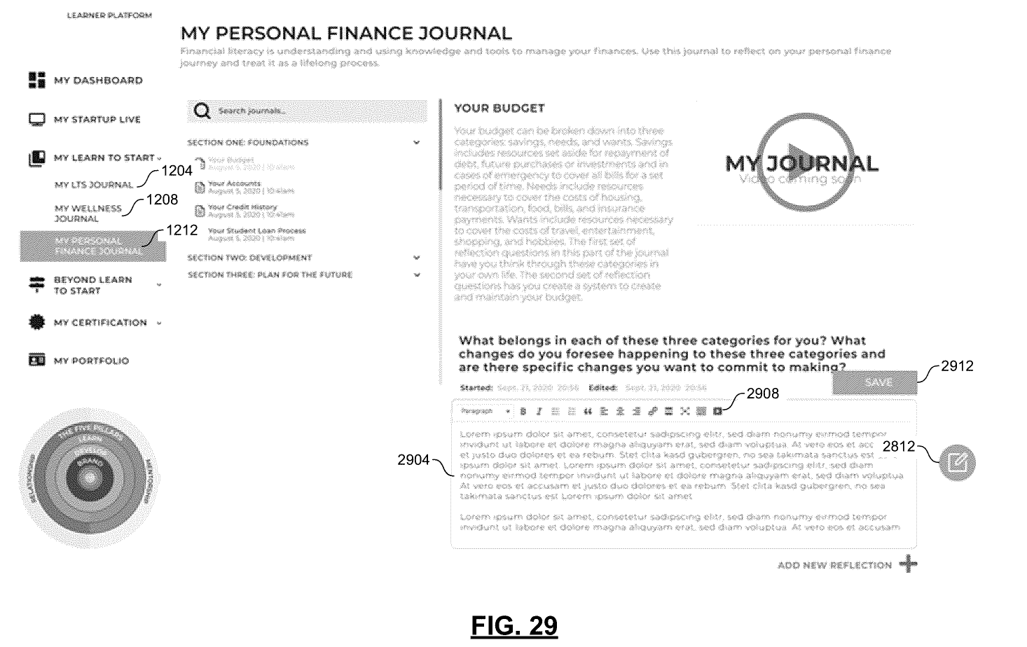

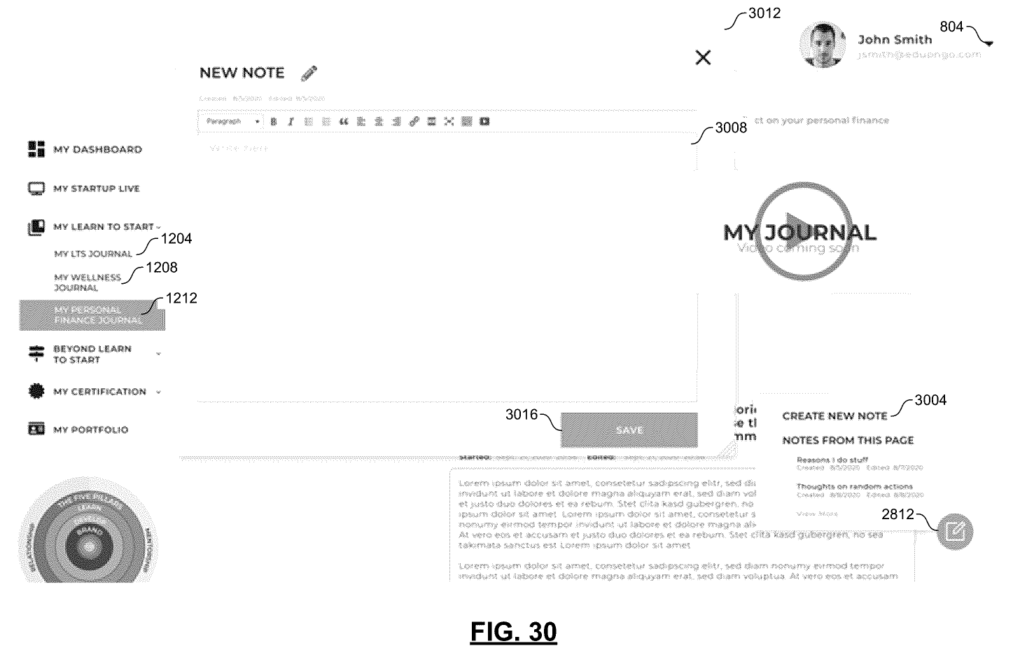

FIG. 27 is a flowchart of an example process for generating user interfaces and adding data objects to the user profile databases 304 after the third mutable data objects editing and display module 262 is initialized. FIGS. 28-30 illustrate example user interface elements that may be generated when the third mutable data objects editing and display module 262 is initialized. In various implementations, FIGS. 28-30 may be referred to as a third journal or “My Personal Finance Journal” page. At 2704, the third mutable data objects editing and display module 262 generates a first user interface element. In various implementations, the first user interface element may be a display-only text box 2804. Control proceeds to 2708. At 2708, the third mutable data objects editing and display module 262 generates a second user interface element. In various implementations, the second user interface element may be a selectable button 2808. Control proceeds to 2712. At 2712, the third mutable data objects editing and display module 262 generates a third user interface element. In various implementations, the third user interface element may be a selectable button 2812. Control proceeds to 2716.

At 2716, the third mutable data objects editing and display module 262 determines whether the second user interface element was selected. If the second user interface element was selected, control proceeds to 2720. Otherwise, control proceeds to 2724. At 2720, the third mutable data objects editing and display module 262 transforms the first user interface element into editable data fields. In various implementations, the editable data fields may be an editable text box 2904. In various implementations, the editable text box 2904 may include selectable buttons 2908 that allow the user to attach files (such as audio, image, and/or video files). Control proceeds to 2728. At 2728, the first mutable data objects editing and display module 254 generates a fourth user interface element. In various implementations, the fourth user interface element may be a selectable button 2912. Control proceeds to 2732. At 2732, the third mutable data objects editing and display module 262 determines whether the fourth user interface element was selected. If the fourth user interface element was selected, control proceeds to 2736. Otherwise, control proceeds back to 2732.

At 2736, the third mutable data objects editing and display module 262 saves the data entered into the editable data fields as third journal raw data objects. In various implementations, the third journal raw data objects may include the attached files. Control proceeds to 2740. At 2740, the third mutable data objects editing and display module 262 determines whether the data entered into the editable data fields and/or the attached files are in a compatible format. For example, a compatible format may be a format usable by the third mutable data objects editing and display module 262 and/or the data object synthesis module 270. If the entered data and/or the attached files are in a compatible format, control proceeds to 2744. Otherwise, control proceeds to 2748.

At 2744, the third mutable data objects editing and display module 262 saves the third journal raw data objects as the third journal formatted data objects 368 and proceeds to 2752. At 2748, the third mutable data objects editing and display module 262 saves reformats the third journal raw data objects into formats usable by the third mutable data objects editing and display module 262 and/or the data object synthesis module 270 and saves the reformatted data objects as the third journal formatted data objects 368. Control proceed to 2752. At 2752, the third mutable data objects editing and display module 262 transforms the first user interface element back into display-only data fields and displays at least a portion of the third journal formatted data objects 368.

At 2724, the third mutable data objects editing and display module 262 determines whether the third user interface element was selected. If the third user interface element was selected, control proceeds to 2756. Otherwise, control proceeds back to 2716. At 2756, the third mutable data objects editing and display module 262 generates a fifth user interface element. In various implementations, the fifth user interface element may be a “Create New Note” selectable element 3004. Control proceeds to 2760. At 2760, the third mutable data objects editing and display module 262 determines whether the fifth user interface element was selected. If the fifth user interface element was selected, control proceeds to 2764. Otherwise, control proceeds back to 2760. At 2764, the third mutable data objects editing and display module 262 generates a sixth user interface element. In various implementations, the sixth user interface element may include an editable text field 3008 within a pop-up field 3012. Control proceeds to 2768.

At 2768, the third mutable data objects editing and display module 262 may generate a seventh user interface element. In various implementations, the seventh user interface element may be a selectable button 3016. Control proceeds to 2772. At 2772, the third mutable data objects editing and display module 262 may determine whether the seventh user interface element was selected. If the seventh user interface element was selected, control proceeds to 2776. Otherwise, control proceeds back to 2772. At 2776, the third mutable data objects editing and display module 262 saves the data entered into the sixth user interface element as a note. Control proceeds to 2780. At 2780, the third mutable data objects editing and display module 262 associates the note with the user and the third journal page.

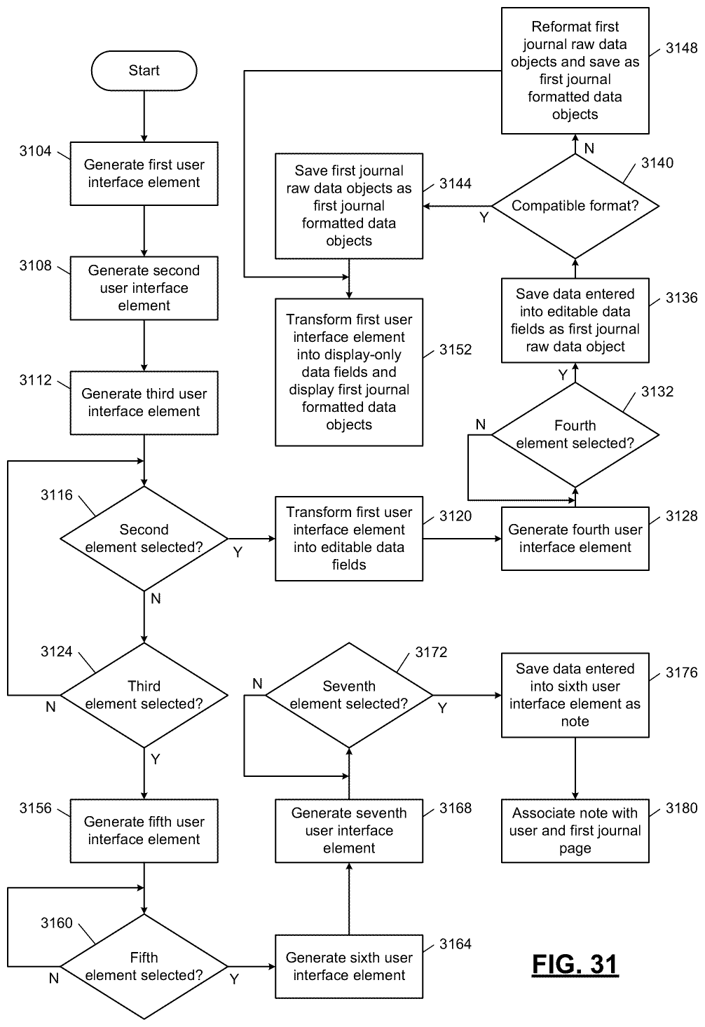

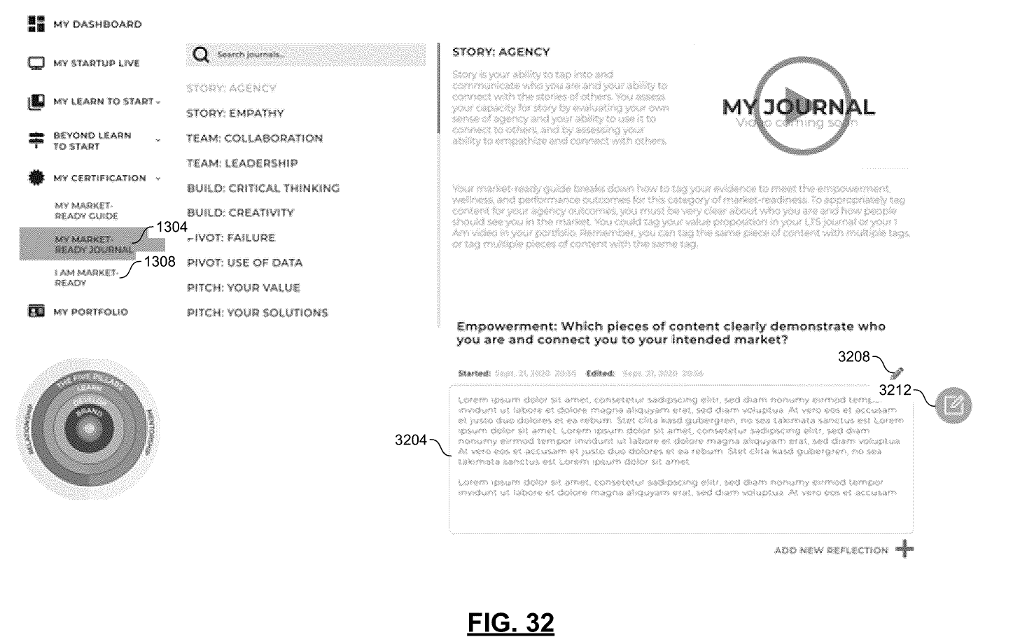

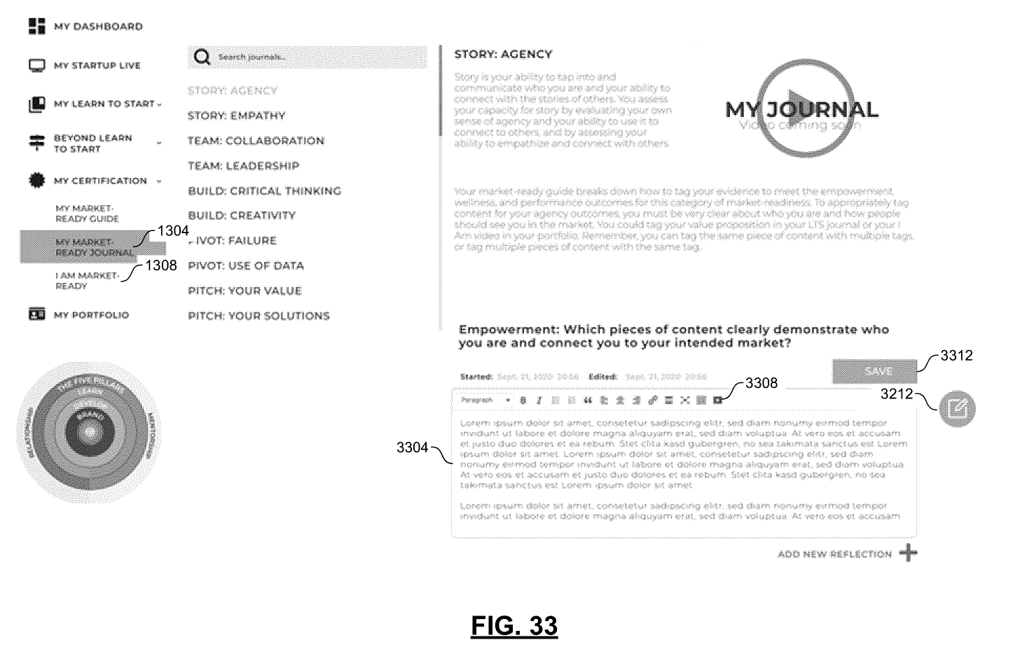

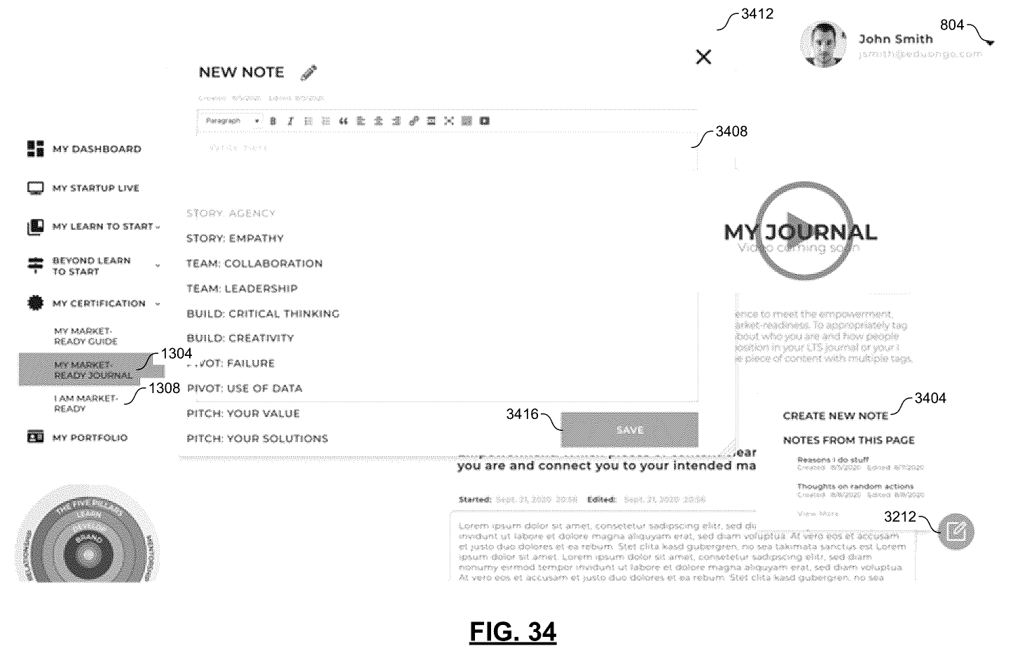

FIG. 31 is a flowchart of an example process for generating user interfaces and adding data objects to the user profile databases 304 after the first mutable data objects editing and display module 254 is initialized. FIGS. 32-34 illustrate example user interface elements that may be generated when the first mutable data objects editing and display module 254 is initialized. In various implementations, FIGS. 32-34 may be referred to as a fourth journal or “My Market-Ready Journal” page. At 3104, the first mutable data objects editing and display module 254 generates a first user interface element. In various implementations, the first user interface element may be a display-only text box 3204. Control proceeds to 3108. At 3108, the first mutable data objects editing and display module 254 generates a second user interface element. In various implementations, the second user interface element may be a selectable button 3208. Control proceeds to 3112. At 3112, the first mutable data objects editing and display module 254 generates a third user interface element. In various implementations, the third user interface element may be a selectable button 3212. Control proceeds to 3116.

At 3116, the first mutable data objects editing and display module 254 determines whether the second user interface element was selected. If the second user interface element was selected, control proceeds to 3120. Otherwise, control proceeds to 3124. At 3120, the first mutable data objects editing and display module 254 transforms the first user interface element into editable data fields. In various implementations, the editable data fields may be an editable text box 3304. In various implementations, the editable text box 3304 may include selectable buttons 3308 that allow the user to attach files (such as audio, image, and/or video files). Control proceeds to 3128. At 3128, the first mutable data objects editing and display module 254 generates a fourth user interface element. In various implementations, the fourth user interface element may be a selectable button 3312. Control proceeds to 3132. At 3132, the first mutable data objects editing and display module 254 determines whether the fourth user interface element was selected. If the fourth user interface element was selected, control proceeds to 3136. Otherwise, control proceeds back to 3132.

At 3136, the first mutable data objects editing and display module 254 saves the data entered into the editable data fields as first journal raw data objects 354. In various implementations, the first journal raw data objects 354 may include the attached files. Control proceeds to 3140. At 3140, the first mutable data objects editing and display module 254 determines whether the data entered into the editable data fields and/or the attached files are in a compatible format. For example, a compatible format may be a format usable by the first mutable data objects editing and display module 254 and/or the data object synthesis module 270. If the entered data and/or the attached files are in a compatible format, control proceeds to 3144. Otherwise, control proceeds to 3148.

At 3144, the first mutable data objects editing and display module 254 saves the first journal raw data objects 354 as the first journal formatted data objects 356 and proceeds to 3152. At 3148, the first mutable data objects editing and display module 254 saves reformats the first journal raw data objects 354 into formats usable by the first mutable data objects editing and display module 254 and/or the data object synthesis module 270 and saves the reformatted data objects as the first journal formatted data objects 356. Control proceed to 3152. At 3152, the first mutable data objects editing and display module 254 transforms the first user interface element back into display-only data fields and displays at least a portion of the first journal formatted data objects 356.

At 3124, the first mutable data objects editing and display module 254 determines whether the third user interface element was selected. If the third user interface element was selected, control proceeds to 3156. Otherwise, control proceeds back to 3116. At 3156, the first mutable data objects editing and display module 254 generates a fifth user interface element. In various implementations, the fifth user interface element may be a “Create New Note” selectable element 3404. Control proceeds to 3160. At 3160, the first mutable data objects editing and display module 254 determines whether the fifth user interface element was selected. If the fifth user interface element was selected, control proceeds to 3164. Otherwise, control proceeds back to 3160. At 3164, the first mutable data objects editing and display module 254 generates a sixth user interface element. In various implementations, the sixth user interface element may include an editable text field 3408 within a pop-up field 3412. Control proceeds to 3168.

At 3168, the first mutable data objects editing and display module 254 may generate a seventh user interface element. In various implementations, the seventh user interface element may be a selectable button 3416. Control proceeds to 3172. At 3172, the first mutable data objects editing and display module 254 may determine whether the seventh user interface element was selected. If the seventh user interface element was selected, control proceeds to 3176. Otherwise, control proceeds back to 3172. At 3176, the first mutable data objects editing and display module 254 saves the data entered into the sixth user interface element as a note. Control proceeds to 3180. At 3180, the first mutable data objects editing and display module 254 associates the note with the user and the fourth journal page.

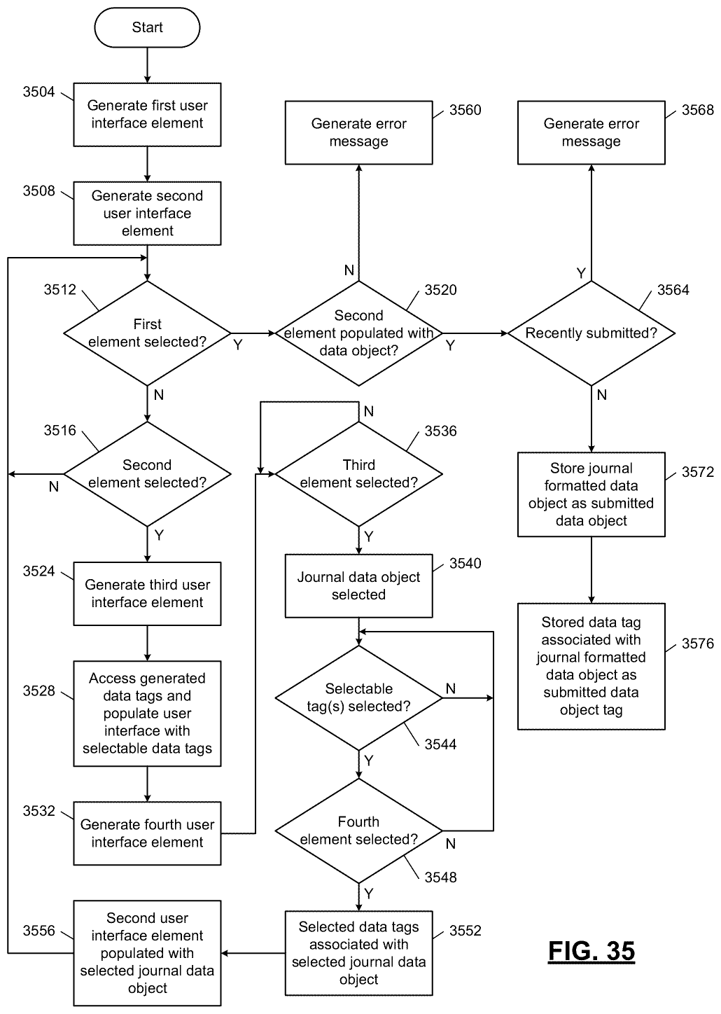

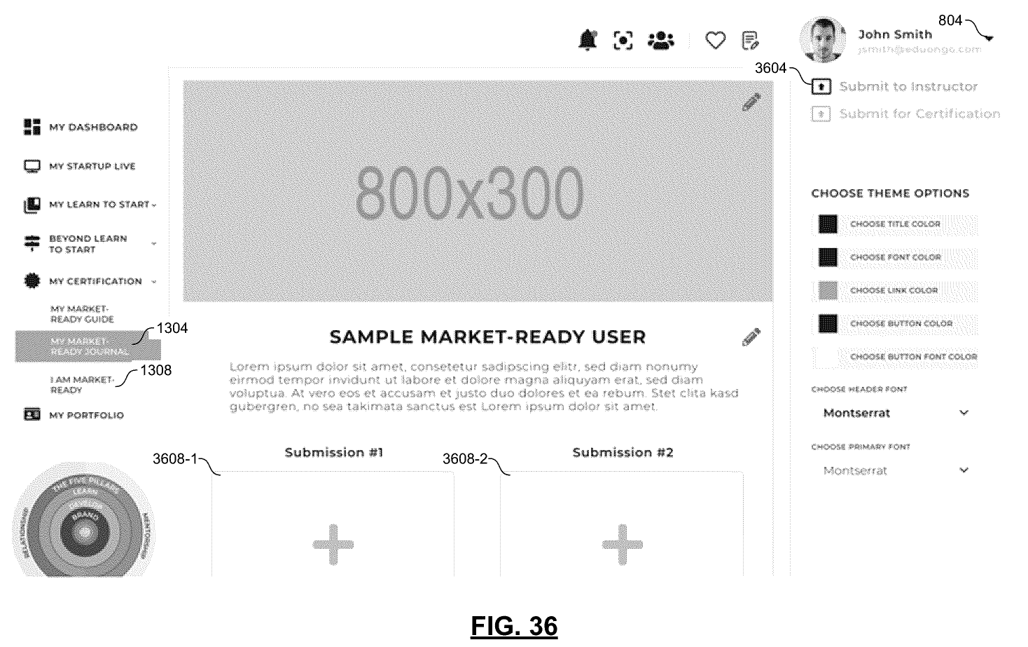

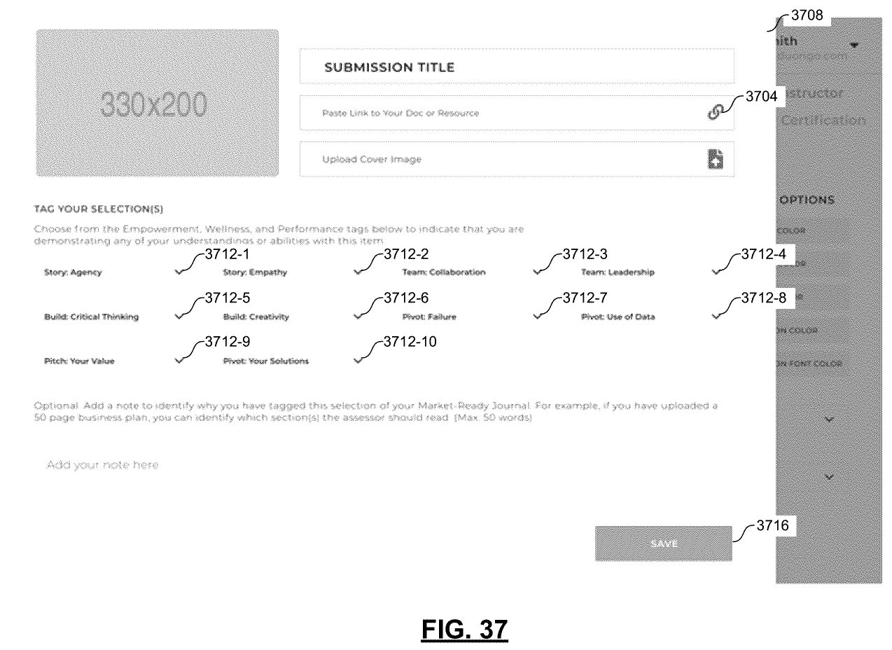

FIG. 35 is a flowchart of an example process for automatically generating user interfaces and processing data objects after the data object synthesis module 270 is initialized. FIGS. 36 and 37 illustrate example user interface elements that may be generated when the data object synthesis module 270 is initialized. In various implementations, the user interface elements of FIGS. 36 and 37 may be referred to as a submissions or “I Am Market-Ready” (“IAMR”) page. At 3504, the data object synthesis module 270 generates a first user interface element. In various implementations, the first user interface element may be a selectable button 3604, such as a “Submit to Instructor” button. Control proceeds to 3508. At 3508, the data object synthesis module 270 generates a second user interface element. In various implementations, the second user interface element may be a selectable data field 3608-1 or a selectable data field 3608-2, such as a “Submission” data field. Control proceeds to 3512.

At 3512, the data object synthesis module 270 determines whether the first user interface element was selected. If the first user interface element was not selected, control proceeds to 3516. Otherwise, if the first user interface element was selected, control proceeds to 3520. At 3516, the data object synthesis module 270 determines whether the second user interface element was selected. If the second user interface element was selected, control proceeds to 3524. Otherwise, control proceeds back to 3512. At 3524, the data object synthesis module 270 generates a third user interface element. In various implementations, the third user interface element may be a selectable upload field 3704 in a pop-up field 3708. Control proceeds to 3528. At 3528, the data object synthesis module 270 accesses the generated data tags 314 and selectable data tags based on the generated data tags 314. For example, if there are ten generated data tags 314, the data object synthesis module 270 may generate selectable data tags 3712 including ten selectable data tags 3712-1 through 3712-10. In various implementations, each of the selectable data tags 3712 may correspond to a respective one of the ten generated data tags 314. Control proceeds to 3532.

At 3532, the data object synthesis module 270 generates a fourth user interface element. In various implementations, the fourth user interface element may include a selectable button 3716, such as a “Save” button. Control proceeds to 3536. At 3536, the data object synthesis module 270 determines whether the third user interface element was selected. If the third user interface element was selected, control proceeds to 3540. Otherwise, control proceeds back to 3536. At 3540, a journal data object is selected based on the user's input to the third user interface element. For example, the data object synthesis module 270 may select one of the first journal formatted data objects 356, second journal formatted data objects 362, third journal formatted data objects 368, or fourth journal formatted data objects 374 corresponding to the user's input to the third user interface element. Control proceeds to 3544.

At 3544, the data object synthesis module 270 determines whether at least one of the selectable data tags 3712 have been selected. If at least one of the selectable data tags 3712 have been selected, control proceeds to 3548. Otherwise, control proceeds back to 3444. At 3548, the data object synthesis module 270 determines whether the fourth user interface element was selected. If the fourth user interface element was selected, control proceeds to 3552. Otherwise, control proceeds back to 3544. At 3552 the selectable data tags 3712 are associated with the selected journal data object. In various implementations, the generated data tags 314 may include metadata, and the metadata corresponding to the selectable data tags 3712 may be associated with the selected journal data object. Control proceeds to 3556. At 3556, the second user interface element is populated with a preview of the selected journal data object. Control proceeds back to 3512.

At 3520, the data object synthesis module 270 determines whether the second user interface element is populated with the selected journal data object. If the data object synthesis module 270 determines that the second user interface element is not populated with the selected journal data object, control proceeds to 3560, where the data object synthesis module 270 generates an error message. In various implementations, the error message may prompt the user to select the second user interface element to select a journal data object for submission. Otherwise, if at 3520 the data object synthesis module 270 determines that the second user interface element is populated with the selected journal data object, control proceeds to 3564. At 3564, the data object synthesis module 270 determines whether the user recently submitted journal data objects using the submissions page. For example, in various implementations, each submission from the submissions page may be logged in the submission logs 332. The data object synthesis module 270 may parse the submission logs 332 to determine whether the user submitted journal data objects within a previous period of time. If the data object synthesis module 270 determines that the user submitted journal data objects within the previous period of time, control proceeds to 3568. Otherwise, control proceeds to 3572.

At 3568, the data object synthesis module 270 generates an error message. In various implementations, the error message may indicate that an insufficient period of time has elapsed between the user's most recent submission and the user's current submission attempt. At 3572, the data object synthesis module 270 stores the journal data object selected at 3540 as a submitted data object in the submissions database 310. For example, if the user corresponds to the first user, the journal data object may be saved in submitted data objects 320. If the user corresponds to the n-th user, the journal data object may be saved in submitted data objects 326. Control proceeds to 3576. At 3576, the data object synthesis module 270 stores the data tags associated with the journal formatted data object as submitted data object tags in the submissions database 310. For example, if the user corresponds to the first user, the submitted data object tags may be saved in submitted data object tags 322 and associated with the relevant journal data object from the submitted data objects 320. If the user correspond to the n-th user, the submitted data object tags may be saved in submitted data object tags 328 and associated with the relevant journal data object from the submitted data objects 326.

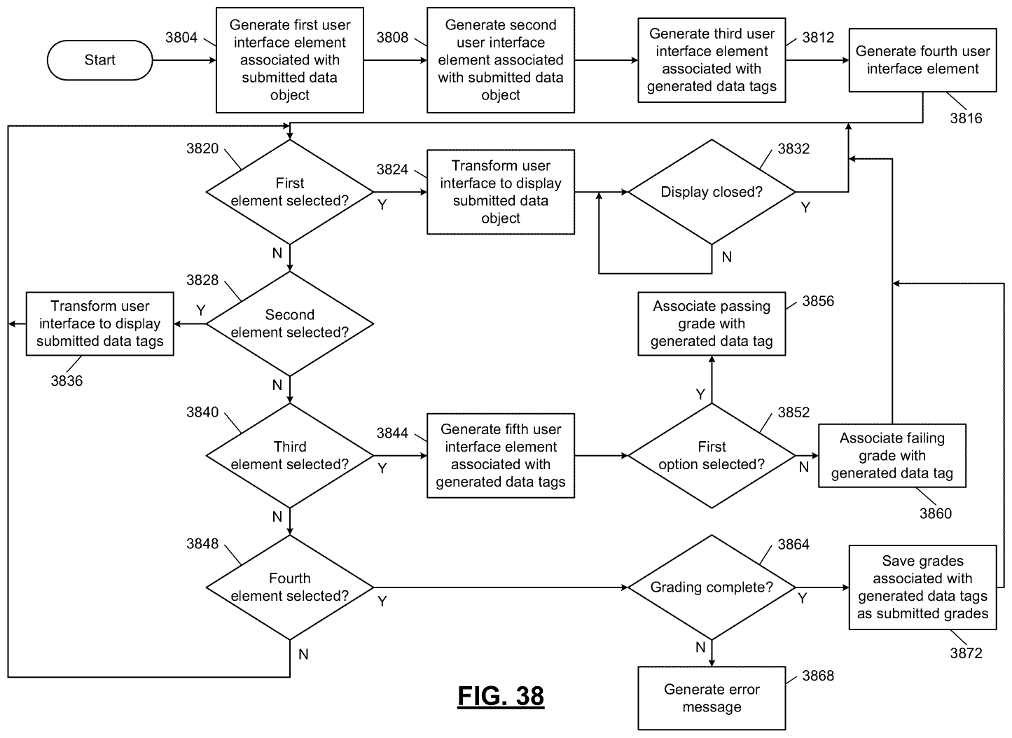

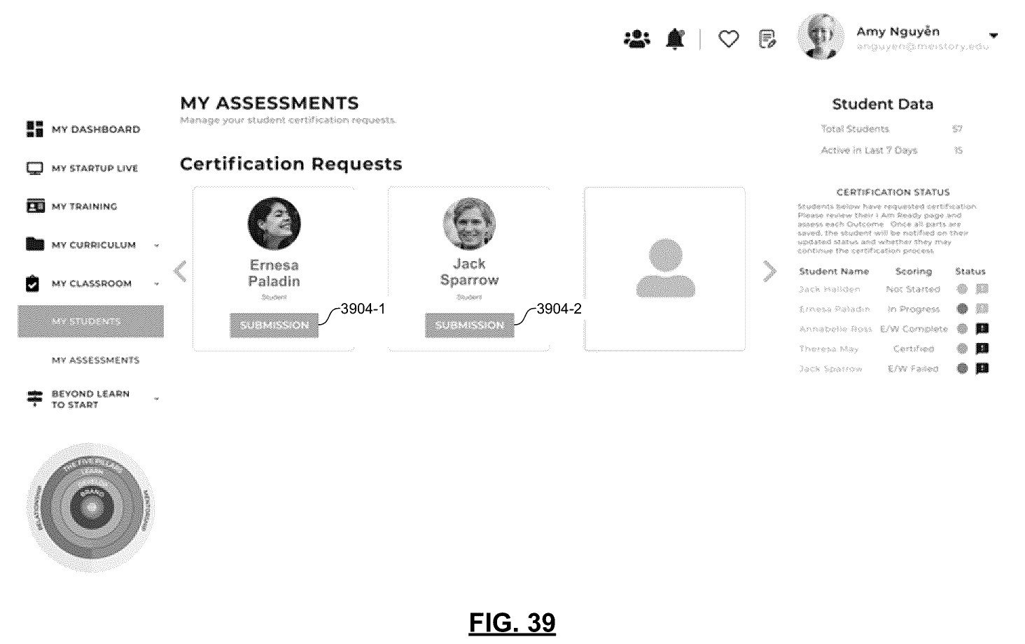

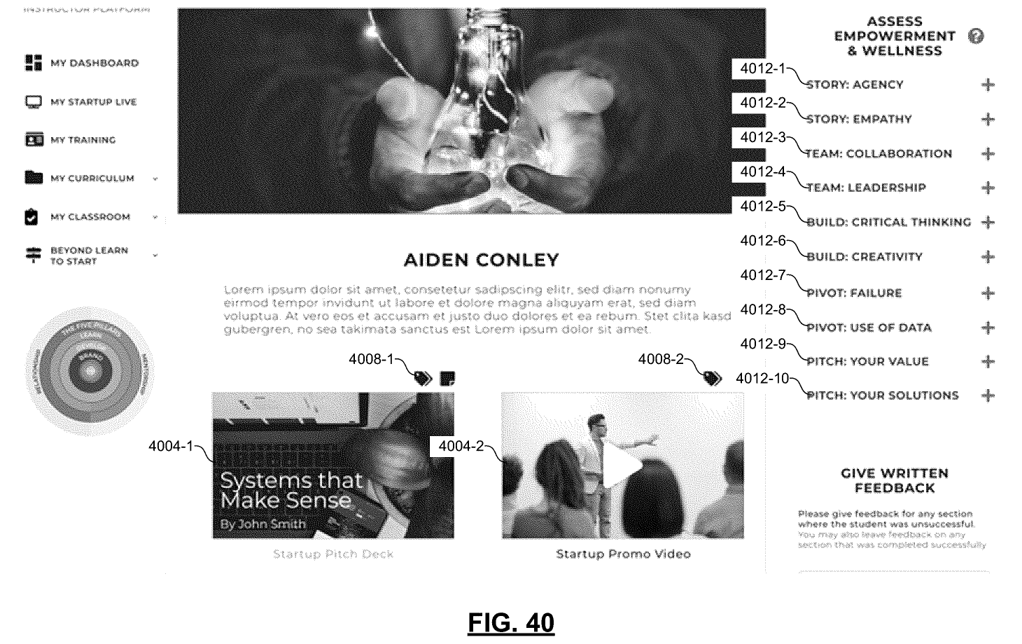

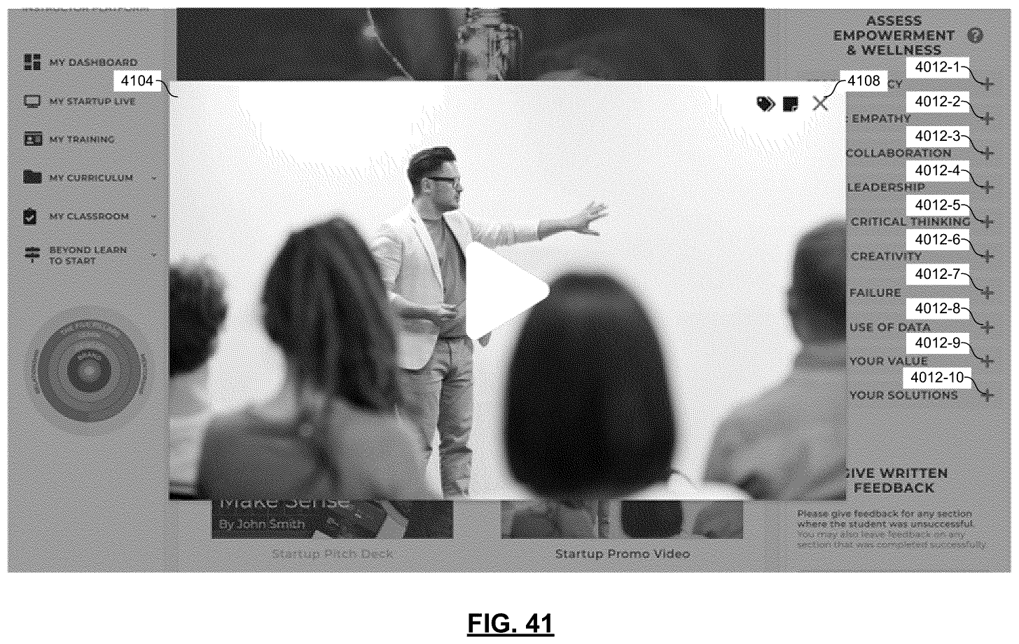

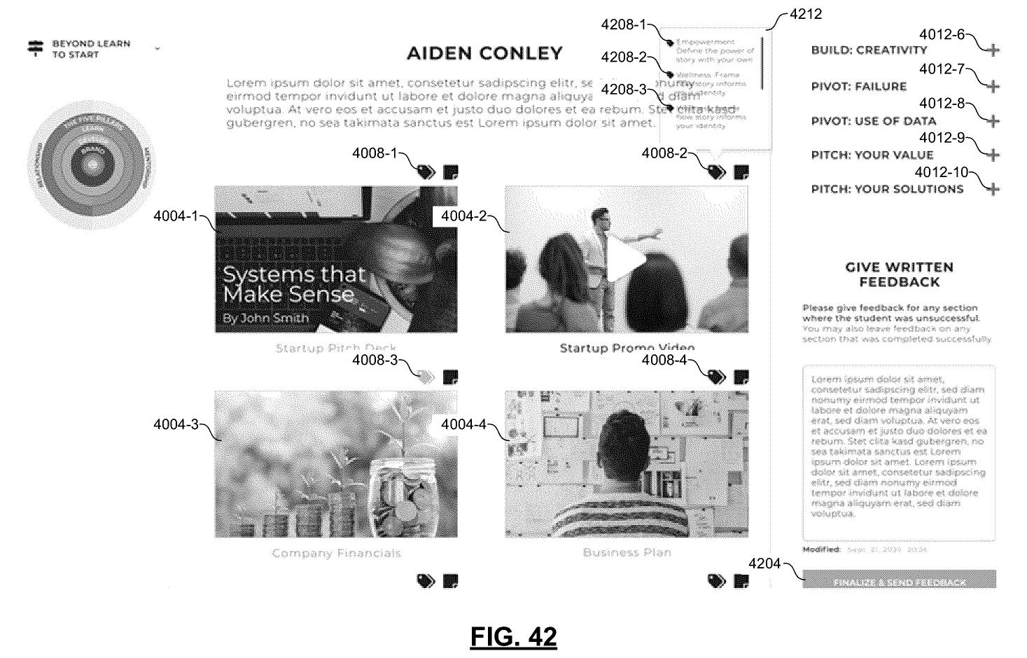

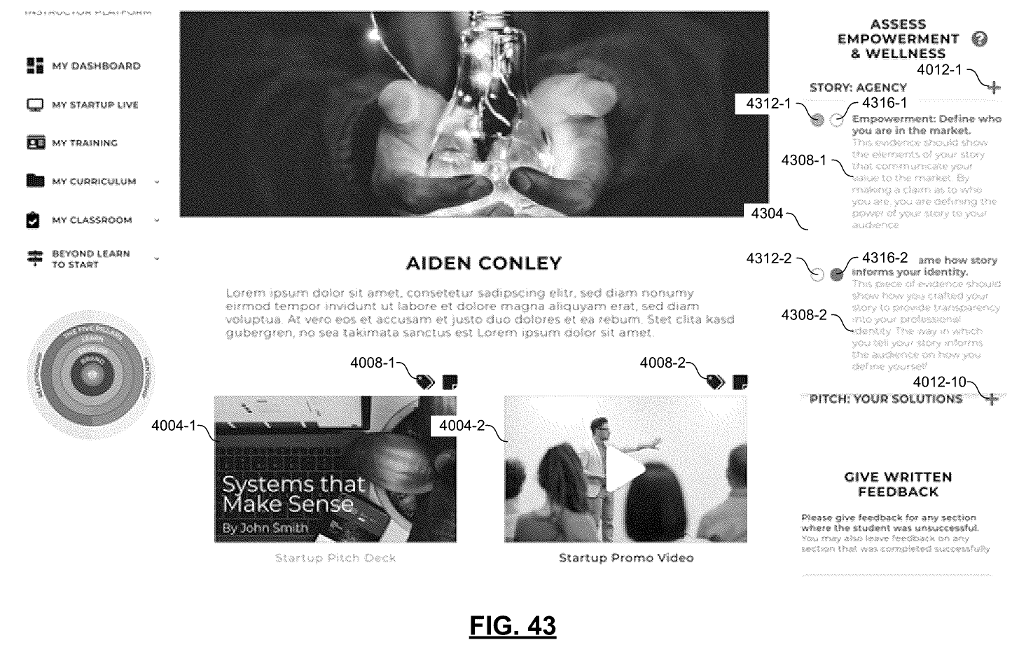

FIG. 38 is a flowchart of an example process for automatically generating user interfaces and processing data objects after the review platform generation module 238 is initialized. FIGS. 39-43 illustrate example user interface elements that may be generated when the review platform generation module 238 is initialized. In various implementations, the user interface elements of FIGS. 39-43 may be referred to as an assessments or “My Assessments” page. The example process of FIG. 38 begins at 3804 after the user selects one of the submission buttons 3904. In various implementations, each of the submission buttons 3904 may correlate to a user who has submitted journal data objects for review using the data object synthesis module 270 and/or the submissions page. In various implementations, the review platform generation module 238 may parse the submissions database 310 for submitted data objects and/or submitted data object tags to generate the submission buttons 3904. For example, if the submissions database 310 contains submitted data objects and/or submitted data object tags for two users, then two submission buttons 3904-1 and 3904-2 are generated.

After the user selects one of the submission buttons 3904, the review platform generation module 238 generates a first user interface element at 3804. In various implementations, the first user interface element may be a selectable preview 4004. In various implementations, the selectable preview 4004 may access the submitted data objects in the submissions database 310 and generate a preview based on the relevant data object. In various implementations, a selectable preview 4004 may be generated for each of the submitted data objects in the submissions database 310 associated with the selected user. Control proceeds to 3808. At 3808, the review platform generation module 238 generates a second user interface element. In various implementations, the second user interface element may be a selectable button 4008. Control proceeds to 3812. At 3812, the review platform generation module 238 generates a third user interface element. In various implementations, the third user interface element may be an expandable field 4012. In various implementations, an expandable field 4012 may be generated for each of the relevant certification standards present in the certification standards database 306, such relevant certification standards data objects 312 and/or generated data tags 314. Control proceeds to 3816.

At 3816, the review platform generation module 238 generates a fourth user interface element. In various implementations, the fourth user interface element may be a selectable button 4204, such as a “Finalize & Send Feedback” button. Control proceeds to 3802. At 3802, the review platform generation module 238 determines whether the first user interface element was selected. If the first user interface element was selected, control proceeds to 3824. Otherwise, control proceeds to 3828. At 3824, the review platform generation module 238 transforms the user interface to display the submitted data object corresponding to the selectable preview 4004. For example, if the submitted data object corresponding to the selectable preview 4004 is a video file, the review platform generation module 238 transforms the user interface to display a rendering of the video file in a pop-up window 4104. In various implementations, the pop-up window 4104 includes a selectable element 4108 that closes the pop-up window 4104 upon selection. Control proceeds to 3832.

At 3832, the review platform generation module 238 determines whether the selectable element 4108 was selected. If the selectable element 4108 was selected, the review platform generation module 238 closes the pop-up window 4104 and proceeds back to 3820. Otherwise, control proceeds back to 3832. At 3823, the review platform generation module 238 determines whether the second user interface element was selected. If the second user interface was selected, control proceeds to 3836. Otherwise, control proceeds to 3840. At 3836, the review platform generation module 238 transforms the user interface to display the selectable data tags. In various implementations, the selectable data tags may each be displayed in a field 4208 within a pop-up window 4212. In various implementations, the pop-up window 4212 may be closed when the user clicks away from the pop-up window 4212. Control proceeds back to 3820.

At 3840, the review platform generation module 238 determines whether the third user interface element was selected. If the third user interface element was selected, control proceeds to 3844. Otherwise, control proceeds to 3848. At 3844, the review platform generation module 238 generates a fifth user interface element. In various implementations, the fifth user interface element includes an expandable field 4304 with a description 4308 of each of the relevant certification standards from the certification standards database 306, such as the relevant certification standards data objects 312 and/or generated data tags 314. In various implementations, a first selectable button 4312 and a second selectable button 4312 may be generated for each description 4308. In various implementations, the first selectable button 4312 may correspond to a first option, and the second selectable button 4316 may correspond to a second option. In various implementations, the second selectable button 4316 may be selected by default when the fifth user interface element is initially generated. Control proceeds to 3852.

At 3852, the review platform generation module 238 determines whether the first option was selected. In various implementations, the first option may be selected when the user selects the first selectable button 4312. If the first option was selected, control proceeds to 3856. If the second option was selected, control proceeds to 3860. At 3856, the review platform generation module 238 associates a passing grade with the relevant certification standard associated with the description 4308. Control proceeds back to 3820. At 3860, the review platform generation module 238 associates a failing grade with the relevant certification standard associated with the description 4308. Control proceeds back to 3820. At 3848, the review platform generation module 238 determines whether the fourth user interface element was selected. If the fourth user interface element was selected, control proceeds to 3864. Otherwise, control proceeds to 3820.

At 3864, the review platform generation module 238 determines whether grading is complete. In various implementations, grading is complete when a passing or failing grade is assigned to each of the relevant certification standards loaded by the review platform generation module 238. If grading is not complete, control proceeds to 3868. In various implementations, grading may not be complete when one or more of the relevant certification standards is missing a passing or failing grade (for example, assigned by one of the selectable buttons 4312 or 4316). At 3868, the review platform generation module 238 generates an error message, such as a prompt notifying the user to grade the relevant description 4308. At 3872, the review platform generation module 238 saves the grades associated with the generated data tags as submitted grades in the submissions database 310. In various implementations, if the submitted grades are associated with the first user, the review platform generation module 238 saves the submitted grades as submitted grades 324. In various implementations, if the submitted grades are associated with the n-th user, the review platform generation module 238 saves the submitted grades as submitted grades 330.

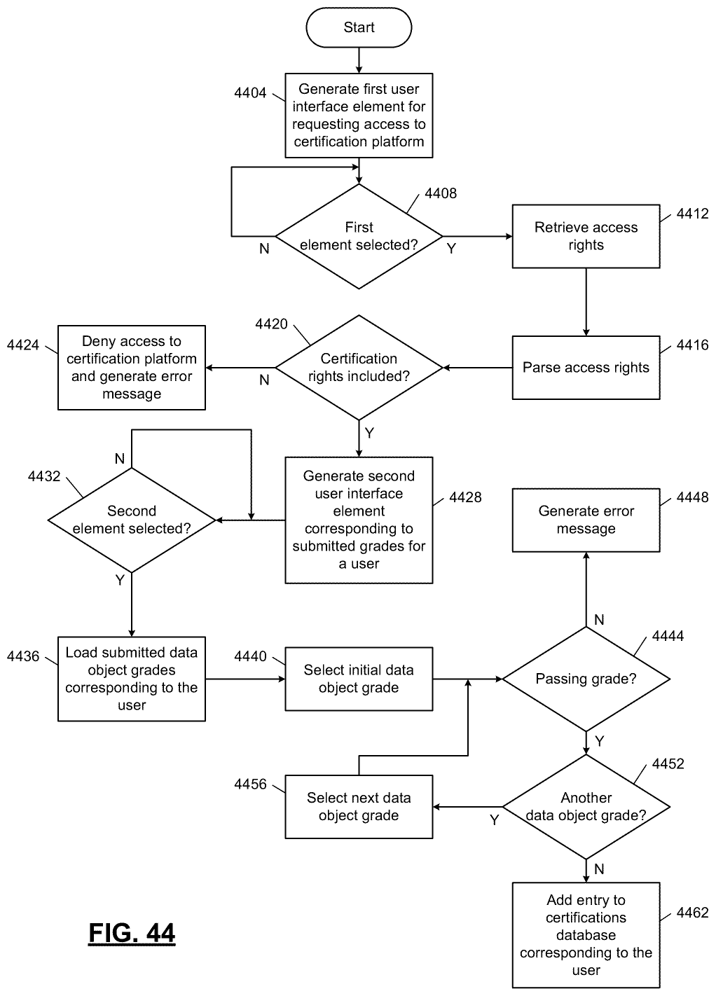

FIG. 44 is a flowchart of an example process for automatically generating user interfaces and processing data objects after the administrator platform generation module 230 is initialized. At 4404, the administrator platform generation module 230 generates a first user interface element. In various implementations, the first user interface element may be a selectable user interface element. Control proceeds to 4408. At 4408, the administrator platform generation module 230 determines whether the first user interface element was selected. If the first user interface element was selected, control proceeds to 4412. Otherwise, control proceeds back to 4408. At 4412, the administrator platform generation module 230 retrieves access rights of the user. For example, if the user is the first administrator, the administrator platform generation module 230 retrieves access rights 342. If the user is the first reviewer, the administrator platform generation module 230 retrieves the access rights 346. Control proceeds to 4416.

At 4416, the administrator platform generation module 230 parses the retrieved access rights. Control proceeds to 4420. At 4420, the administrator platform generation module 230 determines whether the retrieved access rights include certification rights. If the retrieved access rights do not include certification rights, control proceeds to 4424. If the retrieved access rights include certification rights, control proceeds to 4428. At 4424, the administrator platform generation module 230 denies the user access to the certification platform and generates an error message. At 4428, the administrator platform generation module 230 may selectively initialize a certification module 234. In various implementations, the administrator platform generation module 230 may initialize the certification module 234 if the user is a reviewer but is not an administrator to allow the reviewer access to the functionality of the certification platform while keeping the reviewer partitioned from the functionality of the administrator platform.

At 4428, the administrator platform generation module 230 and/or the certification module 234 generates a second user interface element. In various implementations, the second user interface element corresponds to submitted grades for a user present in the submissions database 310. Control proceeds to 4432. At 4432, the administrator platform generation module 230 and/or the certification module 234 determines whether the second user interface element was selected. If the second user interface element was selected, control proceeds to 4436. Otherwise, control proceeds back to 4432. At 4436, the administrator platform generation module 230 and/or the certification module 234 loads the submitted grades corresponding to the user present in the submissions database 310. Control proceeds to 4440. At 4440, the administrator platform generation module 230 and/or the certification module 234 selects the initial grade from the loaded grades. Control proceeds to 4444.

At 4444, the administrator platform generation module 230 and/or the certification module 234 determines whether the selected grade is a passing grade. If the selected grade is not a passing grade, control proceeds to 4448. Otherwise, if the selected grade is a passing grade, control proceeds to 4452. At 4448, the administrator platform generation module 230 and/or the certification module 234 generates an error message. At 4452, the administrator platform generation module 230 and/or the certification module 234 determines whether another grade is present in the loaded grades. If another grade is present, control proceeds to 4456. Otherwise, if another grade is not present, control proceeds to 4462. At 4456, the administrator platform generation module 230 and/or the certification module 234 selects the next grade from the loaded grades and proceeds back to 4444. At 4462, the administrator platform generation module 230 and/or the certification module 234 adds an entry to the certifications database 308 corresponding to the user. For example, if the user is the first user, the administrator platform generation module 230 and/or the certification module 234 adds an entry to certifications 316. If the user is the n-th user, the administrator platform generation module 230 and/or the certification module 234 adds an entry to certifications 318.

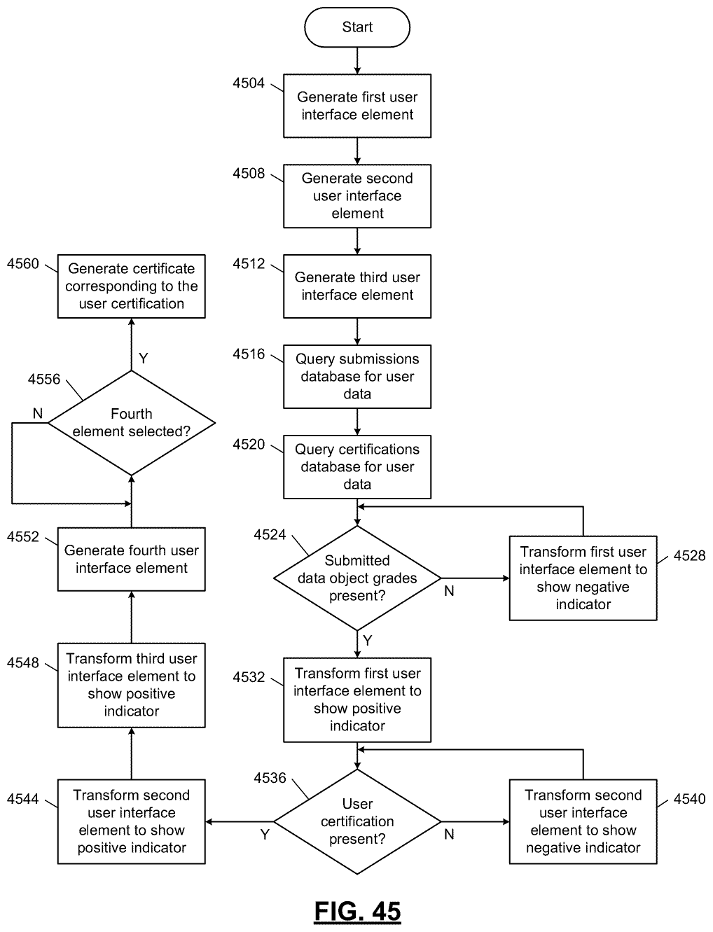

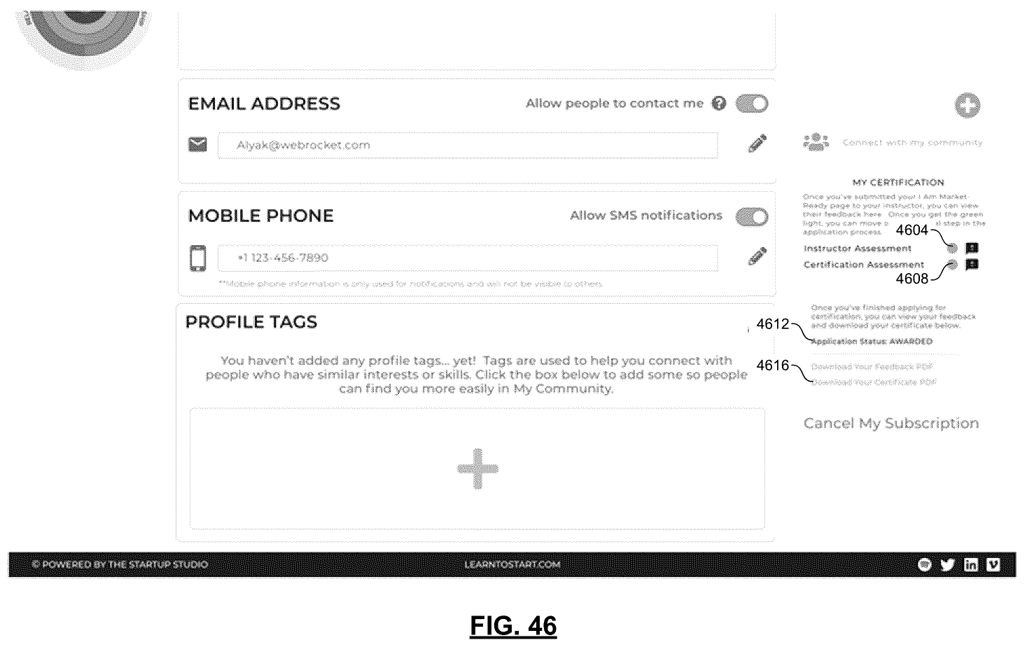

FIG. 45 is a flowchart of an example process for automatically generating user interfaces after the user platform generation module 240 is initialized. FIG. 46 illustrates user interface elements that may be automatically generated after the user platform generation module 240 is initialized. In various implementations, FIG. 46—along with FIGS. 12-16—may be referred to as the dashboard or “My Dashboard” page. At 4504, the user platform generation module 240 may generate a first user interface element. In various implementations, the first user interface element may include a binary status indicator 4604. The binary status indicator 4604 may indicate whether the reviewer has completed grading the data objects submitted by the user. Control proceeds to 4508. At 4508, the user platform generation module 240 may generate a second user interface element. In various implementations, the second user interface element may include a binary status indicator 4608. The binary status indicator 4608 may indicate whether the administrator and/or reviewer with certification rights has completed the certification process for the user. Control proceeds to 4512.

At 4512, the user platform generation module 240 generates a third user interface element. In various implementations, the third user interface element may include a status field 4612 that indicates whether a certificate has been awarded to the user. Control proceeds to 4516. At 4516, the user platform generation module 240 queries the submissions database 310 for user data, such as whether submitted grades are present for the user. For example, if the user is the first user, the user platform generation module 240 may query the submissions database 310 for submitted grades 324. If the use is the n-th user, the user platform generation module 240 may query the submissions database 310 for submitted grades 330. Control proceeds to 4520. At 4520, the user platform generation module 240 queries the certifications database 308 for user data, such as whether a certification is present for the user. For example, if the user is the first user, the user platform generation module 240 may query the certifications database 308 for certifications 316. If the user is the n-th user, the user platform generation module 240 may query the certifications database 308 for certifications 318. Control proceeds to 4524.

At 4524, the user platform generation module 240 determines whether submitted grades are present in the submissions database 310 for the user. For example, if the user is the first user, the user platform generation module 240 may determine whether submitted grades 324 are present. If the user is the n-th user, the user platform generation module 240 may determine whether submitted grades 330 are present. If submitted grades are not present for the user, control proceeds to 4528. If submitted grades are present for the user, control proceeds to 4532. At 4528, the user platform generation module 240 transforms the first user interface element to show a negative indication. For example, the user platform generation module 240 may transform the binary status indicator 4604 to be filled with a red color. Control proceeds back to 4524.

At 4532, the user platform generation module 240 transforms the first user interface element to show a positive indication. For example, the user platform generation module 240 may transform the binary status indicator 4604 to be filled with a green color. Control proceeds to 4536. At 4536, the user platform generation module 240 determines whether certifications are present in the certifications database 308 for the user. For example, if the user is the first user, the user platform generation module 240 determines whether certifications 316 are present. If the user is the n-th user, the user platform generation module 240 determines whether certifications 318 are present. If the certifications are not present for the user, control proceeds to 4540. If the certifications are present for the user, control proceeds to 4544.

At 4540, the user platform generation module 240 transforms the second user interface element to show a negative indication. For example, the user platform generation module 240 may transform the binary status indicator 4608 to be filled with a red color. Control proceeds back to 4536. At 4544, the user platform generation module 240 transforms the second user interface element to show a positive indication. For example, the user platform generation module 240 may transform the binary status indicator 4608 to be filled with a green color. Control proceeds to 4548. At 4548, the user platform generation module 240 transforms the third user interface element to show a positive indication. For example, the user platform generation module 240 may transform the status field 4612 to display “Application Status: AWARDED.” Control proceeds to 4552.

At 4552, the user platform generation module 240 generates a fourth user interface element. In various implementations, the fourth user interface element may be a selectable element 4616. Control proceeds to 4556. At 4556, the user platform generation module 240 determines whether the fourth user interface element was selected. If the fourth user interface element was selected, control proceeds to 4560. Otherwise, control proceeds back to 4556. At 4560, the user platform generation module 240 generates a certificate based on the certifications for the user present in the certifications database 308.

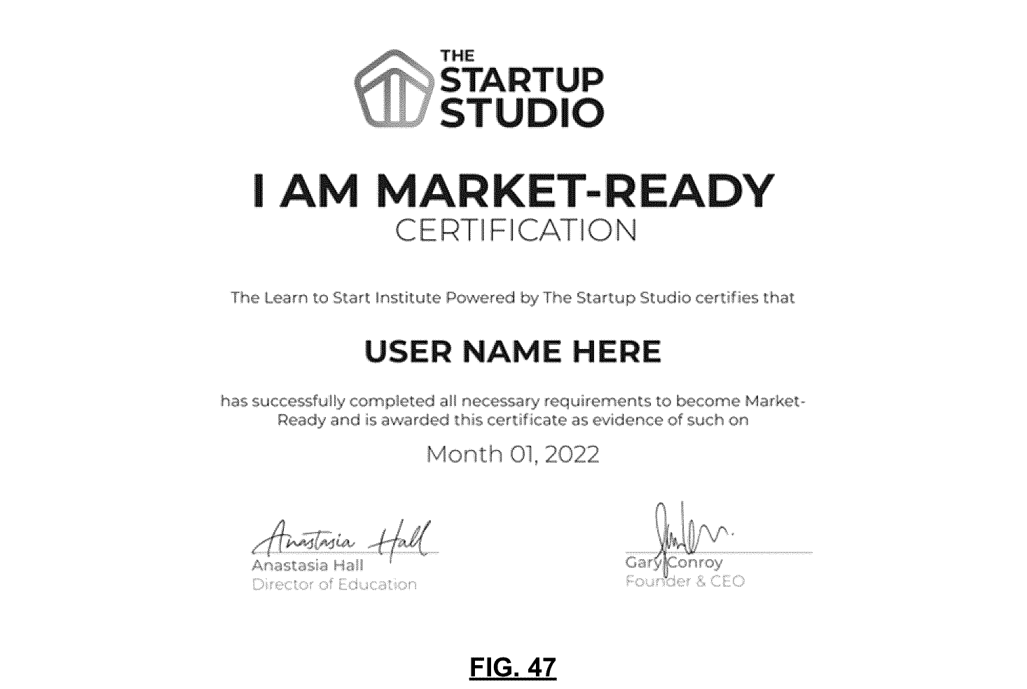

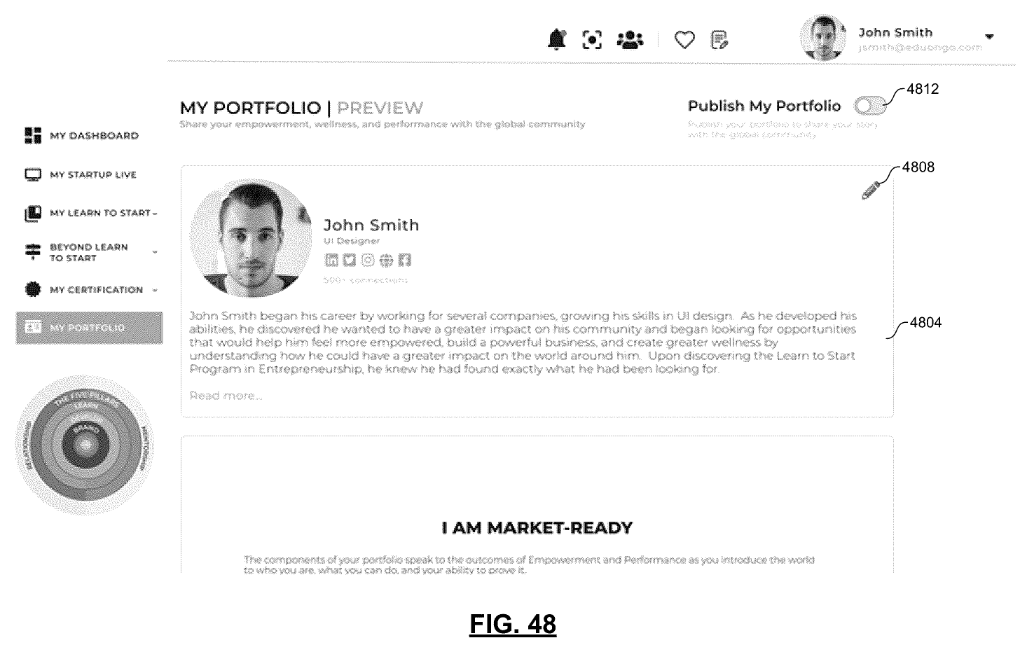

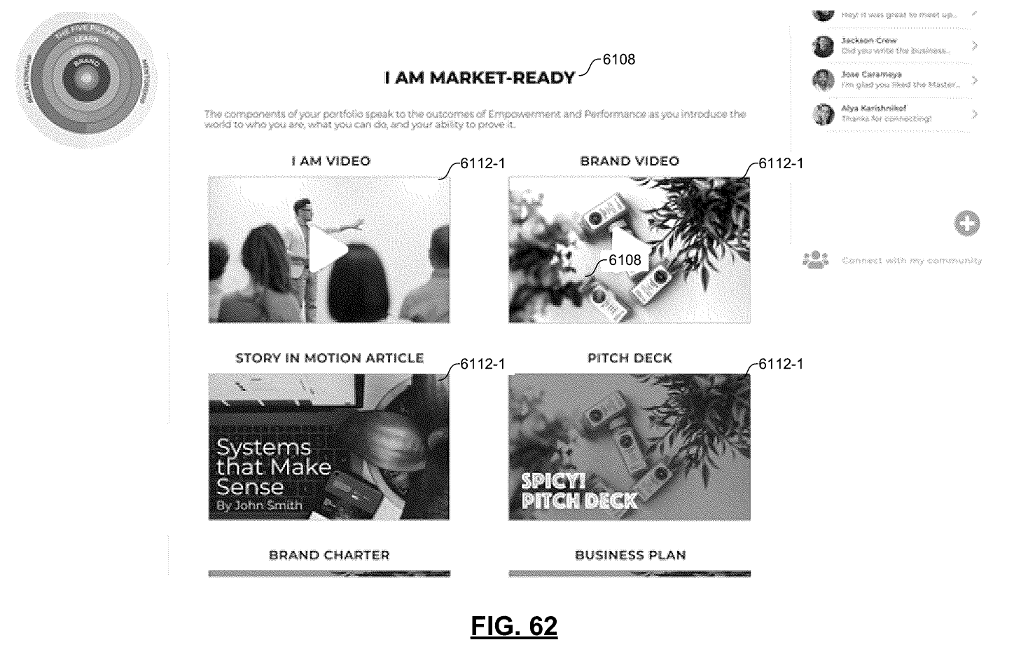

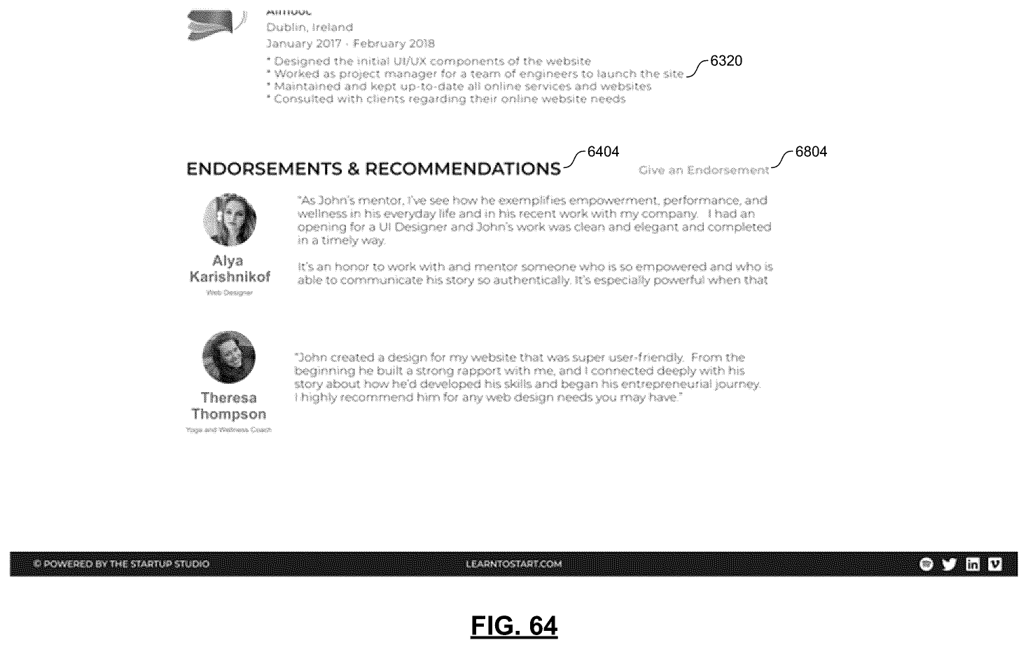

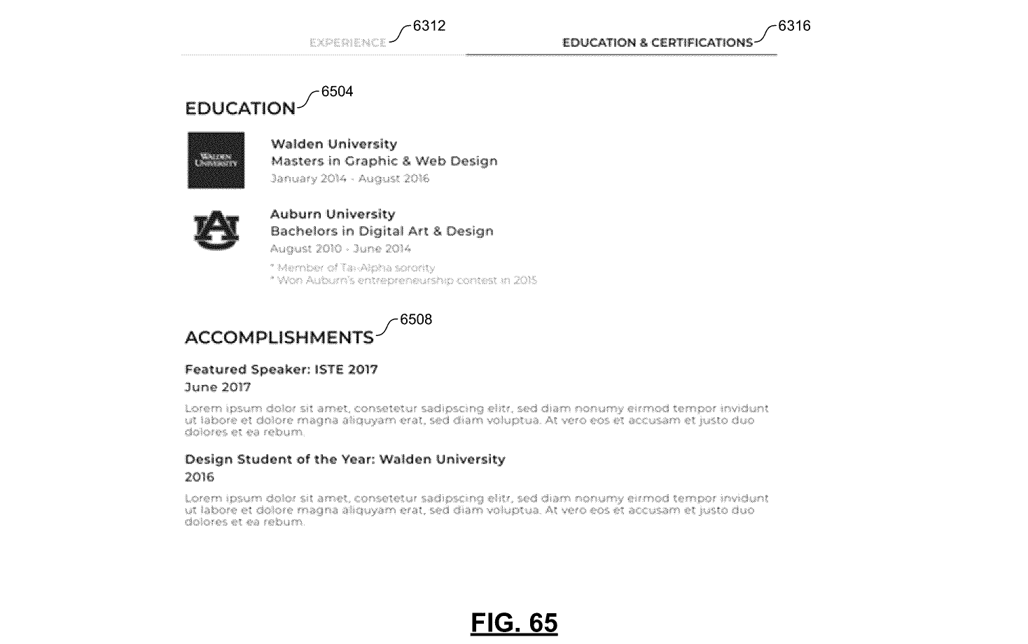

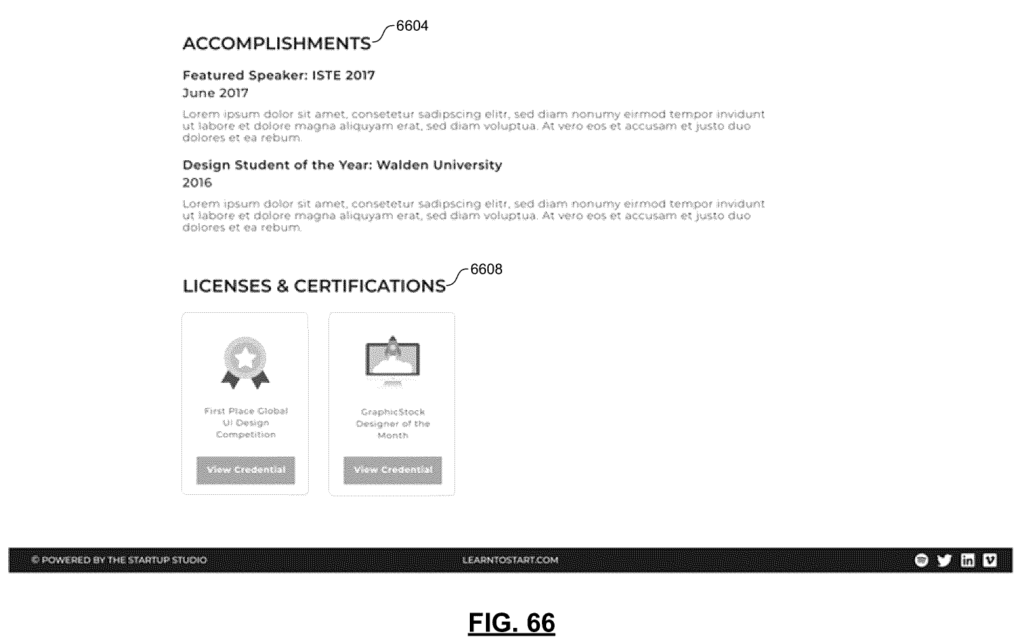

FIG. 47 illustrates an example certificate—such as an “I Am Market-Ready” or “IAMR” certificate—that may be generated at step 4560 of FIG. 45. FIGS. 48-66 show example user interface elements that may be generated by the user platform generation module 240 at a portfolio or “My Portfolio” page. As shown in FIG. 48, the portfolio page may include a summary field 4804 that displays a summary related to the user. The contents of the summary field 4804 may be edited upon the user selecting a selectable element 4808. In various implementations, the contents of the portfolio page may not be visible to other users of the distributed client integration and interconnect platform 104 when the “Publish My Portfolio” toggle switch 4812 is in the negative position. In various implementations, the contents of the portfolio page may be visible to other users of the distributed client integration and interconnect platform 104 when the “Publish My Portfolio” toggle switch 4812 is in the positive position.

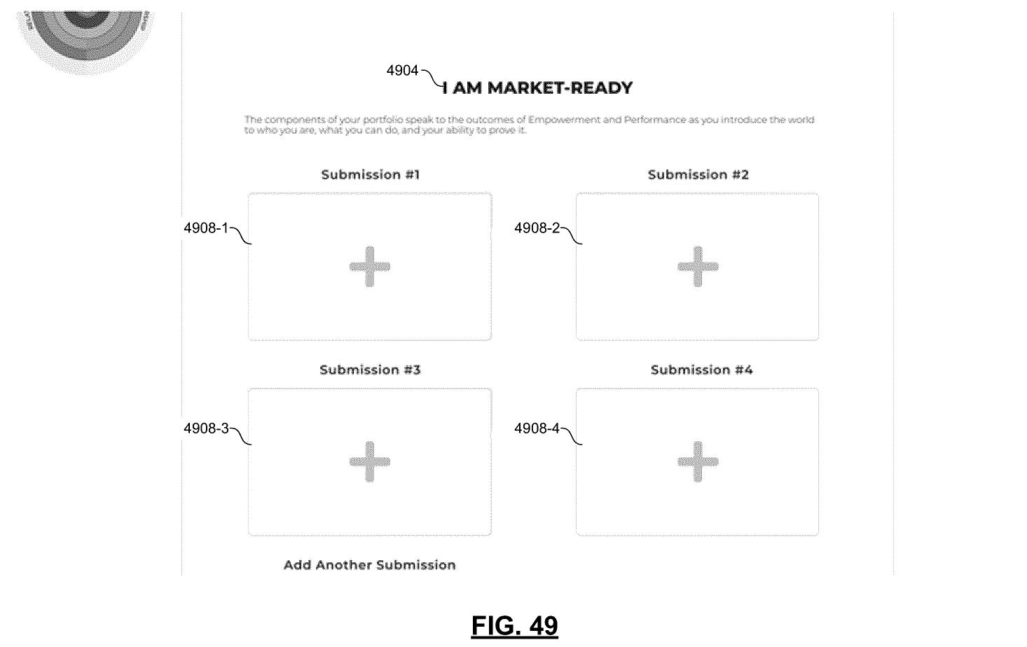

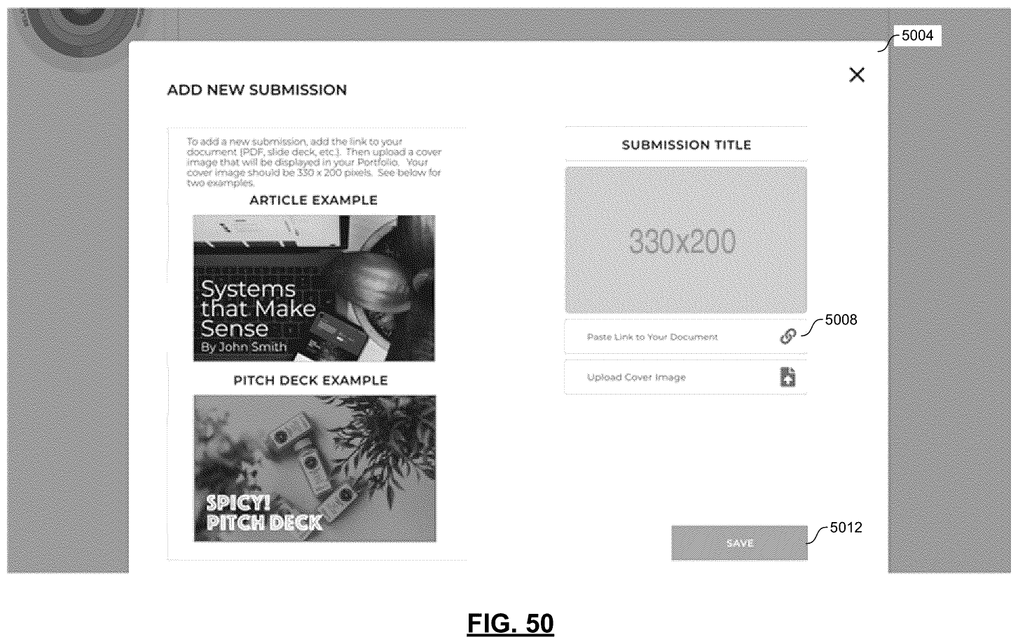

As shown in FIG. 49, the portfolio page may include an “I Am Market-Ready” field 4904 (or an “IAMR” field). The “I Am Market-Ready” field 4904 may include one or more selectable preview fields 4908. After the user selects one of the selectable preview fields 4908, the user platform generation module 240 generates an “Add New Submission” pop-up field 5004, shown in FIG. 50. The “Add New Submission” pop-up field 5004 may include a selectable element 5008. After the user selects the selectable element 5008, the user platform generation module 240 may generate a prompt allowing the user to link the selectable preview field 4908 to one or more of the journal raw data objects and/or journal formatted data objects in the user profile databases 304, and/or one or more of the submitted data objects in the submissions database 310. The “Add New Submission” pop-up field 5004 may also include a selectable element 5012. After the user selects the selectable element 5012, the user platform generation module 240 associates the linked data object(s) to the selectable preview field 4908, closes the “Add New Submission” pop-up field 5004, and returns to the portfolio page.

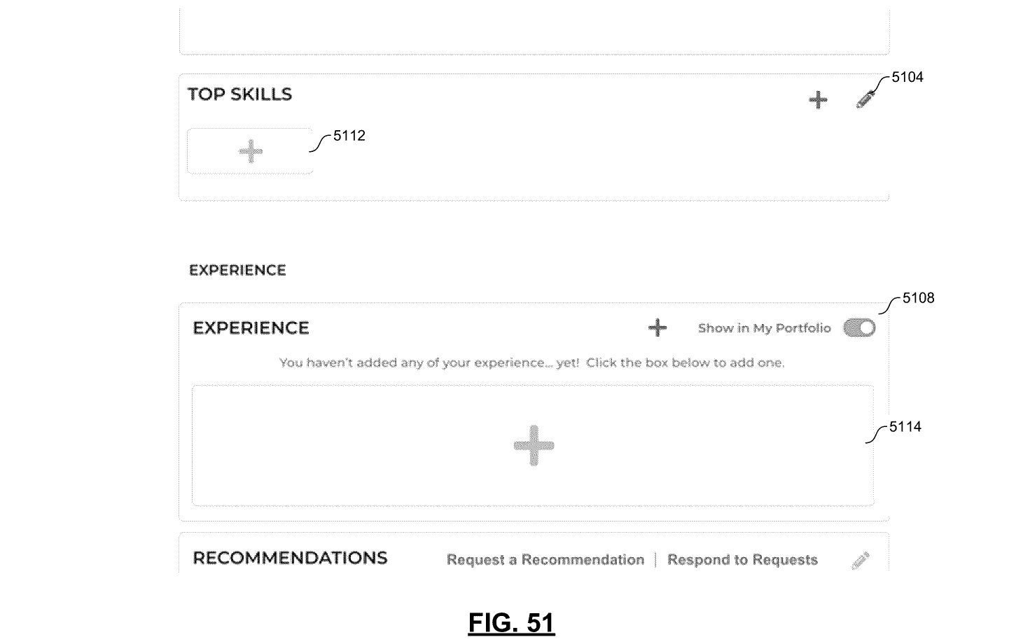

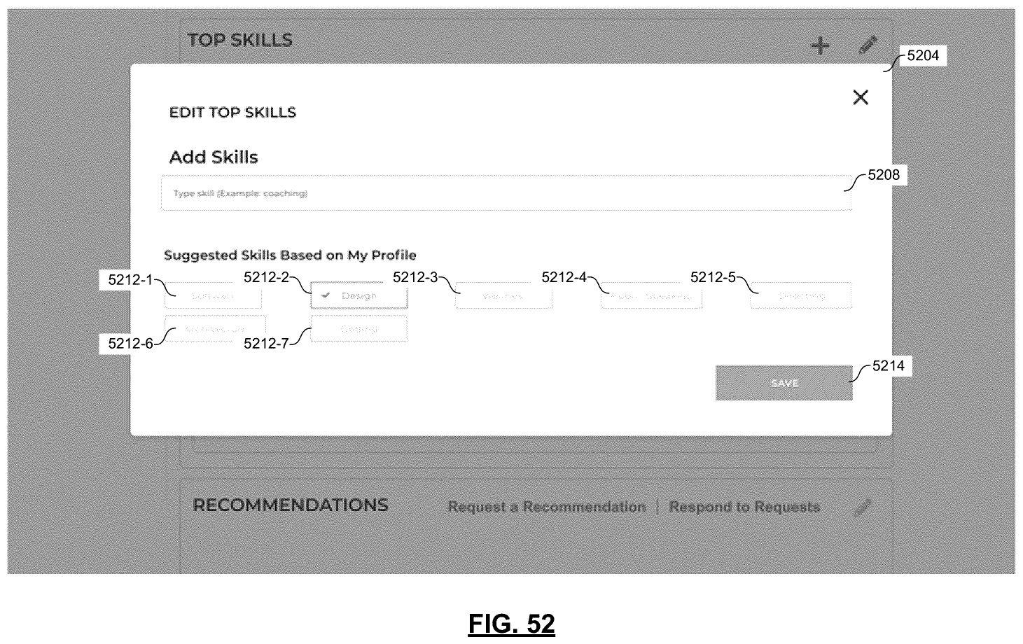

As shown in FIG. 51, the portfolio page may include a “Top Skills” field 5104 and an “Experience” field 5108. The “Top Skills” field 5104 may include a selectable element 5112. After the user selects the selectable element 5112, the user platform generation module 240 generates an “Edit Top Skills” pop-up field 5204, shown in FIG. 52. The “Edit Top Skills” pop-up field 5204 includes an input field 5208 that allows the user to manually add skills—such as by populating a text box—and selectable fields 5212 that may be automatically generated by the user platform generation module 240 based on data about the user. The “Edit Top Skills” pop-up field 5204 also includes a selectable element 5214. After the user selects the selectable element 5214, the user platform generation module 240 adds the skills input into the input field 5208 and/or the skills correlating to the selected selectable fields 5212 to the “Top Skills” field 5104 and closes the “Edit Top Skills” pop-up field 5204 and returns to the portfolio page.

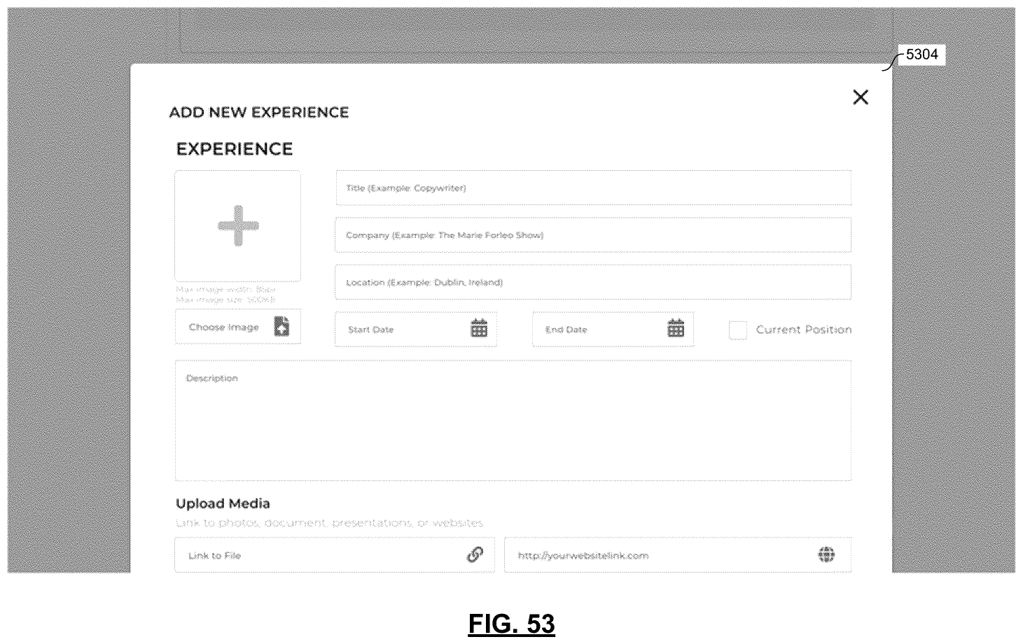

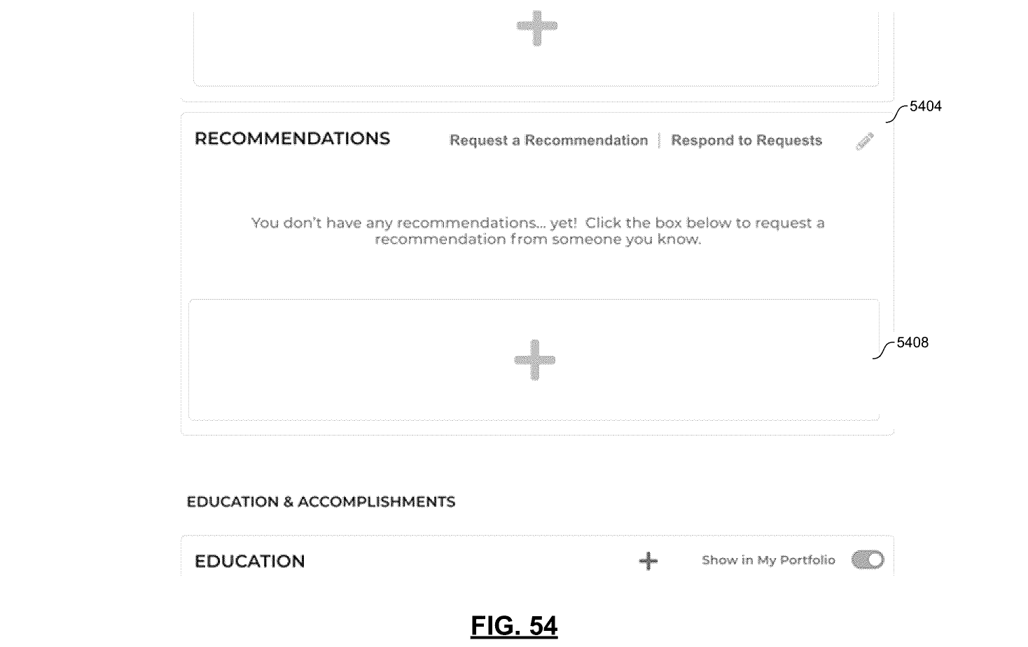

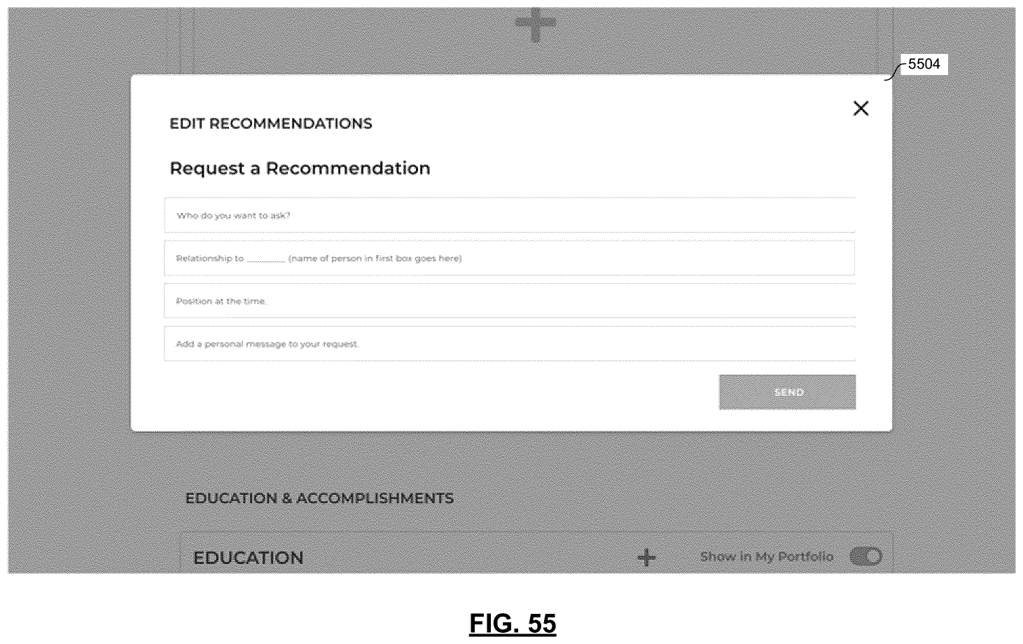

In various implementations, the “Experience” field 5108 may include a selectable element 5114. After the user selects the selectable element 5114, the user platform generation module 240 generates an “Add New Experience” pop-up field 5304, shown in FIG. 53, which allows the user to add elements related to their experience to the portfolio page. As shown in FIG. 54, the portfolio pay may include a “Recommendations” field 5404. In various implementations, the “Recommendations” field 5404 may include a selectable element 5408. After the user selects the selectable element 5408, the user platform generation module 240 generates an “Edit Recommendations” pop-up field 5504, shown in FIG. 55, which allows the user to request recommendations from other users, including other users of the distributed client integration and interconnect platform 104 and/or external users.

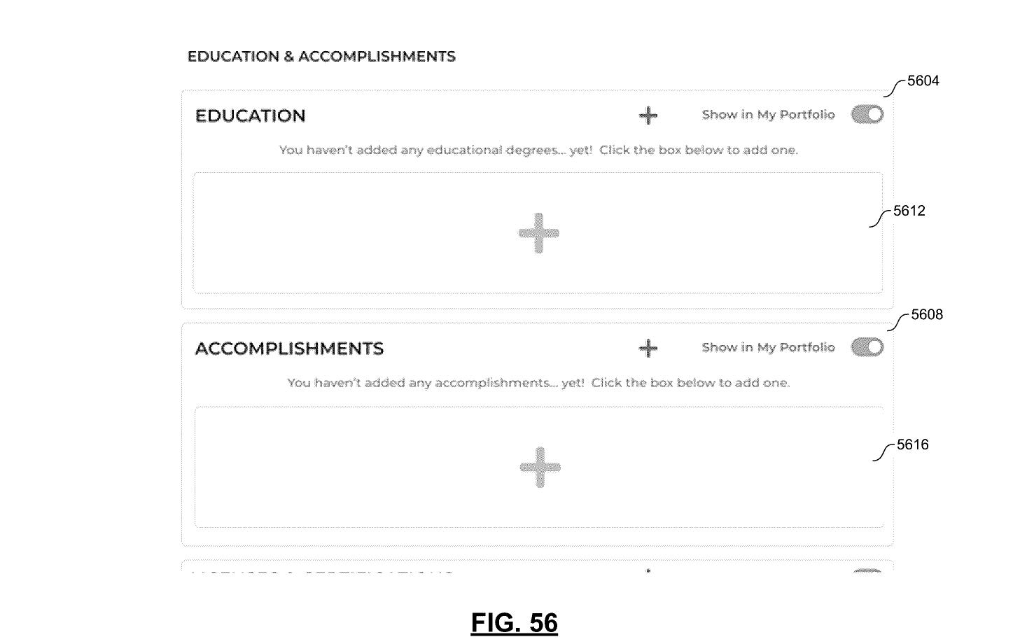

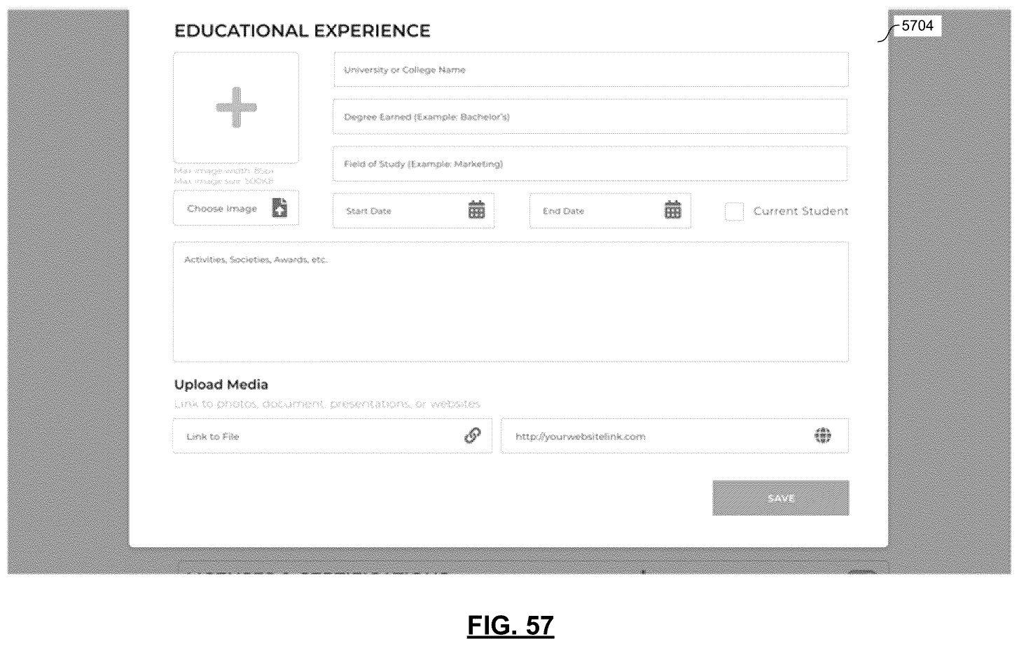

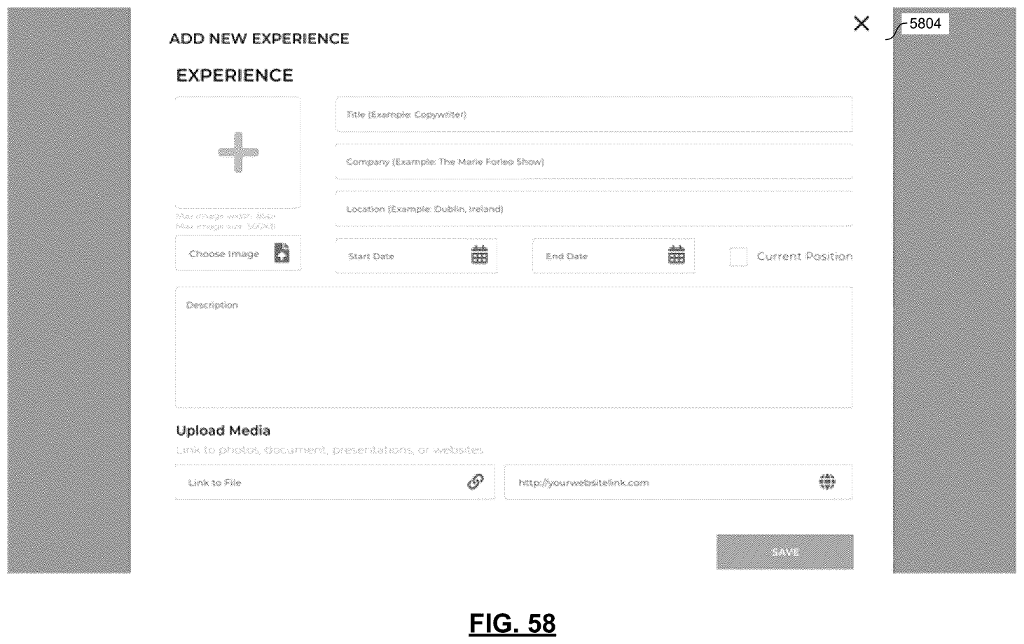

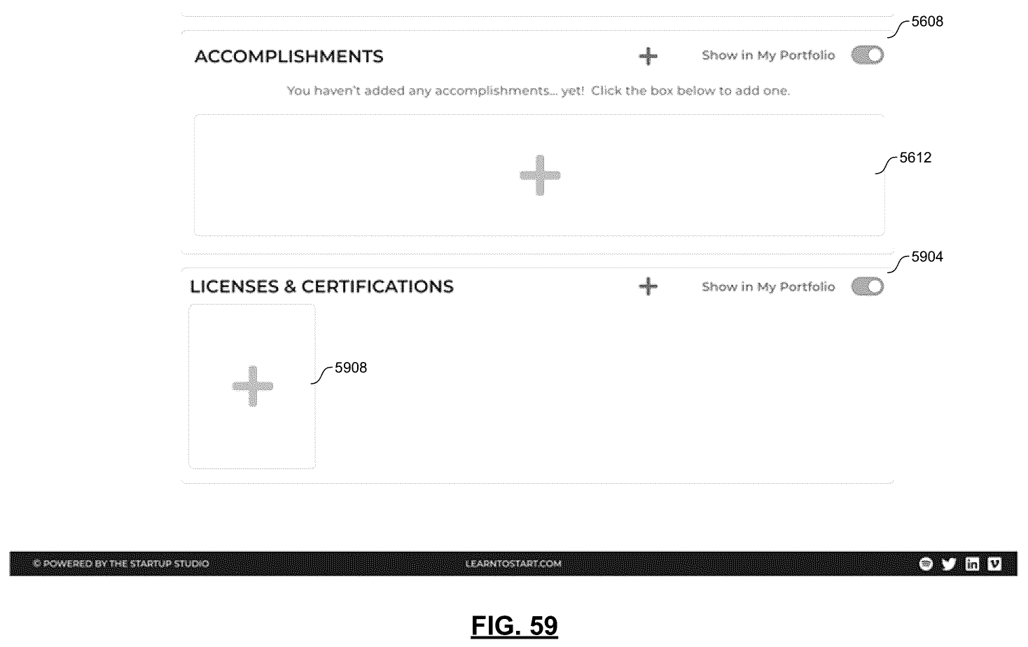

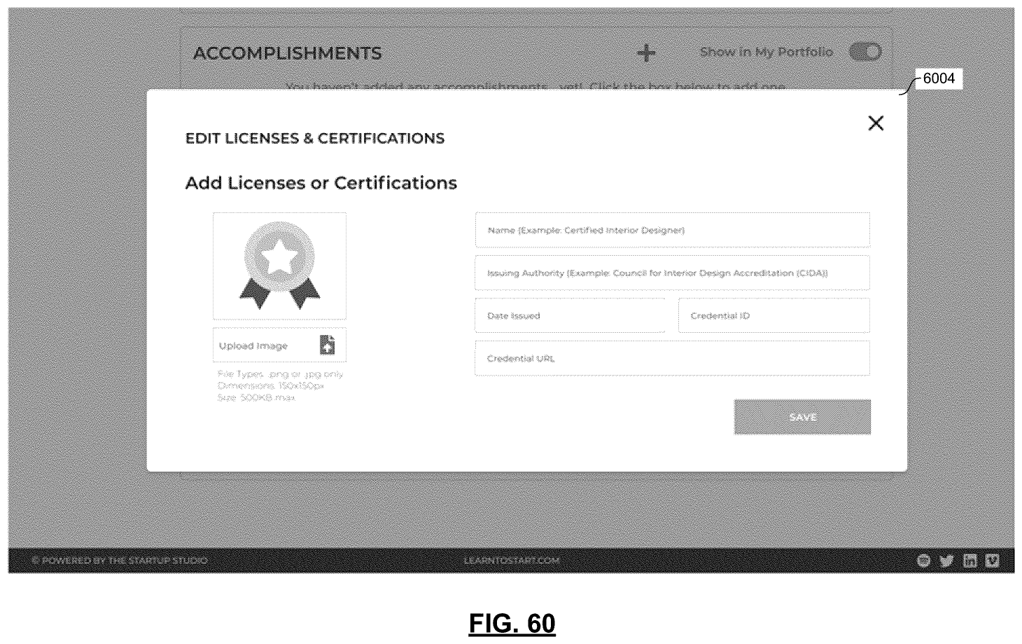

As shown in FIG. 56, the portfolio page may include an “Education” field 5604 and an “Accomplishments” field 5608. The “Education” field 5604 may include a selectable element 5612. After the user selects the selectable element 5612, the user platform generation module 240 generates an “Educational Experience” pop-up field 5704, shown in FIG. 57, which allows the user to add elements related to their educational experience to the portfolio page. In various implementations, the “Accomplishments” field 5608 may include a selectable element 5616. After the user selects the selectable element 5616, the user platform generation module 240 generates an “Add New Experience” pop-up field 5804, shown in FIG. 58, which allows the user to add elements related to their professional and other experiences to the portfolio page. As shown in FIG. 59, the portfolio page may include a “Licenses & Certifications” field 5904. The “Licenses & Certifications” field 5904 may include a selectable element 5908. After the user selects the selectable preview field 4908, the user platform generation module 240 generates an “Edit Licenses & Certifications” pop-up field 6004, shown in FIG. 60, which allows the users to add licenses and/or certifications to the portfolio page.

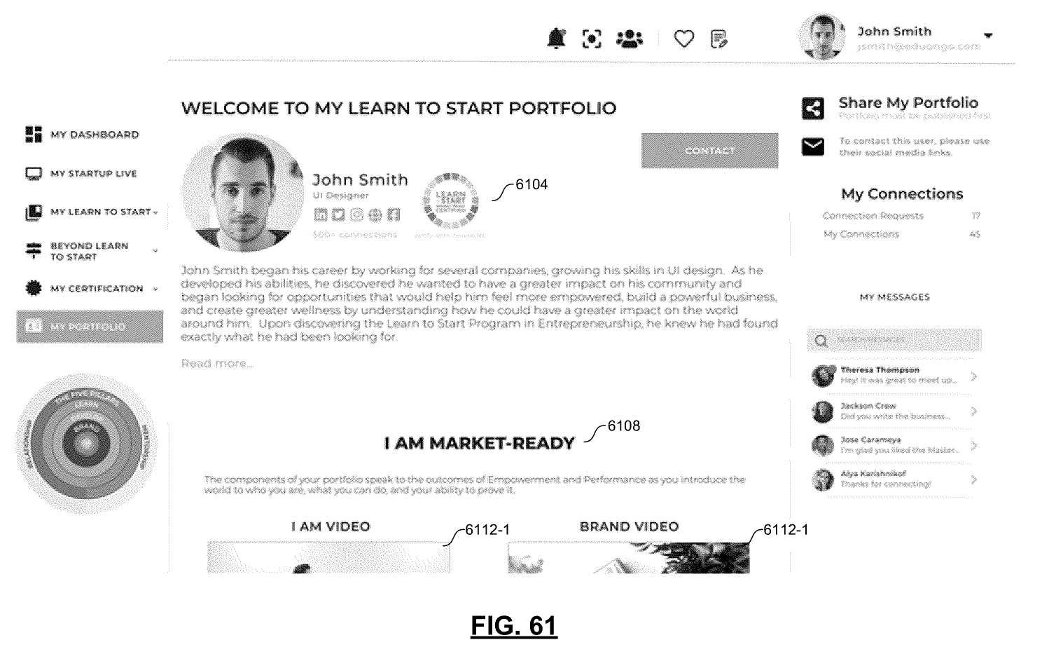

FIGS. 61-66 show example user interface elements that may be generated by the user platform generation module 240 at a portfolio or “My Portfolio” page after it has been published. In various implementations, the portfolio page may be published after the user selects the “Publish My Portfolio” toggle switch 4812 and moves it to the positive position. After it has been published, the portfolio may include a published summary field 6104 that includes data from the summary field 4804, and a published “I Am Market-Ready” field 6108 (or “IAMR” field) including selectable preview fields 6112 that includes selectable previews of the data objects associated with the selectable preview fields 4908 of the “I Am Market-Ready” field 4904. If the user selects one of the selectable preview fields 6112, the user platform generation module 240 accesses the associated data object and displays and/or play sit in a pop-up field.

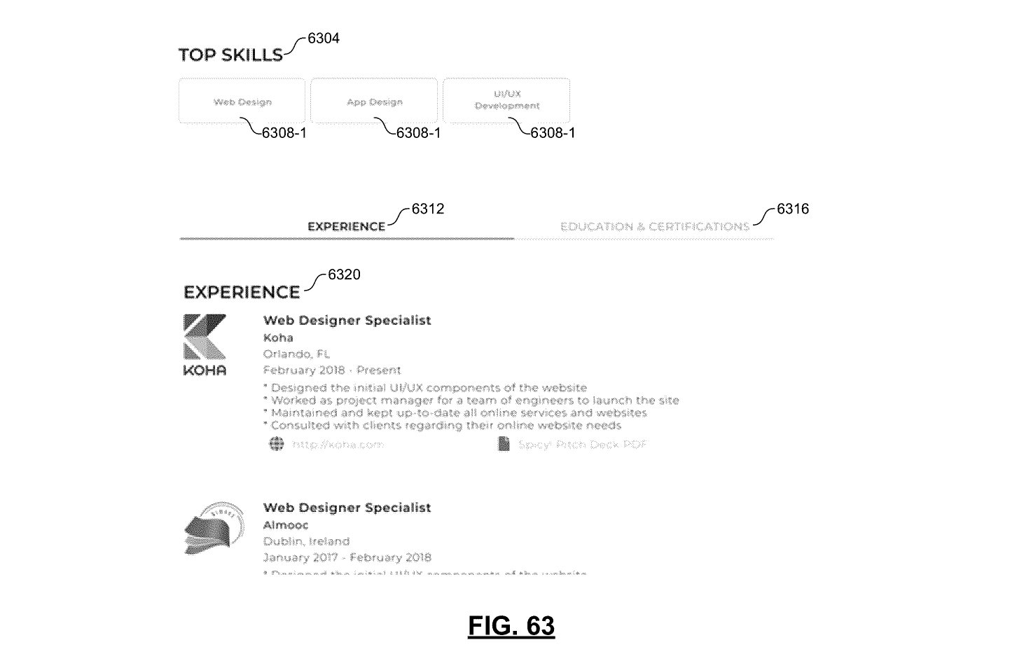

The published portfolio page also includes a published “Top Skills” field 6304. In various implementations, the “Top Skills” field 6304 includes tags 6308 that each correlate to a skill added via the selectable element 5112 of the “Top Skills” field 5104. As shown in FIG. 63, the published portfolio page also includes a selectable “Experience” element 6312 and a selectable “Education & Certifications” element 6316. If the selectable “Experience” element 6312 is selected, the published portfolio page displays a published “Experience” field 6320 and a published “Endorsements & Recommendations” field 6404. If the selectable “Education & Certifications” element 6316 is selected, a published “Education” field 6504, a published “Accomplishments” field 6604, and a published “License & Certifications” field 6608 is displayed.

In various implementations, the published “Experience” field 6320 includes elements added via the selectable element 5114 of the “Experience” field 5108. In various implementations, the published “Endorsements & Recommendations” field 6404 includes elements added by users solicited via the selectable element 6408. In various implementations, the published “Education” field 6504 includes elements added via the selectable element 5612 of the “Education” field 5604. In various implementations, the published “Accomplishments” field 6508 includes elements added via the selectable element 5616 of the “Accomplishments” field 5608. In various implementations, the published “Licenses & Certifications” field 6608 includes elements added via the selectable element 5908 of the “Licenses & Certifications” field 5904.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A system for orchestrating structured data exchange between computer devices and generating dynamic user interfaces comprising:
an interconnect platform including:
a data store including a user profile, a submissions database, and a certification database,
platform generation and service modules,
a programming interface configured to provide access to the platform generation and service modules, and
a first communications interface configured to provide access to the programming interface; and
a user device including:
a display,
a second communications interface configured to be operatively coupled to the first communications interface via a network, and
platform access modules configured to access the programming interface via the second communications interface, the network, and the first communications interface;
wherein the platform generation and service modules are configured to:
access a plurality of formatted data objects stored in the user profile,
save the formatted data objects to the submissions database,
determine whether each of the formatted data objects complies with standards stored in a certification standards database,
in response to determining that each of the formatted data objects complies with the standards, transform a user interface element at a user interface to provide a positive indication, and
in response to determining that at least one of the formatted data objects does not comply with the standards, transform the user interface element to provide a negative indication.

2. The system of claim 1 wherein the platform generation and service modules are configured to:
generate a second user interface element selectable by a first user;
in response to the first user selecting the second user interface element, receive a raw data object uploaded by the first user; and
save the raw data object to the user profile.

3. The system of claim 2, wherein the user platform generation and service modules are configured to:
determine whether the raw data object is in a file format compatible with the platform generation and service modules; and
in response to determining that the file format is not compatible with the platform generation and service modules, reformat the raw data object and adding the reformatted raw data object to the formatted data objects.

4. The system of claim 3, wherein the user platform generation and service modules are configured to:
in response to determining that the file format is compatible with the platform generation and service modules, add the raw data object to the formatted data objects.

5. The system of claim 4, wherein the platform generation and service modules are configured to transform the second user interface element to display a preview of one of the formatted data objects.

6. The system of claim 5, wherein the platform generation and service modules are configured to:
transform the user interface to display a third user interface element selectable by the first user; and
in response to the first user selecting third user interface element, save the formatted data objects as submitted data objects in the submissions database.

7. The system of claim 6, wherein the platform generation and service modules are configured to:
transform the user interface to display a fourth user interface element selectable by a second user; and
in response to the second user selecting the fourth user interface element:
transform the user interface to display one of the submitted data objects,
transform the user interface to display a fifth user interface element and a sixth user interface element, the fifth user interface element and the sixth user interface element each selectable by the second user,
in response to the second user selecting the fifth user interface element, associate a first data marker with the submitted data object, and
in response to the second user selecting the sixth user interface element, associate a second data marker with the submitted data object.

8. The system of claim 7, wherein the platform generation and service modules are configured to:
transform the user interface to display a seventh user interface element selectable by the second user; and
in response to the second user selecting the seventh user interface element:
determine whether each of the submitted data objects has an associated data marker,
in response to determining that each of the submitted data objects has the associated data marker, save the submitted data objects and the associated data markers as submitted grades in the submissions database, and
in response to determining that at least one of the submitted data objects does not have the associated data marker, generate an error message and outputting the error message to the user interface.

9. The system of claim 8, wherein the platform generation and service modules are configured to:
load the submitted grades from the submissions database;
determine whether each of the submitted grades is associated with the first data marker or the second data marker;
in response to determining that one of the submitted grades is associated with the second data marker, generate a second error message and outputting the second error message to the user interface; and
in response to determining that each of the submitted grades is associated with the first data marker, add an entry to the certifications database.

10. The system of claim 9, wherein the platform generation and service modules are configured to:
generate an eighth user interface element;
determine whether the entry is present in the certifications database;
in response to determining that the entry is not present in the certifications database, transform the eighth user interface element to display a negative indication; and
in response to determining that the entry is present in the certifications database:
transform the eighth user interface element to display a positive indication,
generate a ninth user interface element selectable by the first user, and
in response to the first user selecting the eighth user interface element, generate a certificate corresponding to the entry and outputting the certificate to the user interface.

11. A computer-implemented method of orchestrating structured data exchange between computer devices and generating dynamic user interfaces comprising:
accessing, at platform generation and service modules, a plurality of formatted data objects stored in a user profile, the user profile stored in a data store, the data store forming a part of an interconnect platform including the data store, the platform generation and service modules, a programming interface configured to provide access to the platform generation and service modules, and a first communications interface configured to provide access to the programming interface;
saving the formatted data objects to a submissions database, the submission database stored in the data store;
determining whether each of the formatted data objects complies with standards stored in a certification standards database, the certification standards database stored in the data store;
in response to determining that each of the formatted data objects complies with the standards, transforming a user interface element at a user interface to provide a positive indication; and
in response to determining that at least one of the formatted data objects does not comply with the standards, transforming the user interface element to provide a negative indication.

12. The method of claim 11 further comprising:
generating a second user interface element selectable by a first user;
in response to the first user selecting the second user interface element, receiving a raw data object uploaded by the first user; and
saving the raw data object to the user profile.

13. The method of claim 12 further comprising:
determining whether the raw data object is in a file format compatible with the platform generation and service modules; and
in response to determining that the file format is not compatible with the platform generation and service modules, reformatting the raw data object and adding the reformatted raw data object to the formatted data objects.

14. The method of claim 13 further comprising:
in response to determining that the file format is compatible with the platform generation and service modules, adding the raw data object to the formatted data objects.

15. The method of claim 14 further comprising:
transforming the second user interface element to display a preview of one of the formatted data objects.

16. The method of claim 15 further comprising:
transforming the user interface to display a third user interface element selectable by the first user; and
in response to the first user selecting the third user interface element, saving the formatted data objects as submitted data objects in the submissions database.

17. The method of claim 16 further comprising:
transforming the user interface to display a fourth user interface element selectable by a second user; and
in response to the second user selecting the fourth user interface element:
transforming the user interface to display one of the submitted data objects,
transforming the user interface to display a fifth user interface element and a sixth user interface element, the fifth user interface element and the sixth user interface element selectable by the second user,
in response to the second user selecting the fifth user interface element, associating a first data marker with the submitted data object, and
in response to the second user selecting the sixth user interface element, associating a second data marker with the submitted data object.

18. The method of claim 17 further comprising:
transforming the user interface to display a seventh user interface element selectable by the second user; and
in response to the second user selecting the seventh user interface element:
determining whether each of the submitted data objects has an associated data marker,
in response to determining that each of the submitted data objects has the associated data marker, saving the submitted data objects and the associated data markers as submitted grades in the submissions database, and
in response to determining that at least one of the submitted data objects does not have the associated data marker, generating an error message and outputting the error message to the user interface.

19. The method of claim 18 further comprising:
loading the submitted grades from the submissions database;
determining whether each of the submitted grades is associated with the first data marker or the second data marker;
in response to determining that one of the submitted grades is associated with the second data marker, generating a second error message and outputting the second error message to the user interface; and
in response to determining that each of the submitted grades is associated with the first data marker, adding an entry to a certification database, the certification database stored in the data store.

20. The method of claim 19 further comprising:
generating an eighth user interface element;
determining whether the entry is present in the certifications database;
in response to determining that the entry is not present in the certifications database, transforming the eighth user interface element to display a negative indication; and
in response to determining that the entry is present in the certifications database:
transforming the eighth user interface element to display a positive indication,
generating a ninth user interface element selectable by the first user, and
in response to the first user selecting the eighth user interface element, generating a certificate corresponding to the entry and outputting the certificate to the user interface.
